(19) United States
(12) Patent Application Publication
(10) Pub. No.: US 2025/0284959 A1
(43) Pub. Date: Sep. 11, 2025

(54) THERMODYNAMIC COMPUTING MEAN-FIELD FORWARDS AND BACKWARDS PROPAGATION

(71) Applicant: Extropic Corp., Austin, TX (US)

(72) Inventors: Christopher Chamberland, Austin, TX (US); Guillaume Verdon-Akzam, San Fransisco, CA (US)

(73) Assignee: Extropic Corp., Austin, TX (US)

(21) Appl. No.: 18/977,690

(22) Filed: Dec. 11, 2024

Related U.S. Application Data
(60) Provisional application No. 63/562,576, filed on Mar. 7, 2024.

(51) Int. Cl. G06N 3/084; G06N 3/045

(52) U.S. Cl. CPC G06N 3/084; G06N 3/045

(57) ABSTRACT

A thermodynamic computing system is implemented using one or more thermodynamic chips that implement a plurality of energy based models (EBMs). Each EBM comprises oscillators, wherein the oscillators represent neuron and synapse values of an engineered energy potential. The synapse values may be updated or trained via mean-field forwards and backwards propagation. During the forwards propagation, the energy potentials of the EBMs are not perturbed, and gradient terms are obtained. During the backwards propagation, the energy potentials of the EBMs are perturbed, and additional gradient terms are obtained. The gradient terms may be combined with the additional gradient terms to determine updated synapse values.

### BACKGROUND

### Related Application

This application claims benefit of priority to U.S. Provisional Application Ser. No. 63/562,576, entitled “MEAN-FIELD FORWARDS AND BACKWARDS PROPAGATION TECHNIQUES FOR NEURAL NETWORK INFERENCE AND LEARNING USING THERMODYNAMIC COMPUTING,” filed Mar. 7, 2024, and which is incorporated herein by reference in its entirety.

### Description of Related Art

Various algorithms, such as machine learning algorithms, often use statistical probabilities to make decisions or to model systems. Some such learning algorithms may use Bayesian statistics, or may use other statistical models that have a theoretical basis in natural phenomena. Also, machine learning algorithms themselves may be implemented using Bayesian statistics, or may use other statistical models that have a theoretical basis in natural phenomena.

Generating such statistical probabilities may involve performing complex calculations which may require both time and energy to perform, thus increasing a latency of execution of the algorithm and/or negatively impacting energy efficiency. In some scenarios, calculation of such statistical probabilities using classical computing devices may result in non-trivial increases in execution time of algorithms and/or energy usage to execute such algorithms.

As an alternative, algorithms may be performed using thermodynamic computers. However, communication between multiple algorithms implemented on a thermodynamic computing device and/or communications between thermodynamic computing devices may require converting information into a classical computing device form, thus reducing at least some of the benefits of a thermodynamic computer implementation.

### BRIEF DESCRIPTION OF THE DRAWINGS

FIG. 1A is a high-level diagram illustrating a thermodynamic system of one or more thermodynamic chips that are configured to implement energy based models (EBM) and relay gadgets, wherein the thermodynamic system is configured to determine gradients used to update synapse oscillators of the EBMs, according to some embodiments.

FIG. 1B is a high-level diagram illustrating oscillators of energy based models (EBMs) that represent neurons and synapse values that may be perturbed by the thermodynamic system, according to some embodiments.

FIG. 2 is a high-level diagram illustrating a plurality of EBMs that collectively represent a neural network, wherein output oscillators and relay oscillators are measured by a classical computing device to calculate gradient terms during a forwards pass, according to some embodiments.

FIG. 3 is a high-level diagram illustrating a plurality of energy based models (EBMs) that may be used to determine gradient terms used to update synapses, wherein synapses of respective energy potentials of the EBMs are dynamical degrees of freedom, according to some embodiments.

FIG. 4A is a high-level diagram illustrating a plurality of energy based models (EBMs) that may be used to determine gradient terms during a forwards pass used to update synapses, wherein gradient terms are obtained on a plurality of relay oscillators thus requiring fewer measurements, according to some embodiments.

FIG. 4B is a high-level diagram illustrating a plurality of energy based models (EBMs) that may be used to determine gradient terms during a backwards pass used to update synapses, wherein gradient terms are obtained on a plurality of relay oscillators thus requiring fewer measurements, according to some embodiments.

FIG. 5 is a high-level diagram illustrating gradient terms, that may be used to update synapse values, obtained using relay oscillators in an analogue way, according to some embodiments.

FIG. 6 is high-level diagram illustrating a process of determining weights and biases to be used in an energy-based model (EBM), wherein the weights and biases are determined using measurement values for synapse oscillators, according to some embodiments.

FIG. 7 is high-level diagram illustrating a process of determining weights and biases to be used in an energy-based model (EBM), wherein the weights and biases are computed using a classical computing device, according to some embodiments.

FIG. 8 is a diagram illustrating hardware components that may be used to implement oscillators of energy-based models (EBMs), as well as two different example hardware configurations of a relay oscillator that have a time-dependent mass or a time-dependent frequency, respectively, according to some embodiments.

FIG. 9 is a diagram providing additional details regarding a hardware configuration used to implement a relay oscillator with a time-dependent frequency, according to some embodiments.

FIG. 10 is a diagram providing additional details regarding a hardware configuration used to implement a relay oscillator with a time-dependent mass, according to some embodiments.

FIG. 11 is a high-level diagram illustrating an output oscillator, an input oscillator, and a relay gadget, wherein the relay gadget comprises a group of relay oscillators and is configured to relay thermodynamic information between the output oscillator and the input oscillator and includes bias oscillators, according to some embodiments.

FIG. 12 is a high-level diagram illustrating a spatial analogue relay gadget, wherein respective ones of relay oscillators of a group of relay oscillators are configured to store respective sample values of an output oscillator, according to some embodiments.

FIG. 13 is a high-level diagram illustrating a temporal analogue relay gadget, wherein a group of relay oscillators comprises a single relay oscillator, according to some embodiments.

FIG. 14 is a high-level diagram illustrating a series analogue relay gadget, wherein a group of relay oscillators comprises a plurality of relay oscillators arranged in series, according to some embodiments.

FIG. 15A illustrates example couplings between visible neurons of an energy-based model (EBM), according to some embodiments.

FIG. 15B illustrates example couplings between visible neurons and non-visible neurons (e.g., hidden neurons) of an energy-based model (EBM), according to some embodiments.

FIG. 16 is a high-level diagram illustrating oscillators included in a substrate of the thermodynamic chip and mapping of the oscillators to logical neurons of the thermodynamic chip, according to some embodiments.

FIG. 17 is an additional high-level diagram illustrating oscillators included in a substrate of the thermodynamic chip mapped to logical neurons, weights, and biases of a given neuro-thermodynamic computing system, according to some embodiments.

FIG. 18 is a high-level flowchart illustrating the process of implementing energy based models and determining gradients that may be used to update synapse oscillators representing synapse values, according to some embodiments.

FIG. 19 is a block diagram illustrating an example computer system that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof.

### DETAILED DESCRIPTION

The present disclosure relates to methods, systems, and/or apparatuses for a thermodynamic system comprising one or more thermodynamic chips used to implement a plurality of energy based models (EBMs) configured to thermodynamically evolve. The thermodynamic system may be configured to implement a neural network by using oscillators of the EBMs. Some oscillators of the respective EBMs may be neuron oscillators representing neuron values, and other respective oscillators of the respective EBMs are synapse oscillators representing synapse values. In some embodiments, the synapse oscillators, when coupled with the neuron oscillators, establish an engineered potential that is configured to be perturbed. In some embodiments, one or more relay gadgets, each comprising one or more oscillators (relay oscillators) may be configured to relay thermodynamic information between the EBMs as the EBMs thermodynamically evolve in a forward pass and a backward pass. In some embodiments, respective EBMs may represent respective layers of a neural network. The forwards and backwards passes may be used to determine gradients used for training the EBMs. For example, gradient terms (forwards gradient terms) of a given EBM are determined during the forwards pass, wherein the engineered energy function is not perturbed in the forward pass. Furthermore, as an example, gradient terms (backwards gradient terms) of the given EBM are determined during the backwards pass, wherein the engineered energy function is perturbed in the backward pass.

In some embodiments, a classical computing device may be used to measure thermodynamic information of one or more synapse oscillators of a given EBM, compute the forwards or backwards gradient terms of a given EBM based on the measurements of the synapse oscillators, and determine updated synapse values based on the forwards or backwards gradient terms. In other embodiments, additional relay oscillators configured to couple and uncouple with other oscillators may be used to determine the forwards or backwards gradient terms based on respective relay oscillators evolving thermodynamically and may be used to update synapse values based on the forwards or backwards gradient terms based on respective relay oscillators evolving thermodynamically.

In some embodiments, a thermodynamic system may be used to implement a neural network. The thermodynamic system may take input data and output inference data. For example, oscillators of an energy based model (EBM) such as described herein may take the input data and evolve thermodynamically to generate inferences based on the input data. The thermodynamic system may be configured to train itself and to minimize a loss function when using labeled training data. Training may comprise determining gradients of a loss function such as a first derivative and second derivative (e.g., Hessian) of the loss function with respect to synapse values and updating synapse oscillators representing the synapse values. In this way, a thermodynamic training scheme may intelligently train the model. In some embodiments, a thermodynamic system may use measurements of output oscillators and/or relay oscillators to determine gradient terms used to update synapse values (e.g., synapse values such as weights and biases). In some embodiments, a thermodynamic system may use measurements of input oscillators and synapse oscillators to determine the gradient terms. Furthermore, in some other embodiments, gradient terms may be determined using a plurality of additional relay oscillators.

In some embodiments, a forwards pass may comprise determining gradients wherein energy potentials of respective EBMs are not perturbed. The energy potentials of respective EBMs are based on synapse values such as weights and biases of neuron oscillators. The energy potential may be tuned throughout a training process to improve metrics such as a loss function, wherein inference results that more closely match labeled training data result in less loss. In some embodiments, a backwards pass may comprise determining gradients wherein the energy potentials of respective EBMs are perturbed. The gradient of the unperturbed potential and the gradient of the perturbed potential may be combined to determine how to update synapse parameters of the thermodynamic system. The thermodynamic system may perturb the energy potential of respective EBMs by adjusting input or output oscillators by a small amount. For example, each neuron of a given EBM block may have an energy potential that is perturbed. Such a perturbed energy potential may be obtained by turning on additional coupling terms, wherein the coupling terms may be mediated via relay oscillators. Thus, by way of example, a gradient terms may be stored in the position degrees of freedom of relay oscillators, wherein such relay oscillators are coupled to output oscillators. Perturbing the energy potentials during a backwards pass allows for gradients of the loss function to be measured directly. Therefore, fewer computations on external classical computing devices may be needed. The perturbed potential may be linear in the outputs of the given EBM block.

Several schemes for performing mean-field forwards and backwards propagation may be implemented, wherein each layer of a deep neural network may be implemented using an energy based model (EBM). In some embodiments, relay oscillators may be coupled to an output of an EBM during the forward pass. The relay oscillators may be used to store the thermal equilibrium expectation value of the output of an EBM, which may then be used as input to a next EBM layer. Relay oscillators may also be used to store gradients during the forwards pass. The potential energy function of an EBM may be chosen such that the thermal equilibrium expectation value of the output may be similar to a result obtained in a layer of a corresponding deep neural network. Several schemes may be used to perform mean-field backwards propagation. In some embodiments, mean-field corresponds to using a computed expectation value to compute derivatives of a loss function with respect to parameters (e.g., synapses such as weights and biases) of each EBM.

In some embodiments, thermal equilibrium expectation values may be stored in one or more relay oscillators and used as inputs to the next EBM block. Gradients of a loss function may be computed by using sample values to compute expectation values. In some embodiments, finite difference methods may be applied to compute a desired gradient. In some embodiments, a small perturbation to the potential energy function during the backwards pass may result in being able to measure the gradients of the loss function directly. This may allow for fewer computations on an external classical processing device than otherwise. Furthermore, the perturbed potential may be chosen in order to obtain desired gradients. The gradients may be used to update synapse oscillators representing synapse parameters (e.g., synapses such as weights and biases) of the EBM during training of the EBM.

### Mean-Field Forwards Propagation

In some embodiments, both analog and digital methods for performing forward propagation in deep learning models may be implemented with energy based models. For example, the protocols described herein may make use of relay oscillator methods.

For example, consider an l'th layer of a deep learning network with input xₗ and output yₗ. The probability of a given output yₗ may be given by,

$$p ( {y}_{l} \vert {x}_{l} , {θ}_{l} ) = \frac{{e}^{- {ℰ}_{{θ}_{l}} ( {y}_{l} \vert {x}_{l} )}}{Z ( {x}_{l} , {θ}_{l} )} , \qquad ( equation 1 )$$

where ε_{θ}_{ₗ} may be a potential energy function of the l'th block with parameters θₗ (e.g., synapses such as weights and biases). The energy function ε_{θ}_{ₗ} may be chosen such that the thermal equilibrium expectation value, i.e.,

$$〈 {y}_{l} 〉 = \int d {y}_{l} {y}_{l} \frac{{e}^{- {ℰ}_{{θ}_{l}} ( {y}_{l} \vert {x}_{l} )}}{Z ( {x}_{l} , {θ}_{l} )} , \qquad ( equation 2 )$$

may be equal to the desired output of a deep learning model. That is, in expectation value, the EBM model with energy function ε_{θ}_{ₗ} performs computation such as block l of a desired neural network. The nodes xₗ and yₗ may be harmonic oscillators which encode the values of the inputs and outputs to the EBM with energy function ε_{θ}_{ₗ}. In what follows, ϕₓ_{ⱼ} may denote the position degrees of freedom for the oscillators which encode the value xⱼ as input to the EBM block with potential ε_{θ}_{ⱼ}. Similarly, the outputs yⱼ may be encoded in the position degrees of freedom of the oscillators ϕ_{y}_{ⱼ}. Lastly, the position degrees of freedom of the relay oscillators coupled to ϕ_{y}_{ⱼ} may be labelled as ϕᵣ_{ⱼ}.

### Obtaining Expectation Values Using Relay Oscillators

In some embodiments, a coupling Hamiltonian may describe the dynamics of a relay oscillator. For example, for some hyperparameters for the coupling pulses, and at thermal equilibrium, an expectation value [symbol] yₗ [symbol] may be transferred to a state of the relay oscillator ϕᵣ_{ₗ}. The Hamiltonian may be given by,

$${H}_{rel}^{( j , l )} = \frac{{( {π}_{{r}_{l}}^{( j )} )}^{2}}{2 {m}_{{r}_{l}}^{( j )}} + \frac{{( {π}_{{y}_{l}}^{( j )} )}^{2}}{2 {m}_{{y}_{l}}^{( j )}} + \frac{1}{2} {m}_{{r}_{l}}^{( j )} ( t ) {( {ω}_{{r}_{l}}^{( j )} ( t ) )}^{2} {( {ϕ}_{{r}_{l}}^{( j )} )}^{2} + {ℰ}_{{θ}_{l}} ( {ϕ}_{{y}_{l}} \vert {ϕ}_{{x}_{l}} , {θ}_{l} ) + {λ}_{A} ( t ) {( {ϕ}_{{r}_{l}}^{( j )} - {ϕ}_{{y}_{l}}^{( j )} )}^{2} + {λ}_{X} ( t ) {ϕ}_{{r}_{l}}^{( j )} {ϕ}_{{x}_{l + 1}}^{( j )} + {λ}_{B} ( t ) {ϕ}_{{b}_{l}}^{( j )} {ϕ}_{{r}_{l}}^{( j )} , \qquad ( equation 3 )$$

where ϕ_{b}_{ₗ}^{(j)} are bias oscillators which are coupled to the relay oscillators. For example, the dynamics of a system for the j^{th} oscillator of the l^{th} layer with relay oscillators may be governed by a Hamiltonian that includes: kinetic energy terms of the relay oscillator and output oscillator, a potential of the relay oscillator, the potential of the l^{th} layer of the EBM given input oscillators and synapse parameters (e.g., synapses such as weights and biases), a time dependent coupling between the relay oscillator and the output oscillators, time dependent coupling between the relay oscillator and the input oscillator of the next EBM layer, and a time dependent coupling between an optional bias oscillator and the relay oscillator. The time-dependent coupling pulses λ_{A}(t), λ_{X}(t) and λ_{B}(t) may take the form,

$$( respectively equations 4 , 5 , and 6 )$$

$${λ}_{A} ( t ) = {λ}_{A} ( σ ( {k}_{A} ( t - {t}_{1}^{( A )} ) ) - σ ( {k}_{A} ( t - {t}_{2}^{( A )} ) ) ) \\ {λ}_{X} ( t ) = {λ}_{X} σ ( {k}_{X} ( t - {t}_{1}^{( X )} ) ) + {λ}_{0}^{( X )} . {λ}_{B} ( t ) = {λ}_{B} σ ( {k}_{B} ( t - {t}_{1}^{( B )} ) ) + {λ}_{0}^{( B )} ,$$

where σ(x) may be the sigmoid function. Appropriate choices of the hyperparameters in equations 3-6 can ensure that after ϕᵣ_{ₗ}^{(l)} may be decoupled from ϕ_{y}_{ₗ}^{(j)}, samples taken of ϕᵣ_{ₗ}^{(j)} may approximately be given by [symbol] ϕ_{y}_{ₗ}^{(j)} [symbol] . The hyperparameters can also be chosen such that the coupling between the relay oscillator and ϕₓ_{ₗ₊₁}^{(j)} imparts [symbol] ϕ_{y}_{ₗ}^{(j)} [symbol] to ϕₓ_{ₗ₊₁}^{(j)}. The product of mass time frequency of ϕₓ_{ₗ₊₁}^{(j)} may be increased such that it remains clamped at [symbol] ϕ_{y}_{ₗ}^{(j)} [symbol] . Therefore, the input to the EBM block with potential energy ε_{θ}_{ₗ₊₁} may be given by the computed value of the l'th layer of a deep neural network. In other embodiments, (e.g., in a fully digital implementation instead of analogue), the coupling between ϕᵣ_{ₗ}^{(j)} and ϕₓ_{ₗ₊₁}^{(j)} may be removed altogether and the position ϕᵣ_{ₗ}^{(j)} may be measured. The measured value may still correspond to approximately [symbol] ϕ_{y}_{ₗ}^{(j)} [symbol] . Then the oscillator ϕₓ_{ₗ₊₁}^{(j)} may be clamped using a clamping potential of the form λ_{c}(ϕₓ_{ₗ₊₁}^{(j)}− [symbol] ϕ_{y}_{ₗ}^{(j)} [symbol] )² for some large value of λ_{c}.

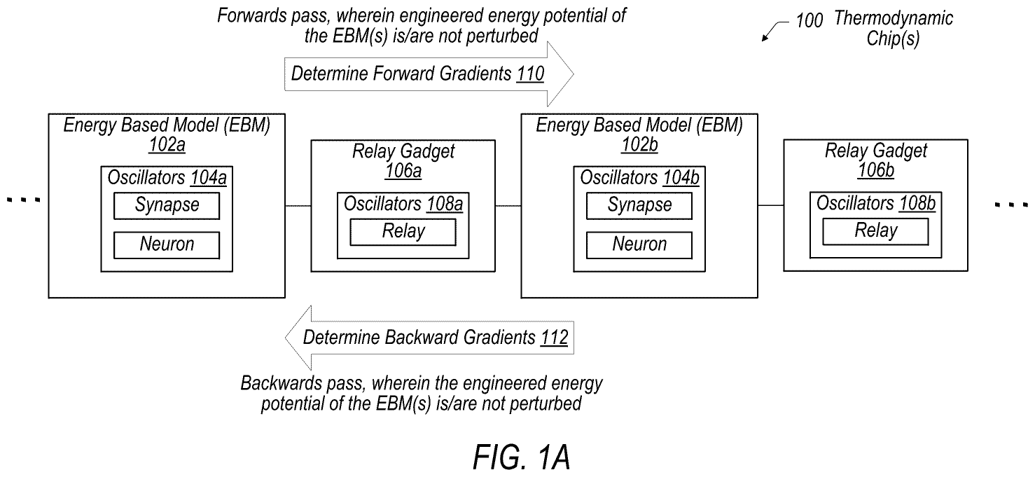

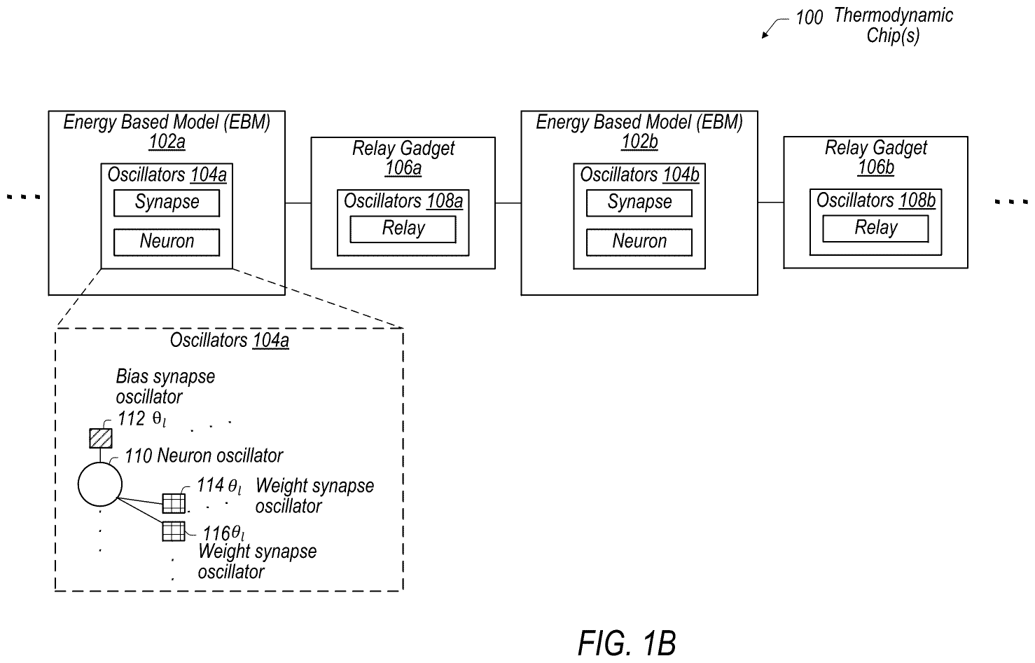

FIG. 1A is a high-level diagram illustrating a thermodynamic system of one or more thermodynamic chips comprising energy based models (EBM) and relay gadgets, wherein the thermodynamic system is configured to determine gradients used to update synapse oscillators of EBMs, according to some embodiments.

In some embodiments, thermodynamic chip(s) 100 comprise energy based models (EBMs) 102a-b and relay gadgets 106a-b. Relay gadgets 106a-b may comprise relay oscillators 108a used to relay thermodynamic information, such as expectation values, of neuron oscillators 104a to neuron oscillators of 104b. Synapse oscillators of oscillators 104a and 104b may be used to process thermodynamic information, wherein oscillators 104a and 104b evolve thermodynamically according to an energy potential (e.g., according to Langevin dynamics). Synapse oscillators and neuron oscillators of oscillators 104a of EBM 102a may be coupled together to establish an energy potential. The thermodynamic system represented in FIG. 1 may be used to determine gradients, wherein the gradient terms may be used to update synapse oscillators of EBMs. In a forwards pass, wherein engineered energy potentials of the EBMs are not perturbed, the system may determine forward gradients 110. In a backwards pass, the engineered energy potential of the EBMs are perturbed to determine backward gradients 112. Gradients may be useful to determine how to update parameters such as described herein. FIG. 1 shows a segment of a chain of EBMs 102a-b and relay gadgets 106a-b. A plurality of EBMs may be used to represent respective layers of a neural network.

### Performing Forwards Propagation Using Relay Oscillator Expectation Values

In some embodiments, to ensure that the input of EBM 102b (e.g., the input neuron oscillators of the l'th EBM block, wherein the EBM block corresponds to the l'th layer of a deep neural network) may be clamped to [symbol] ϕ_{y}_{_{l−1}}^{(j)} [symbol] , which corresponds to the output of EBM 102a of the l−1 layer of a deep neural network. Consequently, forward propagation can be implemented by performing a protocol using relay oscillators of a relay gadget for each EBM block, where each EBM block has a potential energy chosen such that the thermal equilibrium expectation value of the output has the same value as the output that would be obtained by directly computing the given layer of a deep neural network on a classical computing device (e.g., GPU/FPGA chip).

### Computing the Gradients for Mean-Field Backpropagation

In some embodiments, a final layer of a deep neural network may be used to compute a loss function. The loss function may be any suitable loss function, for example, such as the mean squared error (MSE) loss function given by

$$\begin{matrix}M S E = \frac{1}{2 N} {\sum }_{i = 1}^{N} {( {y}_{i}^{( t )} - 〈 {y}_{i}^{( K )} 〉 )}^{2} \\ = \frac{1}{N} {\sum }_{i = 1}^{N} {L}_{i} ,\end{matrix} \qquad ( equation 7 )$$

$$where {L}_{i} = \frac{1}{2} {( {y}_{i}^{( t )} - 〈 {y}_{i}^{( K )} 〉 )}^{2} , \qquad ( equation 8 )$$

wherein a network with a total of K layers may be used. In equation 7, N may be the total number of training samples, yᵢ^{(t)} may be the ground truth and [symbol] yᵢ^{(K)} [symbol] may be the EBM models prediction (which may be emulating a deep neural network). In order to implement back propagation, gradient terms of the form

$$\frac{\partial {L}_{i}}{\partial {θ}_{l}^{( j )}} , \qquad ( equation 9 )$$

may be computed (e.g., determine backwards gradients 112), where θₗ^{(j)} may be the j'th parameter (e.g., synapses of oscillators 104a or 104b such as weights and biases) of ε_{θ}_{ₗ}. Using the chain rule, equation 9 may be written as

$$\frac{\partial {L}_{i}}{\partial {θ}_{l}^{( j )}} = \frac{\partial {L}_{i}}{\partial 〈 {y}_{l}^{( j )} 〉} \frac{\partial 〈 {y}_{l}^{( j )} 〉}{\partial {θ}_{l}^{( j )}} . \qquad ( equation 10 )$$

Later it is shown that

$$\frac{\partial 〈 {y}_{l}^{( j )} 〉}{\partial {θ}_{l}^{( j )}}$$

may be given by

$$\frac{\partial 〈 {y}_{l}^{( j )} 〉}{\partial {θ}_{l}^{( j )}} = - {Cov ( {y}_{l}^{( j )} , \frac{\partial {ℰ}_{{θ}_{l}} ( {y}_{l} \vert {x}_{l} )}{\partial {θ}_{l}^{( j )}} )}_{p ( {y}_{l} \vert {θ}_{l} , {x}_{l} )} . \\ Furthermore \frac{\partial {L}_{i}}{\partial 〈 {y}_{l}^{( j )} 〉} , \qquad ( equation 11 )$$

in the final layer K of the neural network, may be written as

$$\frac{\partial L}{\partial 〈 {y}_{K}^{( 1 )} 〉} = - ( {y}^{( t )} - 〈 {y}_{K}^{( 1 )} 〉 ) . \qquad ( equation 12 )$$

For the hidden layers, it may be written

$$\frac{\partial L}{\partial 〈 {y}_{l}^{( j )} 〉} = {\sum }_{s ∈ {𝒥}_{j}^{( l )}} \frac{\partial L}{\partial 〈 {y}_{l + 1}^{( s )} 〉} \frac{\partial 〈 {y}_{l + 1}^{( s )} 〉}{\partial 〈 {y}_{l}^{( j )} 〉} , \qquad ( equation 13 )$$

where the set [symbol] ⱼ^{(l)} includes all indices for which the output nodes yₗ₊₁^{(s)} are coupled to xₗ^{(j)}= [symbol] yₗ^{(j)} [symbol] . Furthermore, it may be shown that

$$\frac{\partial 〈 {y}_{l + 1}^{( s )} 〉}{\partial 〈 {y}_{l}^{( j )} 〉} = - {Cov ( {y}_{l + 1}^{( s )} , \frac{\partial {ℰ}_{{θ}_{l + 1}} ( {y}_{l + 1} \vert 〈 {y}_{l} 〉 )}{\partial 〈 {y}_{l}^{( j )} 〉} )}_{p ( {y}_{l + 1} \vert {θ}_{t + 1} , 〈 {y}_{i} 〉 )} , \qquad ( equation 14 )$$

where the input xₗ₊₁ to the EBM block in layer l+1 may be given by [symbol] yₗ [symbol] given the dynamics of the relay oscillators.

FIG. 1B is a high-level diagram illustrating oscillators of energy based models (EBMs) that represent neurons and synapse values that may be perturbed by the thermodynamic system, according to some embodiments.

In some embodiments, energy based model 102a comprises oscillators that represent neurons 110, and synapses (e.g., weights 114, 116 and biases 112). The example configuration shown in FIG. 1B illustrates that a neuron oscillator 110 may be coupled with bias synapse oscillators 112 and weights synapse oscillators 114 and 116. The synapse oscillators 112. 114, and 116 may be used, when coupled to neuron oscillator 110, to establish an energy potential such as energy potential 206a. Various arrangements of neuron oscillators and synapse oscillators may be used to establish various engineered energy potential based on the type of EBM being used. Furthermore, synapse oscillators such as 112, 114, and 116 may be updated based on gradient terms such as described herein. The hardware components of oscillators is described in later figures.

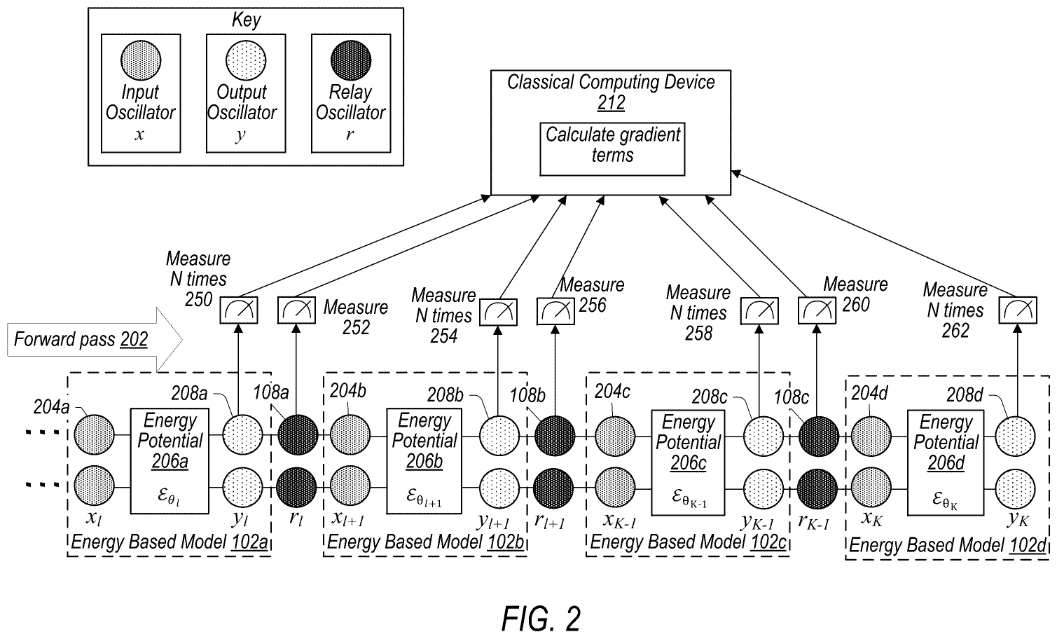

FIG. 2 is a high-level diagram illustrating a plurality of EBMs that collectively represent a neural network, wherein output oscillators and relay oscillators are measured by a classical computing device to calculate gradient terms during a forwards pass, according to some embodiments.

In some embodiments, during a forwards pass, energy potential 206a-d may comprise synapse values implemented in hardware (e.g., synapse values are not dynamical degrees of freedom). In such an embodiment, classical computing device 212 may measure a position or momentum degrees of freedom of output oscillators 208a an N number of times 250 during a forwards pass 202. Furthermore, classical computing device 212 may measure 252 position or momentum degrees of freedom of relay oscillators 108a. Similarly, output oscillators of each EBM may be measured N times (e.g., 254, 258, 262). By way of example, relay oscillators 108a may be used to relay thermodynamic information such as expectation values from output oscillator 208a to input oscillator 204b.

### Implementation of Covariance Calculation Wherein Synapse Parameters are Not Dynamical Degrees of Freedom

In some embodiments, covariances may be calculated. For example, the terms in equations 11, 12, and 14 can be computed using an architecture that comprises measuring output oscillators 208a-d and relay oscillators 108a-c and storing measured values in a classical computing device 212. In some embodiments, the measured values may be used as samples for backwards propagation later which may may be used to determine the expectation values in a covariance calculations, wherein the calculations may be computed on a classical post-processing device 212 such as an FPGA/ASIC chip.

For example, a forward pass 202 of a deep learning network is shown in FIG. 2, with the final layer (e.g., EBM 102d) computing a loss function (e.g., MSE loss). In some embodiments, at each output of a given EBM (e.g., output 208a of EBM 102a), and prior to coupling the output to the relay oscillator, an N number of measurements or samples (e.g., 250, 254, 258 or 262) of the position degree of freedom of the oscillators encoding the output may be performed. For example, at layer l, a number of measurements 250 (e.g., N samples) of ϕ_{y} 208a after the oscillators reach thermal equilibrium may be performed. Such measurements may be used to compute a portion of the terms in equations 11 and 14 since they may be used as samples for computing some of the expectation values. After the relay oscillators (e.g., 108a-c) are coupled to the output oscillators of an EBM block, the position degrees of freedom of the relay oscillators may be measured. In some embodiments, for the l'th EBM block 102a, measuring ϕᵣ_{ₗ} 108a would result in an approximate value for [symbol] yₗ [symbol] with the appropriate couplings, and time-dependent mass or frequencies. Now starting with

$$\frac{\partial 〈 {y}_{l}^{( j )} 〉}{\partial {θ}_{l}^{( j )}} ,$$

expanding the covariance term in equation 11 may result in

$$\frac{\partial 〈 {y}_{l}^{( j )} 〉}{\partial {θ}_{l}^{( j )}} = - {〈 {y}_{l}^{( j )} \frac{\partial {ℰ}_{{θ}_{l}} ( {y}_{l} \vert {x}_{l} )}{\partial {θ}_{l}^{( j )}} 〉}_{p ( {y}_{l} \vert {θ}_{l} , {x}_{l} )} + {〈 {y}_{l}^{( j )} 〉}_{p ( {y}_{l} \vert {θ}_{l} , {x}_{l} )} {〈 \frac{\partial {ℰ}_{{θ}_{l}} ( {y}_{l} \vert {x}_{l} )}{\partial {θ}_{l}^{( j )}} 〉}_{p ( {y}_{l} \vert {θ}_{l} , {x}_{l} )} . \qquad ( equation 15 )$$

In some embodiments, the term [symbol] yₗ^{(j)} [symbol] _{p(y}_{ₗ}_{|θ}_{ₗ}_{,x}_{ₗ}₎ may be obtained directly from the relay oscillator measurements during the forward pass 202. In other embodiments using an architecture where synapse values are chosen to be dynamical degrees of freedom, the term

$${〈 \frac{\partial {ℰ}_{{θ}_{l}} ( {y}_{l} \vert {x}_{l} )}{\partial {θ}_{l}^{( j )}} 〉}_{p ( {y}_{l} \vert {θ}_{l} , {x}_{l} )}$$

(such as shown later) may be computed by measuring the position or momentum of the parameters (e.g., synapses such as weights and biases) directly, wherein the gradient may be reconstructed. In some embodiments where synapse values are not chosen to be dynamical degrees of freedom, the gradient may be computed on a classic post-processing device 212 using all of the N measurement outcomes of the position degrees of freedom of the output EBM in layer l to approximate the expectation value. In such an embodiment, it may be written,

$${〈 \frac{\partial {ℰ}_{{θ}_{l}} ( {y}_{l} \vert {x}_{l} )}{\partial {θ}_{l}^{( j )}} 〉}_{p ( {y}_{l} \vert {θ}_{l} , {x}_{l} )} \approx \frac{1}{N} {\sum }_{s = 1}^{N} \frac{\partial {ℰ}_{{θ}_{l}} ( {y}_{l , s} \vert {x}_{l} )}{\partial {θ}_{l}^{( j )}} , \qquad ( equation 16 )$$

where y_{l,s} may be the sample s∈1, . . . , N of the output nodes yₗ, which may be sampled from the probability distribution p(yₗ|θₗ,xₗ). Similarly, such samples may be used to approximate the expectation value of the term

$${〈 {y}_{l}^{0 )} \frac{\partial {ℰ}_{{θ}_{l}} ( {y}_{l} \vert {x}_{l} )}{\partial {θ}_{l}^{( j )}} 〉}_{p ( {y}_{l} \vert {θ}_{l} , {x}_{l} )}$$

using a similar formulation as in equation 16.

Furthermore, from equation 14

$$( equation 17 ) .$$

$$\frac{\partial 〈 {y}_{l + 1}^{( s )} 〉}{\partial 〈 {y}_{l}^{( j )} 〉} = - {〈 {y}_{l + 1}^{( s )} \frac{\partial {ℰ}_{{θ}_{l + 1}} ( {y}_{l + 1} 1 〈 {y}_{l} 〉 )}{\partial ( {y}_{l}^{( j )} 〉} 〉}_{p ( {y}_{l + 1} \vert {θ}_{l + 1} , 〈 {y}_{l} 〉 )} + {〈 {y}_{l + 1}^{( s )} 〉}_{p ( {y}_{l + 1} \vert {θ}_{l + 1} , 〈 {y}_{l} 〉 )} {〈 \frac{\partial {ℰ}_{{θ}_{l + 1}} ( {y}_{l + 1} \vert 〈 {y}_{l} 〉 )}{\partial 〈 {y}_{l}^{( j )} 〉} 〉}_{p ( {y}_{l + 1} \vert {θ}_{l + 1} , 〈 {y}_{l} 〉 )} ,$$

Similarly to equation 15, the N measured samples of the output 208b of the block l+1 (e.g., EBM 102b) obtained during the forward pass may be used to compute an approximation of the first term on the right-hand side of equation 15, as well as the term

$${〈 \frac{\partial {ℰ}_{{θ}_{l + 1}} ( {y}_{l + 1} \vert 〈 {y}_{l} 〉 )}{\partial 〈 {y}_{l}^{( j )} 〉} 〉}_{p ( {y}_{l + 1} \vert {θ}_{l + 1} , 〈 {y}_{l} 〉 )} .$$

### Architecture for Finite Difference Methods, Wherein Synapse Parameters are Dynamical Degrees of Freedom

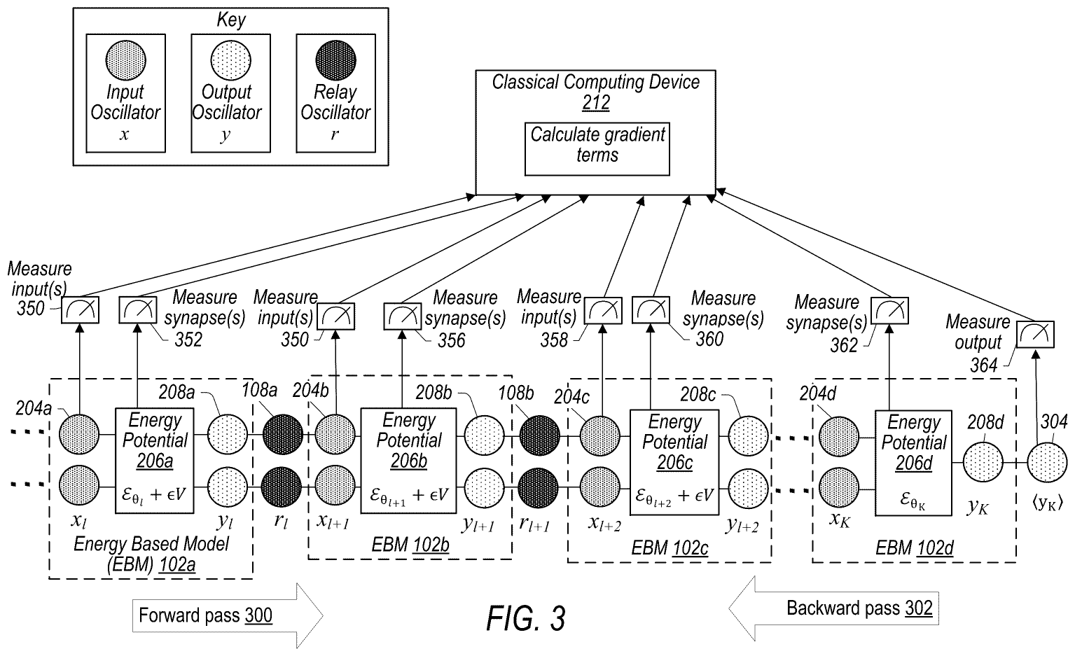

FIG. 3 is a high-level diagram illustrating a plurality of energy based models (EBMs) that may be used to determine gradient terms used to update synapses, wherein synapses of respective energy potentials of the EBMs are dynamical degrees of freedom, according to some embodiments.

In some embodiments, parameters (e.g., synapses such as weights and biases) of energy potential 206a-d may be dynamical degrees of freedom. For example, gradients of the loss function in equation 9 may be obtained by performing a series of measurements 362 of the parameters (e.g., synapses such as weights and biases) of energy potential 206d and measurements of output neurons (e.g., output oscillator 304). In such an embodiment, the architecture comprises parameters θ (e.g., synapses such as weights and biases) of energy potentials 206a-c that are dynamical degrees of freedom. By setting the product of mass times frequency squared of the parameters (e.g., synapses) to be large relative to the input neurons 204a-c and output neurons 208a-c of a given EBM block, respectively EBMs 102a-c, the timescale of the dynamics of the parameters of the energy potentials 206a-c may be much slower than those of the neurons 204a-c and 208a-c. For example, changes in the expectation values of the output neurons 208a-c, given small changes in the parameters θ, may be measured.

For example, the Langevin equation of motion for the θ parameter oscillators (e.g., representing synapse values such as weights and biases) of energy potential 206a-c may be written as

$$\frac{d {π}_{{θ}_{l}^{( j )}} ( t )}{d t} = - γ {π}_{{θ}_{l}^{( j )}} ( t ) - \frac{\partial {H}_{t o t}}{\partial {ϕ}_{{θ}_{l}}^{( j )}} {\vert}_{t} + \sqrt{2 {m}_{l} γ {k}_{B} T} \frac{d {W}_{t}}{d t} , \qquad ( equation 18 )$$

where π_{θ}_{ₗ}_{^{(j)}} may be understood to be the momentum of the degree of freedom of the j'th oscillator in layer l, and ϕ_{θ}_{ₗ}^{(j)} may be its conjugate position degree of freedom. The parameter γ may represent friction, mₗ may be the mass of the parameters for the EBM in layer l, and Wₜ may be a Wienner process. Similarly, variables may be used for each layer (e.g., layers l, l+1, l+2, etc.), wherein layer l may represent a given layer. Integrating equation 18, wherein the momentum dependence of the Hamiltonian in equation 18 only arises through its kinetic term, the following may result

$$( equation 19 )$$

$${π}_{{θ}_{l}^{( j )}} ( t ) - {π}_{{θ}_{l}^{( j )}} ( 0 ) + γ {\int }_{0}^{t} {π}_{{θ}_{l}^{( j )}} ( τ ) d τ = \text{} - {\int }_{0}^{t} {〈 \frac{\partial {ℰ}_{{θ}_{l}} ( {ϕ}_{{y}_{l}} \vert {x}_{l} )}{\partial {ϕ}_{{θ}_{l}}^{( j )}} {\vert}_{τ} 〉}_{p {θ}_{l} ( {y}_{l} \vert {x}_{l} )} d τ + \sqrt{2 {m}_{l} γ {k}_{B} T} {\int }_{0}^{T} d {W}_{τ} .$$

As can be seen from equation 19, by performing measurements of the momentum degrees of freedom of the oscillators (synapse oscillators) for some time t, averaged gradients of the energy function may be computed. The time interval and system parameters may be chosen to minimize variance in the measurement due to the noise term. In some embodiments, such as in what follows, since gradients of the form

$$\frac{\partial {L}_{i}}{\partial 〈 {y}_{l}^{( j )} 〉} , \frac{\partial 〈 {y}_{l}^{( j )} 〉}{\partial {θ}_{l}^{( j )}} and \frac{\partial 〈 {y}_{l + 1}^{( s )} 〉}{\partial 〈 {y}_{l}^{( j )} 〉}$$

may be computed (see equations 10 and 13), changes in expectation values of the form [symbol] yₗ^{(j)} [symbol] (e.g., expectation value of output relay oscillators 208a) given changes in the parameters θ (e.g., synapses such as weights and biases) of energy potential 206a during a back propagation step (e.g., backward pass 302) may be measured.

In some embodiments, a protocol for the output layer K (e.g., EBM 102d) is described herein. The gradient of a loss function with respect to the parameters of the output layer EBM 102d (e.g., synapses such as weights and biases) may be given by

$$\frac{\partial L}{\partial {θ}_{K}^{( j )}} = - ( y - 〈 {y}_{K}^{( 1 )} 〉 ) \frac{\partial 〈 {y}_{K}^{( 1 )} 〉}{\partial {θ}_{K}^{( j )}} , \qquad ( equation 20 )$$

where for simplicity the indices i in L have been omitted. If changes in the position degrees of freedom of the parameters θ_{K}^{(j)} (e.g., synapses such as weights and biases) of energy potential 206d are measured while simultaneously measuring the updated [symbol] y_{K}⁽¹⁾ [symbol] (e.g., expectation value of output oscillator 304) of the output neurons,

$$\frac{\partial 〈 {y}_{K}^{( 1 )} 〉}{\partial {θ}_{K}^{( j )}}$$

may be computed as

$$\frac{\partial 〈 {y}_{K}^{( 1 )} 〉}{\partial {θ}_{K}^{( j )}} \approx \frac{〈 {y}_{K}^{( 1 )} 〉 ( t + δ t ) − 〈 {y}_{K}^{( 1 )} 〉 ( t )}{{θ}_{K}^{( j )} ( t + δ t ) − {θ}_{K}^{( j )} ( t )} ,$$

(equation 21) which may be a good approximation for small time intervals of size δt if [symbol] y_{K}⁽¹⁾ [symbol] behaves linearly. Furthermore, measurements for varying time intervals may be performed to confirm the linear behavior of [symbol] y_{K}⁽¹⁾ [symbol] , wherein an appropriate size for δt may be chosen. In some embodiments, the protocol for the output layer EBM 102d may be summarized as follows:

At time t, the thermodynamic system may initialize the parameters θ_{K}^{(j)} (e.g., synapses such as weights and biases) of energy potential 206d to the values they had during a forward pass 300.

The thermodynamic system may allow the parameters θ_{K}^{(j)} to evolve for time δt, and perform at least one measurement of 0_{K}^{(j)} and [symbol] y_{K}⁽¹⁾ [symbol] in such a time interval.

The thermodynamic system may use equation 24 to approximate the gradient

$$\frac{\partial 〈 {y}_{K}^{( 1 )} 〉}{\partial {θ}_{K}^{( j )}}$$

on an external classical computing device 212 (e.g., FPGA/ASIC chip).

The thermodynamic system may compute

$$\frac{\partial L}{\partial {θ}_{K}^{( j )}}$$

using equation 20.

Note that the value [symbol] y_{K}⁽¹⁾ [symbol] (t) 304 may be already known by the thermodynamic system as it may be measured during the forward pass 300.

In some embodiments, a protocol for the hidden layers (e.g., EBMs 102a-c) is described herein. For the hidden layers EBMs 102a-c, gradient terms may be written

$$\frac{\partial L}{\partial {θ}_{l}^{( j )}} = {\sum }_{n} \frac{\partial L}{\partial 〈 {y}_{l}^{( n )} 〉} \frac{\partial 〈 {y}_{l}^{( n )} 〉}{\partial {θ}_{l}^{( j )}} , \qquad ( equation 22 )$$

$$and$$

$$\frac{\partial L}{\partial 〈 {y}_{l}^{( j )} 〉} = {\sum }_{s ∈ {𝒥}_{j}^{( l )}} \frac{\partial L}{\partial 〈 {y}_{l + 1}^{( s )} 〉} \frac{\partial 〈 {y}_{l + 1}^{( s )} 〉}{\partial 〈 {y}_{l}^{( j )} 〉} ,$$

(equation 23). In the l'th layer, [symbol] yₗ^{(j)} [symbol] (e.g., expectation value of output oscillator 208a) may be determined given small changes in θₗ^{(j)} (e.g., synapse values of energy potential 206a) and use an approximation such as

$$\frac{\partial 〈 {y}_{l}^{( j )} 〉}{\partial {θ}_{l}^{( j )}} \approx \frac{〈 {y}_{l}^{( j )} 〉 ( t + δ t ) - 〈 {y}_{l}^{( j )} 〉 ( t )}{{θ}_{l}^{( j )} ( t + δ t ) - {θ}_{l}^{( j )} ( t )} ,$$

(equation 24). In some embodiments, equation 23 may be used, wherein the previously computed values

$$\frac{\partial L}{\partial 〈 {y}_{l + 1}^{( s )} 〉}$$

in addition to changes in [symbol] yₗ₊₁^{(s)} [symbol] (e.g., output oscillators 208b) given changes in [symbol] yₗ^{(j)} [symbol] (e.g., output oscillators 208a) are used, wherein the values are computed by the thermodynamic system. For example, when the parameters θₗ^{(j)} (e.g., synapses such as weights and biases) of energy potential 206a result in a change in [symbol] yₗ^{(j)} [symbol] (e.g., output oscillators 208a), the new input for EBM 102b may be used to compute the change in [symbol] yₗ₊₁^{(s)} [symbol] (e.g., output oscillators 208b), wherein output of output oscillators 208a may be relayed via relay oscillators 108a to input oscillators 204b. Consequently, this allows the gradient

$$\frac{\partial 〈 {y}_{l + 1}^{( s )} 〉}{\partial 〈 {y}_{l}^{( j )} 〉}$$

to be approximated by the thermodynamic system.

### Architecture for Perturbed Mean Field Back Propagation, Wherein Synapse Parameters are Dynamical Degrees of Freedom

In some embodiments, mean field backwards propagation may be performed using a device that comprises synapses that are dynamical degrees of freedom. In some embodiments, mean field backwards propagation (e.g., backwards pass 302) comprises adding a small perturbation to the original potential energy function 206a-d of a given EBM block 102a-d. Is some embodiments, throughout both the forwards pass 300 (wherein gradient terms are found without perturbing the potentials of energy potentials 206a-d) and backwards pass 302 (wherein gradient terms are found with a perturbed potential of energy potentials 206a-d), the parameters θ (e.g., synapses such as weights and biases) of energy potentials 206a-d are dynamical degrees of freedom following Langevin dynamics as in equation 18.

In some embodiments during the forward pass 300, at each EBM block, momentum measurements of the parameters (e.g., synapses) of energy potentials 206a-d may be used, to obtain the gradient terms of the form

$${𝔼 [ \frac{\partial {ℰ}_{{θ}_{l}} ( {y}_{l} \vert {x}_{l} )}{\partial {θ}_{l}^{( j )}} ]}_{{p}_{{θ}_{l}} ( {y}_{l} \vert {x}_{l} )} , \qquad ( equation 25 ) .$$

Furthermore, the expectation value may be taken over the distribution

$${p}_{{θ}_{l}} ( {y}_{l} \vert {x}_{l} ) = \frac{{e}^{- {ɛ}_{{θ}_{l}} ( {y}_{l} \vert {x}_{l} )}}{Z} , . \qquad ( equation 26 )$$

Such gradients may be recorded on an external classical computing device 212 such as an FPGA/ASIC chip. Furthermore, for each EBM block 102a-c, the average state of an output oscillator 208a-c may be measured after the state of the output oscillator is transferred to respective relay oscillators 108a-b. For instance, for an EBM block 102a in layer l, [symbol] yₗ [symbol] (e.g., expectation value of output oscillator 208a) may be measured and stored.

In some embodiments, during a forwards pass 300, in addition to measuring the gradients in equation 25 using an architecture with parameters (e.g., synapses of energy potential 206b) that are dynamical degrees of freedom, gradients of the form

$${𝔼 [ \frac{\partial {ɛ}_{{θ}_{l + 1}} ( {y}_{l + 1} \vert 〈 {y}_{l} 〉 )}{\partial 〈 {y}_{l}^{( j )} 〉} ]}_{{p}_{{θ}_{l + 1}} ( {y}_{l + 1} \vert 〈 {y}_{l} 〉 )} , \qquad ( Equation 27 )$$

may be measured for each EBM block (e.g., EBM 102b-c). In order to obtain such gradients, a similar architecture to the one used for measuring gradients of the parameters θ (e.g., synapses such as weights and biases) may be used. For example, consider an EBM block 102b in layer l+1. After being coupled with the relay oscillator 108a, the input oscillator xₗ₊₁ 204b may be clamped to the state [symbol] yₗ [symbol] (e.g., expectation value of output oscillator 208a). By tuning the product of mass time frequency squared of the input oscillators 204b, which encode the state [symbol] yₗ [symbol] , such oscillators (e.g. input xₗ₊₁ 204b) may undergo Langevin dynamics with their position degrees of freedom changing on a much slower time scale relative to the output oscillators 208b which encode the state yₗ₊₁. By measuring the momentum degrees of freedom of the output oscillators 208a encoding the state [symbol] yₗ [symbol] (prior to their evolution), such momentum measurements can then be used to reconstruct the gradient in equation 27.

For example, a protocol for a forwards pass may be given as follows:

A thermodynamic system may do the following for each layer l∈{1, 2, . . . , K}: Clamp the input oscillators to the EBM block in layer l to the output of a previous layer xₗ= [symbol] yₗ₋₁ [symbol] using relay oscillator methods that may preserve expectation values. Tune the product of mass times frequency squared of the oscillators encoding the parameter degrees of freedom θₗ such that they evolve on a much slower time scale relative to the output oscillators of the given EBM layer encoding the state yₗ. Perform multiple momentum measurements (or position measurements) of the parameter degrees of freedom (e.g., synapse values such as weights and biases). Compute the gradients

$${E [ \frac{\partial {ɛ}_{{θ}_{ℓ}} ( {y}_{l} \vert {x}_{l} )}{\partial {θ}_{l}^{( j )}} ]}_{{p}_{{θ}_{l}} ( {y}_{l} \vert {x}_{l} )}$$

on an external classical post-processing device such as an FPGA/ASIC chip using the momentum (or position) measurements, wherein the index j runs over all parameters for the EBM block in layer l. Re-initialize the parameters to θₗ (e.g., their values prior to the evolution). With the input oscillators initialized to the output of a previous layer xₗ= [symbol] yₗ₋₁ [symbol] , tune the product of mass times frequency squared of the input oscillators of the given layer such that they evolve on a much slower time scale relative to the output oscillators of the given layer encoding the state yₗ. Perform multiple momentum (or position) measurements of the input oscillators. On the FPGA/ASIC chip, use such measurements to compute the gradients

$${E [ \frac{\partial {ɛ}_{{θ}_{ℓ}} ( {y}_{l} \vert 〈 {y}_{l - 1} 〉 )}{\partial 〈 {y}_{l - 1}^{( j )} 〉} ]}_{{p}_{{θ}_{l}}} ( {y}_{l} \vert 〈 {y}_{l - 1} 〉 ) .$$

The index j runs over all input neurons to the EBM block in layer l. Store all measured gradients such that they can be used during the backwards propagation step (e.g., backwards pass 302).

In some embodiments during the backwards pass 302, the protocol may start with the final output layer K (e.g., EBM 102d). For example, for all layers, the goal may be to compute

$$\begin{matrix}\frac{\partial L}{\partial {θ}_{l}^{( j )}} = {\sum }_{n} \frac{\partial L}{\partial 〈 {y}_{l}^{( n )} 〉} \frac{\partial 〈 {y}_{l}^{( n )} 〉}{\partial {θ}_{l}^{( j )}} , with & ( equation 28 ) \\ \frac{\partial L}{\partial 〈 {y}_{l}^{( j )} 〉} = {\sum }_{s ∈ {𝒥}_{j}^{( l )}} \frac{\partial L}{\partial 〈 {y}_{l + 1}^{( s )} 〉} \frac{\partial 〈 {y}_{l + 1}^{( s )} 〉}{\partial 〈 {y}_{l}^{( j )} 〉} , and & ( equation 29 ) \\ L = \frac{1}{2} {( y - 〈 {y}_{K} 〉 )}^{2} , & ( equation 30 )\end{matrix}$$

where y may be an element of the training data set. Now for layer K, consider the perturbed potential given by

$${ɛ}_{{θ}_{K}}^{( B )} ( {y}_{K} \vert {x}_{K} ) = {ɛ}_{{θ}_{K}} ( {y}_{K} \vert {x}_{K} ) + ϵ V ( {y}_{K} ) , \qquad ( equation 31 )$$

where ϵ<<1 and V(y_{K}) may be a potential that only depends on the output of the EBM block in layer K and the superscript (B) indicates the potential for the backwards pass. Measuring the momentum of the parameters, the gradient

$$𝔼 [ \frac{\partial {ɛ}_{{θ}_{K}}^{( B )} ( {y}_{K} \vert {x}_{K} )}{\partial {θ}_{K}^{( j )}} ] = \int {dy}_{K} \frac{\partial {ɛ}_{{θ}_{K}} ( {y}_{K} \vert {x}_{K} )}{\partial {θ}_{K}^{( j )}} \frac{{e}^{- {ɛ}_{{θ}_{K}} ( {y}_{K} \vert {x}_{K} ) - ɛ V ( {y}_{K} )}}{{Z}^{( B )}} ≡ {I}_{1} , \qquad ( equation 32 )$$

may be obtained where

$${Z}^{( B )} = \int d {y}_{K} {e}^{- {ɛ}_{{θ}_{K}} ( {y}_{K} \vert {x}_{K} ) - ɛ V ( {y}_{K} )} , \qquad ( equation 33 )$$

and wherein V(y_{K}) may be independent of θ_{K}. Now since ϵ<<1, a Taylor expansion may be used for the exponential in equations 32 and 33 and may be written as

$${e}^{- {ɛ}_{{θ}_{K}} ( {y}_{K} \vert {x}_{K} ) - ϵ V ( {y}_{K} )} = {e}^{- {ɛ}_{{θ}_{K}} ( {y}_{K} \vert {x}_{K} )} ( 1 - ϵ V ( {y}_{K} ) + 𝒪 ( {ϵ}^{2} ) ) , . \qquad ( equation 34 )$$

In what follows, a partition function may be defined as

$$Z ≡ \int {dy}_{K} {e}^{- {ɛ}_{{θ}_{K}} ( {y}_{K} \vert {x}_{K} )} , . \qquad ( equation 35 )$$

Inserting equation 34 into equation 32 may result in

$${I}_{1}^{( K , j )} = \int {dy}_{K} \frac{\partial {ɛ}_{{θ}_{K}} ( {y}_{K} \vert {x}_{K} )}{\partial {θ}_{K}^{( j )}} [ \begin{matrix}\frac{{e}^{- {ɛ}_{{θ}_{K}} ( {y}_{K} \vert {x}_{K} )}}{Z} \\ ( \frac{1 - ϵ V ( {y}_{K} ) + 𝒪 ( {ɛ}^{2} )}{1 - ɛ \int {dy}_{K} \frac{V ( {y}_{K} ) {e}^{- {ɛ}_{{θ}_{K}} ( {y}_{K} \vert {x}_{K} )}}{Z} + 𝒪 ( {ɛ}^{2} )} )\end{matrix} ] , . \qquad ( equation 36 )$$

Note that using

$$\int {dy}_{K} \frac{V ( {y}_{K} ) {e}^{- {ɛ}_{{θ}_{K}} ( {y}_{K} \vert {x}_{K} )}}{Z} = 〈 V ( {y}_{K} ) 〉 , \qquad ( equation 37 )$$

where it may be understood that the expectation value may be taken with respect to the distribution in equation 26, and using

$$\frac{1}{1 - ϵ 〈 V ( {y}_{K} ) 〉 + 𝒪 ( {ϵ}^{2} )} = 1 + ϵ 〈 V ( {y}_{K} ) 〉 + 𝒪 ( {ɛ}^{2} ) , \qquad ( equation 38 )$$

equation 36 may be written as

$$\begin{matrix}{I}_{1}^{( K , j )} = \int {dy}_{K} \frac{\partial {ɛ}_{{θ}_{K}} ( {y}_{K} \vert {x}_{k} )}{\partial {θ}_{K}^{( j )}} \\ [ \frac{{e}^{- {ɛ}_{{θ}_{K}} ( {y}_{K} \vert {x}_{K} )}}{Z} ( 1 + ϵ 〈 V ( {y}_{K} ) 〉 - ϵ V ( {y}_{K} ) + 𝒪 ( {ϵ}^{2} ) ) ] \\ = 〈 \frac{\partial {ɛ}_{{θ}_{K}} ( {y}_{K} \vert {x}_{K} )}{\partial {θ}_{K}^{( j )}} 〉 + ϵ 〈 \frac{\partial {ɛ}_{{θ}_{K}} ( {y}_{K} \vert {x}_{K} )}{\partial {θ}_{K}^{( j )}} 〉 〈 V ( {y}_{K} ) 〉 - \\ ϵ 〈 \frac{\partial {ɛ}_{{θ}_{K}} ( {y}_{K} \vert {x}_{K} )}{\partial {θ}_{K}^{( j )}} V ( {y}_{K} ) 〉 + 𝒪 ( {ϵ}^{2} ) \\ = 〈 \frac{\partial {ɛ}_{{θ}_{K}} ( {y}_{K} \vert {x}_{K} )}{\partial {θ}_{K}^{( j )}} 〉 - ϵ Cov ( V ( {y}_{K} ) , \frac{\partial {ɛ}_{{θ}_{K}} ( {y}_{K} \vert {x}_{K} )}{\partial {θ}_{K}^{( j )}} ) + \\ 𝒪 ( {ϵ}^{2} ) .\end{matrix} \qquad ( equation 39 )$$

From equation 61 below, the following may be used

$$\frac{\partial 〈 {y}_{K} 〉}{\partial {θ}_{K}^{( j )}} = - Cov ( {y}_{K} , \frac{\partial {ɛ}_{{θ}_{K}} ( {y}_{K} \vert {x}_{K} )}{\partial {θ}_{K}^{( j )}} ) , . \qquad ( equation 40 )$$

Note that the goal may be to compute

$$\frac{\partial L}{\partial {θ}_{K}^{( j )}} = {\sum }_{n} \frac{\partial L}{\partial 〈 {y}_{K}^{( n )} 〉} \frac{\partial 〈 {y}_{K}^{( n )} 〉}{\partial {θ}_{K}^{( j )}} = {g}_{K} \cdot \frac{\partial 〈 {y}_{K} 〉}{\partial {θ}_{K}^{( j )}} , \qquad ( equation 41 )$$

where g_{K} may be defined as

$${g}_{K} ≡ \frac{\partial L}{\partial 〈 {y}_{K} 〉} . \qquad ( equation 42 )$$

Note that since K may be the final layer, g_{K} may be determined using

$${g}_{K} = \frac{\partial L}{\partial 〈 {y}_{K} 〉} = - ( y - 〈 {y}_{K} 〉 ) , \qquad ( equation 43 )$$

where [symbol] y_{K} [symbol] may be known since it was measured during the forward pass 300 (or 202). Thus, the perturbed potential energy function may be given by

$$V ( {y}_{K} ) = {g}_{K} \cdot {y}_{K} , \qquad ( equation 44 )$$

and equation 39 can be re-written as

$$\begin{matrix}{I}_{1}^{( K , j )} - 〈 \frac{\partial {ℰ}_{{θ}_{K}} ( {y}_{K} \vert {x}_{K} )}{\partial {θ}_{K}^{( j )}} 〉 = \begin{matrix}- ϵ {g}_{K} \cdot Cov \\ ( {y}_{K} , \frac{\partial {ℰ}_{{θ}_{K}} ( {y}_{K} \vert {x}_{K} )}{\partial {θ}_{K}^{( j )}} ) + 𝒪 ( {ϵ}^{2} )\end{matrix} \\ = ϵ {g}_{K} \cdot \frac{\partial 〈 {y}_{K} 〉}{\partial {θ}_{K}^{( j )}} \\ = ϵ \frac{\partial L}{\partial {θ}_{K}^{( j )}}\end{matrix} . \qquad ( equation 45 )$$

Thus, the desired gradient can be obtained by measuring I₁^{(K,j)}, subtracting the result from the measured gradient obtained during the forward pass, and dividing the result by ϵ. In some embodiments, for a layer l<K at least some gradient terms may be written as

$$\frac{\partial L}{\partial {θ}_{l}^{( j )}} = {\sum }_{n} \frac{\partial L}{\partial 〈 {y}_{l}^{( n )} 〉} \frac{\partial 〈 {y}_{l}^{( n )} 〉}{\partial {θ}_{l}^{( j )}} , with \qquad ( equation 46 )$$

$$\frac{\partial L}{\partial 〈 {y}_{l}^{0 )} 〉} = {\sum }_{s ∈ {𝒥}_{j}^{( l )}} \frac{\partial L}{\partial 〈 {y}_{l + 1}^{( s )} 〉} \frac{\partial 〈 {y}_{l + 1}^{( s )} 〉}{\partial 〈 {y}_{l}^{( j )} 〉} . \qquad ( equation 47 )$$

In equation 47, the term

$$\frac{\partial L}{\partial 〈 {y}_{l + 1}^{( s )} 〉}$$

may be meant to be pre-computed in the previous layer (i.e. when considering the EBM block in layer l,

$$\frac{\partial L}{\partial 〈 {y}_{l + 1}^{( s )} 〉}$$

should have already been computed in layer l+1). In equation 47, calculation of the term

$$\frac{\partial 〈 {y}_{l + 1}^{( s )} 〉}{\partial 〈 {y}_{l}^{( j )} 〉}$$

may be used. As shown further down, the following relation may apply

$${\sum }_{s ∈ {𝒥}_{j}^{( l )}} \frac{\partial L}{\partial 〈 {y}_{l + 1}^{( s )} 〉} \frac{\partial 〈 {y}_{l + 1}^{( s )} 〉}{\partial 〈 {y}_{l}^{( j )} 〉} = - {\sum }_{s ∈ {𝒥}_{j}^{( l )}} \frac{\partial L}{\partial 〈 {y}_{l + 1}^{( s )} 〉} Cov ( {y}_{l + 1}^{( s )} , \frac{\partial {ℰ}_{{θ}_{l + 1}} ( {y}_{l + 1} \vert 〈 {y}_{l} 〉 )}{\partial 〈 {y}_{l}^{( j )} 〉} ) , \qquad ( equation 48 )$$

(see equation 67). Note that the covariance term in equation 48 vanished if the index s does not belong to the set [symbol] ⱼ^{(l)}. As such, equation 48 may be simplified by summing over all output indices for the EBM block in layer l+1. Thus, the following may be written

$${\sum }_{s ∈ {𝒥}_{j}^{( l )}} \frac{\partial L}{\partial 〈 {y}_{l + 1}^{( s )} 〉} \frac{\partial 〈 {y}_{l + 1}^{( s )} 〉}{\partial 〈 {y}_{l}^{( j )} 〉} = - \frac{\partial L}{\partial 〈 {y}_{l + 1} 〉} \cdot Cov ( {y}_{l + 1} , \frac{\partial {ℰ}_{{θ}_{l + 1}} ( {y}_{l + 1} \vert 〈 {y}_{l} 〉 )}{\partial 〈 {y}_{l}^{( j )} 〉} ) . \qquad ( equation 49 )$$

Notice that equation 49 may be similar to the covariance term in equation 39 except that the gradient may be taken with respect to the input variables xₗ₊₁= [symbol] yₗ [symbol] instead of the parameters θ (e.g., synapses such as weights and biases). Such gradients can be obtained using an architecture with parameters that are dynamical degrees of freedom, but where the parameters θ are clamped, and the input neurons xₗ₊₁ 204b are allowed to evolve on a slow time-scale relative to the output neurons yₗ₊₁ 208b. For example, after obtaining I₁ using a system where parameters are dynamical degrees of freedom, the parameters θ may be clamped back to the values they had prior to their evolution, while simultaneously tuning the product of mass times frequency squared of the input neurons xₗ₊₁ 204b such that they evolve on a slow time-scale relative to the output neurons yₗ₊₁ 208b. Prior to the evolution, a perturbed potential may be implemented, where the total energy potential 206a may be written as

$${\tilde{ℰ}}_{{θ}_{l}}^{( B )} ( {y}_{l} \vert {x}_{l} ) = {ℰ}_{{θ}_{l}} ( {y}_{l} \vert {x}_{l} ) + ϵ \tilde{V} ( {y}_{l} ) . \qquad ( equation 50 )$$

Measuring the momentum degrees of freedom of the oscillators used to encode the state of the input neurons results in the averaged gradient given by

$$𝔼 [ \frac{\partial {\tilde{ℰ}}_{{θ}_{l + 1}}^{( B )} ( {y}_{l + 1} \vert {x}_{l + 1} )}{\partial 〈 {y}_{l}^{( j )} 〉} ] = \int d {y}_{l + 1} \frac{\partial {\tilde{ℰ}}_{{θ}_{l + 1}} ( {y}_{l + 1} \vert {x}_{l + 1} )}{\partial 〈 {y}_{l}^{( j )} 〉} \frac{{e}^{- {ℰ}_{{θ}_{l + 1}} ( {y}_{l + 1} \vert {x}_{l + 1} ) - ϵ \tilde{V} ( {y}_{l + 1} )}}{{\tilde{Z}}^{( B )}} ≡ {I}_{2} . \qquad ( equation 51 )$$

Following the same steps that lead to equation 39, it may be straightforward to show that to leading order in ϵ, equation 51 may reduce to

$${I}_{2}^{( l + 1 , j )} = 〈 \frac{\partial {ℰ}_{{θ}_{l + 1}} ( {y}_{l + 1} \vert {x}_{l + 1} )}{\partial 〈 {y}_{l}^{( j )} 〉} 〉 - ϵ Cov ( \tilde{V} ( {y}_{l + 1} ) , \frac{\partial {ℰ}_{{θ}_{l + 1}} ( {y}_{l + 1} \vert {x}_{l + 1} )}{\partial 〈 {y}_{l}^{( j )} 〉} ) + 𝒪 ( {ϵ}^{2} ) . \qquad ( equation 52 )$$

In some embodiments, the goal may be to obtain the result in equation 49. From equation 52, an architecture where parameters are dynamical degrees of freedom may be need to implement the scheme for the input variables xₗ₊₁ during the forward pass (wherein the potential is un-perturbed) to compute the gradient

$$〈 \frac{\partial {\tilde{ℰ}}_{{θ}_{l + 1}} ( {y}_{l + 1} \vert {x}_{l + 1} )}{\partial 〈 {y}_{l}^{( j )} 〉} 〉 .$$

Then during the backwards pass I₂^{(l+1,j)} may be computed. In some embodiments, with

$$\tilde{V} ( {y}_{l + 1} ) = \frac{\partial L}{\partial 〈 {y}_{l + 1} 〉} \cdot {y}_{l + 1} , \qquad ( equation 53 )$$

the following may result

$$( equation 54 )$$

$$\begin{matrix}{I}_{2}^{( l + 1 , j )} - 〈 \frac{\partial {ε}_{{θ}_{l + 1}} ( {y}_{l + 1} \vert {x}_{l + 1} )}{\partial 〈 {y}_{l}^{( j )} 〉} 〉 = - ϵ \frac{\partial L}{\partial 〈 {y}_{l + 1} 〉} \cdot Cov ( {y}_{l + 1} , \frac{\partial {ε}_{{θ}_{l + 1}} ( {y}_{l + 1} \vert {x}_{l + 1} )}{\partial 〈 {y}_{l}^{( j )} 〉} ) + \\ O ( {ϵ}^{2} ) \\ = {ϵ \sum }_{s ∈ {𝒥}_{j}^{( l )}} \frac{\partial L}{\partial 〈 {y}_{l + 1}^{( s )} 〉} \frac{\partial 〈 {y}_{l + 1}^{( s )} 〉}{\partial 〈 {y}_{l}^{( j )} 〉} = ϵ \frac{\partial L}{\partial 〈 {y}_{l}^{( j )} 〉} ,\end{matrix}$$

where equations 47 and 49 were used in the last line of equation 54. In some embodiments, the potential in equation 53 may be the same perturbed potential that may be used when the input oscillators xₗ₊₁ 204b are clamped to output oscillators [symbol] yₗ [symbol] 208a and the parameters θₗ₊₁ of energy potential 206b are allowed to change (to compute I₁^{(l+1)} using an architecture, wherein parameters (e.g., synapses) are dynamical degrees of freedom, with the perturbed potential). Thus, the tildes may be removed resulting in V(yₗ).

In some embodiments, a protocol for backwards propagation (backwards pass 302) using a thermodynamic system may be described as follows: (1) Store all the gradients of the form

$$〈 \frac{\partial {ε}_{{θ}_{l}} ( {y}_{l} \vert {x}_{l} )}{\partial {θ}_{l}^{( j )}} 〉 and 𝔼 〈 \frac{\partial {ε}_{{θ}_{l}} ( {y}_{l} \vert {x}_{l} )}{\partial 〈 {y}_{l - 1}^{( j )} 〉} 〉$$

that were measured during the forwards pass 300 on a classical post-processing device such as an FPGA/ASIC chip. (2) For each layer l∈{K, K−1, . . . , 1} do the following. (3) Clamp the input neurons to the expectation value of the previous layer output oscillators xₗ= [symbol] yₗ₋₁ [symbol] . (4) Adjust the product of mass times frequency squared of the parameters θₗ of energy potential 206a such that they evolve on a much slower time scale than the output oscillators 208a used to encode the state yₗ. (5) If l=K, (6) set the perturbed potential energy V(y_{K})=g_{K}·y_{K} where g_{K}=−(y− [symbol] y_{K} [symbol] ) and with y being an element of the training data. (7) Perform multiple momentum measurements (or position measurements) of the parameter degrees of freedom θ_{K}. Use such measurements to compute the averaged gradient

$$〈 \frac{\partial {ε}_{{θ}_{𝒦}}^{( ℬ )} ( {y}_{K} \vert {x}_{K} )}{\partial {θ}_{K}^{( j )}} 〉 = {I}_{1}^{( K , j )}$$

on the FPGA/ASIC chip (for each index j), where [symbol] (y_{K}|x_{K}) is given in equation 31. (8) Set

$$\frac{\partial L}{\partial {θ}_{K}^{( j )}} = \frac{1}{ϵ} ( {l}_{1}^{( K , j )} - 〈 \frac{\partial {E}_{{θ}_{𝒦}} ( {y}_{K} \vert {x}_{K} )}{\partial {θ}_{K}^{( j )}} 〉 ) ,$$

for each index j running over all parameters of the EBM in layer K. (9) Clamp the parameters θ_{K} back to their original values (prior to letting them evolve). Initialize the input oscillators to [symbol] y_{K} [symbol] . Tune the product of mass times frequency squared of the input oscillators encoding x_{K} such that they evolve on a much slower time-scale relative to the output oscillators encoding the state y_{K}. (10) Perform multiple momentum measurements (or position measurements) of the input oscillators using an architecture wherein the parameters are dynamical degrees of freedom to compute

$$E 〈 \frac{\partial {ε}_{{θ}_{𝒦}} ( {y}_{K} \vert {x}_{K} )}{\partial 〈 {y}_{K - 1}^{( j )} 〉} 〉 = {I}_{2}^{( K , j )}$$

(for each index j) using the same perturbed potential as above. (11) Set

$$\frac{\partial L}{\partial 〈 {y}_{K - 1}^{( j )} 〉} = \frac{1}{ϵ} ( {I}_{2}^{( K , j )} - 〈 \frac{\partial {\tilde{ε}}_{{θ}_{𝒦}} ( {y}_{K} \vert {x}_{K} )}{\partial 〈 {y}_{K - 1}^{( j )} 〉} 〉 ) ,$$

for each index j that runs over all input neurons to the EBM block in layer K. (12) End layer k segment of if statement. (13) Start another segment of the if statement wherein the statement l=K is false. (14) Set the perturbed potential energy

$$V ( {y}_{l} ) = {g}_{l} \cdot {y}_{l} \\ where {g}_{l} = \frac{\partial L}{\partial 〈 {y}_{l} 〉}$$

was computed in the previous layer l+1. (15) repeat the steps (7)-(11) stated in this paragraph but with the index K replaced with l. The index j in step (7) and (8) runs over all parameters for the EBM block in layer l. The index j in steps (10) and (11) runs over all input neurons to the EBM block in layer l.

### Calculation of the Gradient of the Loss Function

In some embodiments, a gradient of a loss function may be determined. A detailed calculation of both terms in equation 10 may be described as the following, starting with

$$\frac{\partial 〈 {y}_{l} 〉}{\partial {θ}_{l}^{( j )}} .$$

The definition of the expectation value may be written as

$$\frac{\partial 〈 {y}_{l} 〉}{\partial {θ}_{l}^{( j )}} = \int d {y}_{l} {y}_{l} \frac{\partial }{\partial {θ}_{l}^{( j )}} p ( {y}_{l} \vert {θ}_{l} , {x}_{l} ) , \qquad ( equation 57 ) .$$

Using equation 1, may result in

$$( equation 58 ) .$$

$$\begin{matrix}\frac{\partial }{\partial {θ}_{l}^{( j )}} p ( {y}_{l} \vert {θ}_{l} , {x}_{l} ) = \frac{\partial }{\partial {θ}_{l}^{( j )}} \frac{{e}^{- {ε}_{{θ}_{l}} ( {y}_{l} \vert {x}_{l} )}}{Z ( {x}_{l} , {θ}_{l} )} \\ = - p ( {y}_{l} \vert {θ}_{l} , {x}_{l} ) \frac{\partial {ε}_{{θ}_{l}} ( {y}_{l} \vert {x}_{l} )}{\partial {θ}_{l}^{( j )}} - \frac{{e}^{- ε ( {y}_{l} \vert {x}_{l} )}}{{Z ( {x}_{l} , {θ}_{l} )}^{2}} \frac{\partial Z ( {x}_{l} , {θ}_{l} )}{\partial {θ}_{l}^{( j )}} \\ = - p ( {y}_{l} \vert {θ}_{l} , {x}_{l} ) ( \frac{\partial {ε}_{{θ}_{l}} ( {y}_{l} \vert {x}_{l} )}{\partial {θ}_{l}^{( j )}} + \frac{1}{Z ( {x}_{l} , {θ}_{l} )} \frac{\partial Z ( {x}_{l} , {θ}_{l} )}{\partial {θ}_{l}^{( j )}} ) ,\end{matrix}$$

Now, it may be written

$$\begin{matrix}\frac{\partial Z ( {x}_{l} , {θ}_{l} )}{\partial {θ}_{l}^{( j )}} = \int dy \frac{\partial {e}^{- {ε}_{{0}_{l}} ( y \vert {x}_{l} )}}{\partial {θ}_{l}^{( j )}} \\ = - \int dy \frac{\partial {ε}_{{θ}_{l}} ( y \vert {x}_{l} )}{\partial {θ}_{l}^{( j )}} {e}^{- {ε}_{{θ}_{l}} ( y \vert {x}_{l} )} ,\end{matrix} \qquad ( equation 59 )$$

so that equation 58 becomes

$$\frac{\partial }{\partial {θ}_{l}^{( j )}} p ( {y}_{l} \vert {θ}_{l} , {x}_{l} ) = - p ( {y}_{l} \vert {θ}_{l} , {x}_{l} ) ( \frac{\partial {ε}_{{θ}_{l}} ( {y}_{l} \vert {x}_{l} )}{\partial {θ}_{l}^{( j )}} - {〈 \frac{\partial {ε}_{{θ}_{l}} ( {y}_{l} \vert {x}_{l} )}{\partial {θ}_{l}^{( j )}} 〉}_{p ( {y}_{l} \vert {θ}_{l} , {x}_{l} )} ) , \qquad ( equation 60 ) .$$

Inserting equation 60 into equation 57 may result in

$$( equation 61 )$$

$$\begin{matrix}\frac{\partial 〈 {y}_{l} 〉}{\partial {θ}_{l}^{( j )}} = - \int d {y}_{l} {y}_{l} \frac{\partial {ε}_{{θ}_{l}} ( {y}_{l} \vert {x}_{l} )}{\partial {θ}_{l}^{( j )}} p ( {y}_{l} \vert {θ}_{l} , {x}_{l} ) + \int {dy}_{l}^{( t )} {y}_{l} p ( {y}_{l} \vert {θ}_{l} , {x}_{l} ) {〈 \frac{\partial {ε}_{{θ}_{l}} ( {y}_{l} \vert {x}_{l} )}{\partial {θ}_{l}^{( j )}} 〉}_{p ( {y}_{l} \vert {θ}_{l} , {x}_{l} )} \\ = - {〈 {y}_{l} \frac{\partial {ε}_{{θ}_{l}} ( {y}_{l} \vert {x}_{l} )}{\partial {θ}_{l}^{( j )}} 〉}_{p ( {y}_{l} \vert {θ}_{l} , {x}_{l} )} + {〈 {y}_{l} 〉}_{p ( {y}_{l} \vert {θ}_{l} , {x}_{l} )} {〈 \frac{\partial {ε}_{{θ}_{l}} {y}_{l} \vert {x}_{l} )}{\partial {θ}_{l}^{( j )}} 〉}_{p ( {y}_{l} \vert {θ}_{l} , {x}_{l} )} \\ = - Cov ( {y}_{l} , \frac{\partial {ε}_{{θ}_{l}} ( {y}_{l} \vert {x}_{l} )}{\partial {θ}_{l}^{( j )}} ) ,\end{matrix}$$

where the covariance of two random variables X and Y may be defined as

$$Cov ( X , Y ) = 〈 XY 〉 - 〈 X 〉 〈 Y 〉 , \qquad ( equation 62 ) .$$

Therefore, the term

$$\frac{\partial 〈 {y}_{l} 〉}{\partial {θ}_{l}^{( j )}}$$

can be obtained by computing the covariance between the output of the EBM in layer l and the gradient of the corresponding potential energy with respect to the parameters.

Next, computing the term

$$\frac{\partial L}{\partial 〈 {y}_{l}^{( j )} 〉}$$

is discussed (where without loss of generality the index i is removed) by starting with the final layer, and then consider the hidden layers of the deep neural network. For the final layer, using equation 8 may result in

$$\frac{\partial L}{\partial 〈 {y}_{K}^{( 1 )} 〉} = - ( {y}^{( t )} - 〈 {y}_{K}^{( 1 )} 〉 ) , \qquad ( equation 63 )$$

where the index (j) may be set to (1) since the final layer of the model may have a single output. For the hidden layer, the chain rule may be used to write

$$\frac{\partial L}{\partial ( {y}_{l}^{( j )} 〉} = {\sum }_{s ∈ {𝒥}_{j}^{( l )}} \frac{\partial L}{\partial 〈 {y}_{l + 1}^{( s )} 〉} \frac{\partial 〈 {y}_{l + 1}^{( s )} 〉}{\partial 〈 {y}_{l}^{( j )} 〉} , \qquad ( equation 64 )$$

where the set [symbol] ⱼ^{(l)} includes all indices for which the output nodes yₗ₊₁^{(s)} are coupled to

$${x}_{l}^{( j )} = 〈 {y}_{l}^{( j )} 〉 .$$

The second term on the right-hand side of equation 65 may be computed as follows. First write out the derivative of the expectation value explicitly as

$$\frac{\partial 〈 {y}_{l + 1}^{( s )} 〉}{\partial 〈 {y}_{l}^{( j )} 〉} = \int d {y}_{l + 1}^{( s )} {y}_{l + 1}^{( s )} \frac{\partial }{\partial 〈 {y}_{l}^{( j )} 〉} \frac{{e}^{- {ε}_{{0}_{l + 1}} ( {y}_{l + 1} \vert 〈 {y}_{l} 〉 )}}{Z ( 〈 {y}_{l} 〉 , {θ}_{l + 1} )} , \qquad ( equation 65 )$$

It may be noted that the input to the EBM block in layer l+1 may be xₗ= [symbol] yₗ [symbol] since the relay oscillator imparts its state to xₗ. As such, xₗ may be replaced with [symbol] yₗ [symbol] in equation 65. Now, computing the derivative in equation 65, may result in

$$\frac{\partial }{\partial 〈 {y}_{l}^{( j )} 〉} \frac{{e}^{- {ε}_{{0}_{l + 1}} ( {y}_{l + 1} \vert 〈 {y}_{l} 〉 )}}{Z ( 〈 {y}_{l} 〉 , {θ}_{l + 1} )} = - p ( {y}_{l + 1} \vert 〈 {y}_{l} 〉 , {θ}_{l + 1} ) ( \frac{\partial {ℰ}_{{θ}_{l + 1}} ( {y}_{l + 1} \vert 〈 {y}_{l} 〉 )}{\partial 〈 {y}_{l}^{( j )} 〉} - 〈 \frac{\partial {ℰ}_{{θ}_{l + 1}} ( {y}_{l + 1} \vert 〈 {y}_{l} 〉 )}{\partial 〈 {y}_{l}^{( j )} 〉} 〉 ) \qquad ( equation 66 )$$

Inserting equation 66 into equation 65, may result in

$$\frac{\partial 〈 {y}_{l + 1}^{( s )} 〉}{\partial 〈 {y}_{l}^{( j )} 〉} = - Cov ( {y}_{l + 1}^{( s )} , \frac{\partial {ℰ}_{{θ}_{l + 1}} ( {y}_{l + 1} \vert 〈 {y}_{l} 〉 )}{\partial 〈 {y}_{l}^{( j )} 〉} ) , \qquad ( equation 67 )$$

where a method is used that is similar to the method that went into deriving equation 61.

### Training Deep EBMs Using Mean-Field Forwards and Backwards Propagation and Additional Relay Oscillators

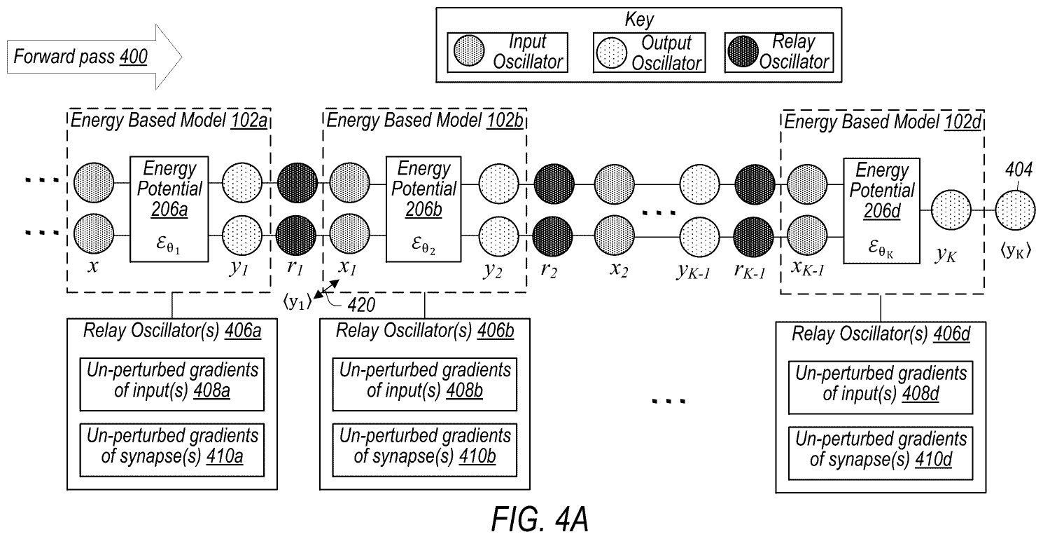

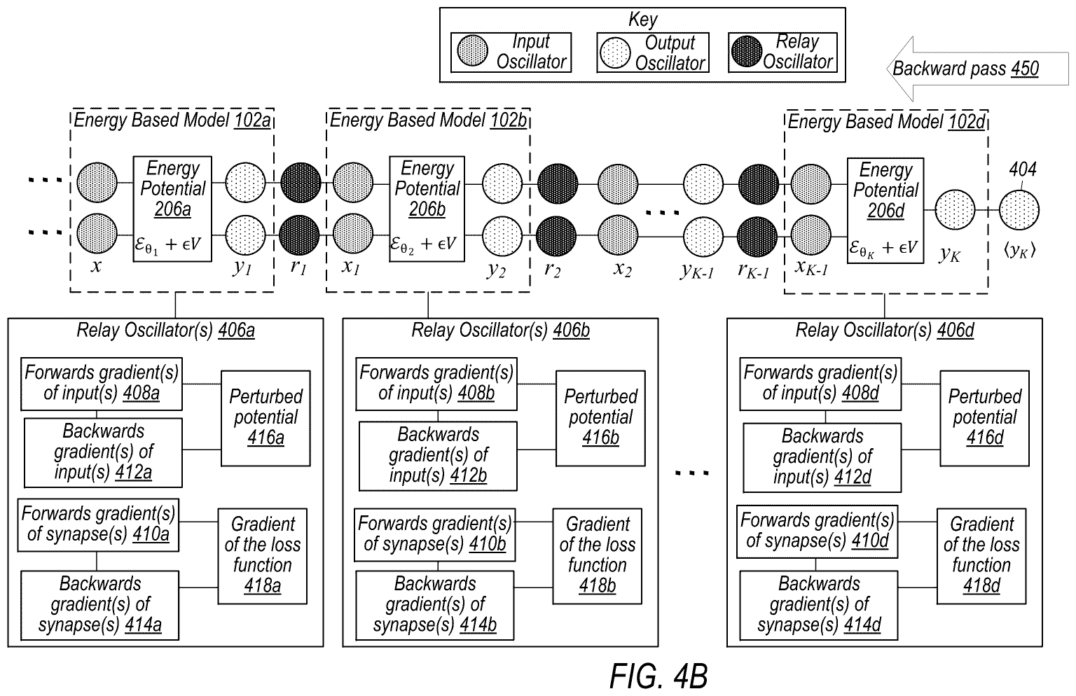

FIG. 4A is a high-level diagram illustrating a plurality of energy based models (EBMs) that may be used to determine gradient terms during a forwards pass used to update synapses, wherein gradient terms are obtained on a plurality of relay oscillators thus requiring fewer measurements, according to some embodiments.

In some embodiments, training a deep energy based model (EBM) may be performed using a mean-field forwards (e.g., forwards pass 400) and backwards propagation (e.g., backwards pass 450) method. For example, the expectation value of the output of a given EBM block (e.g., EBM 102a) may be used as an input to the next block (EBM 102b). The parameters (e.g., synapses such as weights and biases) of energy potentials 206a-d are trained by computing gradients of a loss function similar to what is done in deep neural networks. Gradients of the energy function in each EBM block 102a-d may be stored in the position degrees of freedom of one or more relay oscillators 406a-d using a mean-field relay oscillator protocol during both the forwards (400) and backwards (450) pass. However, during the backwards pass 450, a perturbation to the energy potential 206a-d in each EBM block 102a-d may be turned on. The perturbed potential may be achieved through a linear coupling between relay oscillators that encode the relevant gradients and output neurons of the EBM blocks. By applying the chain rule, the gradients may be stored in relay oscillators and can be used to compute gradients of loss function with respect to the parameters (e.g., synapses such as weights and biases) of each EBM block. Such gradients may be then used to train the EBM parameters. An example illustration of the overall forwards and backwards architecture for training parameters of a deep EBM using a mean-field approach is shown in FIGS. 4A and 4B, with example details in their implementation described below.

### Mean-Field Forwards Propagation Using Additional Relay Oscillators

In some embodiments, operations are performed during a forwards pass 402. Gradients obtained during the forwards pass 402 may be used to compute gradients of a loss function with respect to parameters θ=(θ₁, θ₂, . . . , θ_{K}) (e.g., synapses such as weights and biases) of each EBM block 102a-d part of the larger deep EBM. It may be assumed that a deep EBM may be composed of K≥1 EBM blocks, with the EBM for block 1≤l≤K having parameters θₗ for energy potentials 206a-d.

In some embodiments, position degrees of freedom of input oscillators for a deep EBM network may be clamped to the values x. It may be assumed that the EBM in the first block has a conditional energy function given by ε_{θ}_{₁}(y₁|x) (e.g., energy potential 206a-d) with output oscillators encoding the values y₁. The mean-field relay oscillator scheme, wherein the position degrees of freedoms of the intermediate relay oscillators labelled as r₁, may be used to clamp the position degree of freedom of the final output relay oscillators to x₁= [symbol] y₁ [symbol] (e.g., see 420 of FIG. 4A). The output of EBM 102a may be used as input to the next EBM block 102b with potential energy ε_{θ}_{₂}(y₂|x₁).

In some embodiments, consider the l'th EBM block with 1≤l≤K. Suppose the output yₗ is of size M≥1 (i.e. there may be M output oscillators encoding the vector yₗ). In addition to the relay oscillators which may be used to encode the expectation value of the output yₗ into xₗ= [symbol] yₗ [symbol] , additional relay oscillators may be used for each EBM block to store the gradient terms of the form

$${𝔼 [ \frac{\partial {ℰ}_{{θ}_{l}} ( {y}_{l} \vert {x}_{l - 1} )}{\partial 〈 {y}_{l - 1}^{( j )} 〉} ]}_{{y}_{l} ∼ {p}_{{θ}_{l}} ( {y}_{l} \vert {x}_{l - 1} )} , \qquad ( equation 68 )$$

(e.g., un-perturbed gradients of inputs 408a) where the probability distribution may be

$${p}_{{θ}_{l}} ( {y}_{l} \vert {x}_{l - 1} ) = {e}^{- {ℰ}_{{θ}_{l}} ( {y}_{l} \vert {x}_{l - 1} )} / Z .$$

For example, M final output relay oscillators may be used to store the gradients given by equation 68 for each index 1≤j≤M. Note that the coupling term Σₜ₌₁^{N}λₜ⁽²⁾[ϕᵣ_{ₜ}−α₁∂_{θ}_{ₗ}_{^{(j)}}ε_{θ}_{ₗ}(yₗ| [symbol] yₗ₋₁ [symbol] )]² in equation 106 may be replaced with

$${\sum }_{t = 1}^{N} {{λ}_{t}^{( 2 )} [ {ϕ}_{{r}_{t}} - {α}_{1} \frac{\partial {ℰ}_{{θ}_{l}} ( {y}_{l} \vert {x}_{l - 1} )}{\partial 〈 {y}_{l - 1}^{( j )} 〉} ]}^{2} ,$$

where α₁ may be a constant to ensure that the gradients, when multiplied by α₁, may have units of position since the gradient term is coupled to the position degree of freedom of the relay oscillator. The latter relay oscillators may also be used during the backwards pass as is described herein.

In some embodiments, the l'th EBM block may have M′ parameters (i.e. θₗ may be a vector of size M′). In addition to using a mean-field relay oscillator protocol to encode the gradients in equation 68, another batch of relay oscillators may be used to obtain gradients of the form

$${𝔼 [ \frac{\partial {ℰ}_{{θ}_{l}} ( {y}_{l} \vert {x}_{l - 1} )}{\partial {θ}_{l}^{( j )}} ]}_{{y}_{l} ∼ {p}_{{θ}_{l}} ( {y}_{l} \vert {x}_{l - 1} )} , \qquad ( equation 69 )$$

(e.g., un-perturbed gradients of synapses 410a). Storing the gradients of equation 69 into the position degrees of freedom of M′ final output relay oscillators can be achieved by following a mean-field relay oscillator protocol. For gradients of the form of equation 69, the coupling may have the form

$${\sum }_{t = 1}^{M ′} {{λ}_{t}^{( 3 )} [ {ϕ}_{{r}_{t}} - {α}_{2} \frac{\partial {ℰ}_{{θ}_{l}} ( {y}_{l} \vert {x}_{l - 1} )}{\partial {θ}_{l}^{( j )}} ]}^{2} ,$$

for some constant α₂.

In some embodiments, it may be assumed that the output of the K'th EBM block is a scalar and can be labeled as y_{K}. A mean-field relay oscillator protocol may be used to store the expectation value [symbol] y_{K} [symbol] in the state of a relay oscillator.

### Mean-Field Backwards Propagation Using Additional Relay Oscillators

FIG. 4B is a high-level diagram illustrating a plurality of energy based models (EBMs) that may be used to determine gradient terms during a backwards pass used to update synapses, wherein gradient terms are obtained on a plurality of relay oscillators thus requiring fewer measurements, according to some embodiments.

In some embodiments of a deep neural network, the parameters (e.g., synapses such as weights and biases) of energy potentials 206a-d may be trained by defining a loss function and computing gradients of the loss function with respect to the model parameters using the chain rule. In some embodiments with a deep EBM architecture, where each block of the network may be presented by an EBM, the expectation value of the output of a given block may be used as input to the next block. In some embodiments, the loss function may be used to train the model parameters.

For example, a mean squared error (MSE) loss function may be used and may be represented by

$$\begin{matrix}MSE = \frac{1}{2 N} {\sum }_{i = 1}^{N} {( {y}_{i}^{( t )} - 〈 {y}_{K}^{( i )} 〉 )}^{2} \\ = \frac{1}{N} {\sum }_{i = 1}^{N} {L}_{i} ,\end{matrix} \qquad ( equation 70 )$$

$$where$$

$${L}_{i} = \frac{1}{2} ( {y}_{i}^{( c )} - {( {y}_{K}^{( i )} \{ )}_{J}^{2} , \qquad ( equation 71 )$$

In equation 70, N may be the total number of training examples. The output oscillator [symbol] y_{K}⁽ⁱ⁾ [symbol] 404 represents the expectation value of the output of the K'th EBM block for the i'th training example, and yᵢ^{(t)} as the ground truth. In some embodiments, it may be desired to compute terms of the form

$$\frac{\partial {L}_{i}}{\partial {θ}_{l}^{( j )}} , \qquad ( equation 72 )$$

for all 1≤l≤K and where θₗ^{(j)} may be the j'th parameter (e.g., synapses such as weights and biases) of ε_{θ}_{ₗ}. Using the chain rule, equation 72 may be written as

$$\frac{\partial {L}_{i}}{\partial {θ}_{l}^{( j )}} = \frac{\partial {L}_{i}}{\partial 〈 {y}_{l}^{( j )} 〉} \frac{\partial 〈 {y}_{l}^{( j )} 〉}{\partial {θ}_{l}^{( j )}} , \qquad ( equation 73 )$$

Without loss of generality, the index i in Lᵢ may be omitted and it may be written as L. In some embodiments, the term

$$\frac{\partial 〈 {y}_{l}^{( j )} 〉}{\partial {θ}_{l}^{( j )}}$$

may be given by

$$\frac{\partial 〈 {y}_{l}^{( j )} 〉}{\partial {θ}_{l}^{( j )}} = - Cov {( {y}_{l}^{( j )} , \frac{\partial {ε}_{{θ}_{l}} ( {y}_{l} \vert {x}_{l - 1} )}{\partial {θ}_{l}^{( j )}} )}_{p ( {y}_{l} \vert {θ}_{l} , {x}_{l - 1} )} , \qquad ( equation 74 )$$

$$where Cov ( X , Y ) = 〈 XY 〉 - 〈 X 〉 〈 Y 〉$$

may be the covariance of two random variables X and Y. The final layer K may be written as

$$\frac{\partial L}{\partial 〈 {y}_{K} 〉} = - ( {y}^{( t )} - 〈 {y}_{K} 〉 ) , \qquad ( equation 75 ) .$$

The hidden layers may be written as

$$\frac{\partial L}{\partial 〈 {y}_{l}^{( j )} 〉} = {\sum }_{s ∈ {𝒯}_{j}^{( l )}} \frac{\partial L}{\partial 〈 {y}_{l + 1}^{( s )} 〉} \frac{\partial 〈 {y}_{l + 1}^{( s )} 〉}{\partial 〈 {y}_{l}^{( j )} 〉} , \qquad ( equation 76 )$$

where the set [symbol] ⱼ^{(l)} includes all indices for which the output nodes yₗ₊₁^{(s)} are coupled to xₗ^{(j)}= [symbol] yₗ^{(j)} [symbol] . In some embodiments, the following may be used

$$\frac{\partial 〈 {y}_{l + 1}^{( s )} 〉}{\partial 〈 {y}_{l}^{( j )} 〉} = - Cov {( {y}_{l + 1}^{( s )} , \frac{\partial {E}_{{θ}_{l + 1}} ( {y}_{l + 1} \vert 〈 {y}_{l} 〉 )}{\partial 〈 {y}_{l}^{( j )} 〉} )}_{{p}_{{θ}_{l + 1}} ( {y}_{l + 1} \vert 〈 {y}_{1} 〉 )} , \qquad ( equation 77 )$$

wherein the input xₗ₊₁ to the EBM block in layer l+1 may be given by [symbol] yₗ [symbol] given the dynamics of the relay oscillators.

In some embodiments, a mean-field relay oscillator protocol can be used to obtain the gradients in equations 74 and 77. For example, a step during a backwards pass may be to use a perturbed energy potential 206a-d given by

$${\tilde{ε}}_{{θ}_{l}}^{( B )} ( {y}_{l} \vert {x}_{l - 1} ) = {ε}_{{θ}_{l}} ( {y}_{l} \vert {x}_{l - 1} ) + ϵV ( {y}_{l} ) , \qquad ( equation 78 )$$

$$for 1 \leq l \leq K and ϵ ≪ 1.$$

For example, during the backwards pass, a potential V(yₗ) is added by turning on ϵ to a small but non-zero value. An example of an appropriate choice of the potential V(yₗ) is given below. The (B) superscript is added in \tilde{ε}_{θ}_{ₗ}^{(B)}(yₗ|xₗ₋₁) to indicate the modified energy potential used during the backwards pass. By way of example, the usefulness of using a perturbed potential given in equation 78 during the backwards pass is as follows. Start with the case where l=K. As during the forwards pass, a mean-field relay oscillator scheme may be used to encode the gradient

$$𝔼 [ \frac{\partial {\tilde{ε}}_{{θ}_{K}}^{( B )} ( {y}_{K} \vert {x}_{K - 1} )}{\partial {θ}_{K}^{( j )}} ] = \int {dy}_{K} \frac{\partial {\tilde{ε}}_{{θ}_{K}} ( {y}_{K} \vert {x}_{K - 1} )}{\partial {θ}_{K}^{( j )}} \frac{{e}^{- {ε}_{{0}_{K}} ( {y}_{K} \vert {x}_{K - 1} ) - ϵ V ( {y}_{K} )}}{{Z}^{( B )}} ≡ {I}_{1}^{( K , j )} , \qquad ( equation 79 )$$

into the position degrees of freedom of output relay oscillators 414d. In equation 79 the following term is used

$${Z}^{( B )} = \int {dy}_{K} {e}^{- {ε}_{{θ}_{K}} ( {y}_{K} \vert {x}_{K - 1} ) - ϵV ( {y}_{K} )} , \qquad ( equation 80 ) .$$

Since ϵ<<1, a Taylor expansion may be used for the exponential in equations 79 and 80 and only leading order terms in ϵ may be kept. Doing so may result in

$${I}_{1}^{( K , j )} = 〈 \frac{\partial {ε}_{{θ}_{K}} ( {y}_{K} \vert {x}_{K - 1} )}{\partial {θ}_{K}^{( j )}} 〉 - ϵCov ( V ( {y}_{K} ) , \frac{\partial {ε}_{{θ}_{K}} ( {y}_{K} \vert {x}_{K - 1} )}{\partial {θ}_{K}^{( j )}} ) + 𝒪 ( {ϵ}^{2} ) , \qquad ( equation 81 ) .$$

Similar to equation 61 the following may be used

$$\frac{\partial 〈 {y}_{K} 〉}{\partial {θ}_{K}^{( j )}} = - Cov ( {y}_{K ′} \frac{\partial {ε}_{{θ}_{K}} ( {y}_{K} \vert {x}_{K - 1} )}{\partial {θ}_{K}^{( j )}} ) , \qquad ( equation 82 ) .$$

In some embodiments, the goal may be to compute

$$\frac{\partial L}{\partial {θ}_{K}^{( j )}} = \frac{\partial L}{\partial 〈 {y}_{K} 〉} \frac{\partial 〈 {y}_{K} 〉}{\partial {θ}_{K}^{( j )}} = {g}_{K} \frac{\partial 〈 {y}_{K} 〉}{\partial {θ}_{K}^{( j )}} , \qquad ( equation 83 )$$

where the following definition may be used

$${g}_{K} ≡ \frac{\partial L}{\partial 〈 {y}_{K} 〉} , \qquad ( equation 84 ) .$$

Note that since K is the final layer, the following may result

$${g}_{K} = \frac{\partial L}{\partial 〈 {y}_{K} 〉} = - ( y - 〈 {y}_{K} 〉 ) , \qquad ( equation 85 )$$

where [symbol] y_{K} [symbol] may be encoded in the final output relay oscillator 404. As such, the perturbed potential energy function may be chosen to be given by

$$V ( {y}_{K} ) = {g}_{K} {y}_{K} . \qquad ( equation 86 )$$

Such a potential term can be achieved by coupling the final output relay oscillator 404 whose position degree of freedom may be static at [symbol] y_{K} [symbol] with the oscillator encoding the output oscillator y_{K}. Inserting equation 86 into equation 81 and rearranging terms, may result in

$$\begin{matrix}{I}_{1}^{( K , j )} - 〈 \frac{\partial {ε}_{{θ}_{K}} ( {y}_{K} \vert {x}_{K} )}{\partial {θ}_{K}^{( j )}} 〉 = \text{-ϵ} {g}_{K} Cov ( {y}_{K} , \frac{\partial {ε}_{{θ}_{K}} ( {y}_{K} \vert {x}_{K} )}{\partial {θ}_{K}^{( j )}} ) + \\ 𝒪 ( {ϵ}^{2} ) \\ = ϵ {g}_{K} \frac{\partial 〈 {y}_{K} 〉}{\partial {θ}_{K}^{( j )}} \\ = ϵ \frac{\partial L}{\partial {θ}_{K}^{( j )}} ,\end{matrix} \qquad ( equation 87 ) .$$

Let \tilde{ϕ}ᵣ_{₁}^{(K,j)} be relay oscillators 410d whose position degree of freedom may be static at

$$〈 \frac{\partial {ε}_{{θ}_{K}} ( {y}_{K} \vert {x}_{K} )}{\partial {θ}_{K}^{( j )}} 〉$$

(e.g., the forwards gradients of synapses) and let \tilde{ϕ}ᵣ_{₂}^{(K,j)} be relay oscillators 414d whose position degree of freedom may be static at I₁^{(K,j)} (e.g., the backwards gradients of synapses). A third set of relay oscillators storing gradients of the loss function (relay oscillators 418d) may be added and labelled as \tilde{ϕ}ᵣ_{₃}^{(K,j)} with mass m_{f} and frequency ω_{f} which may be coupled to relay oscillator \tilde{ϕ}ᵣ_{₁}^{(K,j)} 410d and relay oscillator \tilde{ϕ}ᵣ_{₂}^{(K,j)} 414d (wherein \tilde{ϕ}ᵣ_{₁}^{(K,j)} 410d and \tilde{ϕ}ᵣ_{₂}^{(K,j)} 414d may be both treated as static) as in equation 108. However, the coupling term may be given by the three-body coupling λ₃(t)\tilde{ϕ}ᵣ_{₃}^{(K,j)}\tilde{ϕ}ᵣ_{₂}^{(K,j)}\tilde{ϕ}ᵣ_{₁}^{(K,j)}. Following a relay oscillator protocol such as described herein and using the result in equation 87, the position degree of freedom \tilde{ϕ}ᵣ_{₃}^{(K,j)} of relay oscillator 418d may be static at the value

$$\frac{\partial L}{\partial {θ}_{K}^{( j )}}$$

if the coupling λ₃ is set as follows,

$${λ}_{3} = - \frac{{m}_{f} {ω}_{f}^{2}}{ϵ} .$$

Alternatively, a coupling of the form λ₃(t)(\tilde{ϕ}ᵣ_{₃}^{(K,j)}−c₁(\tilde{ϕ}ᵣ_{₂}^{(K,j)}−\tilde{ϕ}ᵣ_{₁}^{(K,j)}))² for some constant c₁ may be used. For example, it may be chosen that c₁=1/ϵ and λ₃>>m_{f}ω_{f}²/2.

In some embodiments, layers l<K may be considered. Recall that

$$\frac{\partial L}{\partial {θ}_{l}^{( j )}} = {\sum }_{n} \frac{\partial L}{\partial 〈 {y}_{l}^{( n )} 〉} \frac{\partial 〈 {y}_{l}^{( n )} 〉}{\partial {θ}_{l}^{( j )}} , \qquad ( equation 88 )$$

$$with$$

$$\frac{\partial L}{\partial 〈 {y}_{l}^{( j )} 〉} = {\sum }_{s ∈ {𝒥}_{j}^{( l )}} \frac{\partial L}{\partial 〈 {y}_{l + 1}^{( s )} 〉} \frac{\partial 〈 {y}_{l + 1}^{( s )} 〉}{\partial 〈 {y}_{l}^{( j )} 〉} , \qquad ( equation 89 ) .$$

In equation 89, the term

$$\frac{\partial L}{\partial 〈 {y}_{l + 1}^{( s )} 〉}$$

may be meant to be pre-computed in the previous layer (i.e. when considering the EBM block in layer l,

$$\frac{\partial L}{\partial 〈 {y}_{l + 1}^{( s )} 〉}$$

should have already been computed in layer l+1). Such a term may arise from the perturbation potential. In equation 89, calculation of the term

$$\frac{\partial 〈 {y}_{l + 1}^{( s )} 〉}{\partial 〈 {y}_{l}^{( j )} 〉}$$

may be needed. In some embodiments, it may be shown that

$${\sum }_{s ∈ {𝒥}_{j}^{( l )}} \frac{\partial L}{\partial 〈 {y}_{l + 1}^{( s )} 〉} \text{} \frac{\partial 〈 {y}_{l + 1}^{( s )} 〉}{\partial 〈 {y}_{l}^{( j )} 〉} = \text{} - {\sum }_{s ∈ {𝒥}_{j}^{( l )}} \frac{\partial L}{\partial 〈 {y}_{l + 1}^{( s )} 〉} Cov ( {y}_{l + 1}^{( s )} , \frac{\partial {ε}_{{θ}_{l + 1}} ( {y}_{l + 1} \vert 〈 {y}_{l} 〉 )}{\partial 〈 {y}_{l}^{( j )} 〉} ) , \qquad ( equation 90 )$$

(see equation 67). Note that the covariance term in 90 vanishes if the index s does not belong to the set [symbol] ⱼ^{(l)}. As such, equation 90 may be simplified by summing over all output indices for the EBM block in layer l+1 (the reason for doing so may become clearer below). The following may result

$${\sum }_{s ∈ {𝒥}_{j}^{( l )}} \frac{\partial L}{\partial 〈 {y}_{l + 1}^{( s )} 〉} \frac{\partial 〈 {y}_{l + 1}^{( s )} 〉}{\partial 〈 {y}_{l}^{( j )} 〉} = - \frac{\partial L}{\partial 〈 {y}_{l + 1} 〉} \cdot Cov ( {y}_{l + 1} , \frac{\partial {ε}_{{θ}_{l + 1}} ( {y}_{l + 1} \vert 〈 {y}_{l} 〉 )}{\partial 〈 {y}_{l}^{( j )} 〉} ) , \qquad ( equation 91 ) .$$

Now given the perturbed potential in equation 78 for l<K, a mean field relay oscillator scheme may be used, such as may be done during the forwards pass, to encode the gradient

$$𝔼 [ \frac{\partial {\tilde{ε}}_{{θ}_{l + 1}}^{( B )} ( {y}_{l + 1} \vert {x}_{l} )}{\partial 〈 {y}_{l}^{( j )} 〉} ] = \int {dy}_{l + 1} \frac{\partial {\tilde{ε}}_{{θ}_{l + 1}} ( {y}_{l + 1} \vert {x}_{l} )}{\partial 〈 {y}_{l}^{( j )} 〉} \frac{{e}^{- {ε}_{{θ}_{l + 1}} ( {y}_{l + 1} \vert {x}_{l} ) - ϵ V ( {y}_{l + 1} )}}{{\tilde{Z}}^{( B )}} ≡ {I}_{2}^{( l + 1 , j )} , \qquad ( equation 92 )$$

(e.g., backwards gradients of inputs) in the position degree of freedom of output relay oscillators 412a-d. Taylor expanding and keeping terms to leading order in ϵ, may result in

$${I}_{2}^{( l + 1 , j )} = 〈 \frac{\partial {ε}_{{θ}_{l + 1}} ( {y}_{l + 1} \vert {x}_{l} )}{\partial 〈 {y}_{l}^{( j )} 〉} 〉 - ϵ Cov ( V ( {y}_{l + 1} ) , \frac{\partial {ε}_{{θ}_{l + 1}} ( {y}_{l + 1} \vert {x}_{l} )}{\partial 〈 {y}_{l}^{( j )} 〉} ) + 𝒪 ( {ϵ}^{2} ) , \qquad ( equation 93 ) .$$

In some embodiments, it may be chosen that

$$V ( {y}_{l + 1} ) = \frac{\partial L}{\partial 〈 {y}_{l + 1} 〉} \cdot {y}_{l + 1} , \qquad ( equation 94 )$$

which may result in

$$\begin{matrix}{I}_{2}^{( l + 1 , j )} - 〈 \frac{\partial {ε}_{{θ}_{l + 1}} ( {y}_{l + 1} \vert {x}_{l} )}{\partial 〈 {y}_{l}^{( j )} 〉} 〉 = - ϵ \frac{\partial L}{\partial 〈 {y}_{l + 1} 〉} \cdot \\ Cov ( {y}_{l + 1} , \frac{\partial {ε}_{{θ}_{l + 1}} ( {y}_{l + 1} \vert {x}_{l} )}{\partial 〈 {y}_{l}^{( j )} 〉} ) + \\ 𝒪 ( {ϵ}^{2} ) \\ = ϵ {\sum }_{s ∈ {𝒥}_{j}^{( l )}} \frac{\partial L}{\partial 〈 {y}_{l + 1}^{( s )} 〉} \frac{\partial 〈 {y}_{l + 1}^{( s )} 〉}{\partial 〈 {y}_{l}^{( j )} 〉} = \\ ϵ \frac{\partial L}{\partial 〈 {y}_{l}^{( j )} 〉} ,\end{matrix} \qquad ( equation 95 )$$

where equations 89 and 91 were used in the last line of equation 95.

In some embodiments, the term

$$\frac{\partial L}{\partial 〈 {y}_{l + 1} 〉}$$

in equation 94 may need to be computed on an external classical post processing device using measurements of the position degrees of freedom of the relay oscillators 412a-d encoding the state I₂^{(l+2,j)} (for all j) set during the backwards pass 450 and position degrees of freedom of relay oscillators 408a-d encoding

$$〈 \frac{\partial {ε}_{{0}_{l + 2}} ( {y}_{l + 2} \vert {x}_{l + 2} )}{\partial 〈 {y}_{l + 1}^{( j )} 〉} 〉$$

(e.g., forward gradients of inputs) set during the forwards pass 400. In some embodiments, let ϕᵣ_{₁}^{(l+2,j)} be the relay oscillator 408a-d whose position may be static at

$$〈 \frac{\partial {ε}_{{0}_{l + 2}} ( {y}_{l + 2} \vert {x}_{l + 2} )}{\partial 〈 {y}_{l + 1}^{( j )} 〉} 〉 and {ϕ}_{{r}_{2}}^{( l + 2 , j )}$$

be the relay oscillator 412a-d whose position may be static at I₂^{(l+2,j)}. A third relay oscillator ϕᵣ_{₃}^{(l+2,j)} 416a-d may be introduced with mass m_{f} and frequency ω_{f} which may be coupled to ϕᵣ_{₁}^{(l+2,j)} and ϕᵣ_{₂}^{(l+2,j)} as in equation 108 but where the coupling term may be given by a three-body coupling, λ₃(t)ϕᵣ_{₃}^{(l+2,j)}ϕᵣ_{₂}^{(l+2,j)}ϕᵣ_{₁}^{(l+2,j)}. Note that ϕᵣ_{₁}^{(l+2,j)} 408a-d and ϕᵣ_{₂}^{(l+2,j)} 412a-d may be treated as being static. By setting

$${λ}_{3} = - \frac{{m}_{f} {ω}_{f}^{2}}{ϵ} , \qquad ( equation 96 )$$

in equation 108, from equation 95 ϕᵣ_{₃}^{(l+2,j)} 416a-d reaches equilibrium at

$$\frac{\partial L}{\partial 〈 {y}_{l + 1}^{( j )} 〉} .$$

As such, ϕᵣ_{₃}^{(l+2,j)} (treated as static) may be subsequently coupled to the oscillator encoding yₗ₊₁^{(j)} (for all j) to obtain the potential in equation 94. The perturbed potential in equation 78 in layer l+1 may then be used. Alternatively, a coupling of the form λ₃(t)(ϕᵣ_{₃}^{(l+2,j)}−c₁(ϕᵣ_{₂}^{(l+2,j)}−ϕᵣ_{₁}^{(l+2,j)}))² may be used for some constant c₁. For example, it may be chosen that c₁=1/ϵ and λ₃>>m_{f}ω_{f}²/2.

In some embodiments, a system of one or more thermodynamic chips may repeat the above steps for each layer 1≤l≤K by using relay oscillators from the previous layer and coupling them to the output neurons to define the potential in equation 94. Using the perturbed potential, the gradients

$$𝔼 [ \frac{\partial {\tilde{ε}}_{{0}_{l}}^{( B )} ( {y}_{l} \vert {x}_{l} )}{\partial {θ}_{l}^{( j )}} ] and 𝔼 [ \frac{\partial {\tilde{ε}}_{{0}_{l + 1}}^{( B )} ( {y}_{l + 1} \vert {x}_{l + 1} )}{\partial 〈 {y}_{l}^{( j )} 〉} ]$$

may be encoded into the position degrees of freedom of relay oscillators using a mean-field protocol such as described herein. The system may use additional relay oscillators such that their position degrees of freedom reach equilibrium at the difference between the above gradients and those computed during the forwards pass.

In some embodiments, a protocol for using a thermodynamic system for a mean-field backwards propagation may include the following. (1) Let ϕᵣ_{₁}^{(l,j)} be the relay oscillator 408a-d whose position degree of freedom may be static at the gradient

$$〈 \frac{\partial {ε}_{{0}_{l}} ( {y}_{l} \vert {x}_{l} )}{\partial 〈 {y}_{l - 1}^{( j )} 〉} 〉$$

(e.g., forwards gradients of inputs) obtained during the forwards pass. The system may have such relay oscillators for each 1≤l≤K (and each index j for a given layer). (2) Let \tilde{ϕ}ᵣ_{₁}^{(l,j)} be the relay oscillator 410a-d whose position degree of freedom may be static at the gradient

$$〈 \frac{\partial {ε}_{{0}_{l}} ( {y}_{l} \vert {x}_{l} )}{\partial {θ}_{l - 1}^{( j )}} 〉$$

(e.g., forwards gradient of synapses) obtained during the forwards pass 400. The system may have such relay oscillators for each layer 1≤l≤K (and each index j for a given layer). (3) For each layer l∈{K, K−1, . . . , 1} the following may be done. (4) If l=K, the following may be done. (5) Set the perturbed potential energy V(y_{K})=g_{K}y_{K} where g_{K}=−(y− [symbol] y_{K} [symbol] ) with y being a ground truth element of the training data. Such a potential can be achieved by coupling the relay oscillator 404 whose position degree of freedom is static at [symbol] y_{K} [symbol] to y_{K} as described by V(y_{K}). (6) Use the perturbed potential energy given by equation 78 (with l=K) for the EBM in layer l=K. (7) Use a mean-field relay oscillator protocol to encode the gradient

$$E [ \frac{\partial {\tilde{ε}}_{{θ}_{K}}^{( B )} ( {y}_{K} \vert {x}_{K} )}{\partial {θ}_{K}^{( j )}} ] ≡ {I}_{1}^{( K , j )}$$

(e.g., backwards gradients of synapses) into the position degree of freedom of the relay oscillator \tilde{ϕ}ᵣ_{₂}^{(K,j)} 414d. (8) Couple a third batch of relay oscillators \tilde{ϕ}ᵣ_{₃}^{(K,j)} 418d (for each j) with masses \tilde{m}_{f} and frequencies \tilde{ω}_{f} to \tilde{ϕ}ᵣ_{₂}^{(K,j)} 414d and \tilde{ϕ}ᵣ_{₁}^{(K,j)} 410d as in equation 108 (with \tilde{ϕ}ᵣ_{₂}^{(K,j)} 414d and \tilde{ϕ}ᵣ_{₁}^{(K,j)} 410d treated as static and use the coupling \tilde{λ}₃(t)(\tilde{ϕ}ᵣ_{₃}^{(K,j)}−c₁(\tilde{ϕ}ᵣ_{₂}^{(K,j)}−\tilde{ϕ}ᵣ_{₁}^{(K,j)}))²) and set c₁=1/ϵ and choose

$${\tilde{λ}}_{3} >> \frac{1}{2} {\tilde{m}}_{f} {\tilde{ω}}_{f}^{2} .$$

Tune the product \tilde{m}_{f}\tilde{ω}_{f}² such that the position degree of freedom of \tilde{ϕ}ᵣ_{₃}^{(K,j)} 418d remains static at

$$\frac{\partial L}{\partial {θ}_{K}^{( j )}} .$$

(9) Use a mean-field relay oscillator protocol to encode the gradient

$$E [ \frac{\partial {\tilde{ε}}_{{θ}_{K}}^{( B )} ( {y}_{K} \vert {x}_{K} )}{\partial 〈 {y}_{K - 1}^{( j )} 〉} ] ≡ {I}_{2}^{( K , j )}$$

into the position degree of freedom of the relay oscillator ϕᵣ_{₂}^{(K,j)} 412d. (10) Couple a third batch of relay oscillators ϕᵣ_{₃}^{(K,j)} 416d (for each j) with masses m_{f} and frequencies ω_{f} to ϕᵣ_{₂}^{(K,j)} 412d and ϕᵣ_{₁}^{(K,j)} 408d as in equation 108 (with ϕᵣ_{₂}^{(K,j)} and ϕᵣ_{₁}^{(K,j)} treated as static) and using the coupling λ₃(t)(ϕᵣ_{₃}^{(K,j)}−c₁(ϕᵣ_{₂}^{(K,j)}−ϕᵣ_{₁}^{(K,j)}))²) and set c₁=1/ϵ and choose

$${λ}_{3} >> \frac{1}{2} {m}_{f} {ω}_{f}^{2} .$$

Tune the product m_{f}ω_{f}² such that the position degree of freedom of ϕᵣ_{₃}^{(K,j)} 416d remains static at

$$\frac{\partial L}{\partial 〈 {y}_{K - 1}^{( j )} 〉} .$$

(11) Measure the position degree of freedom of the relay oscillators \tilde{ϕ}ᵣ_{₃}^{(K,j)} 410d for each index j and send the measurement results to an external classical post-processing device. (12) End the segment of the if statement where l=K is true. (13) Else where the segment of the if statement where l=K is false, the following may be performed. (14) Set the perturbed potential energy V(yₗ)=gₗ·yₗ by linearly coupling the relay oscillators ϕᵣ_{₃}^{(l+1,j)} 416a-b (computed in the previous layer) to yₗ^{(j)} (for each index j. (15) Repeat the steps (6)-(11) but with the index K replaced with l (e.g., relay oscillators 406a-b). The index j in step (7), (8) and (11) runs over all parameters (e.g., synapses such as weights and biases) for the EBM block in layer l. The index j in steps (9) and (10) runs over all input neurons to the EBM block in layer l.

In some embodiments, all the gradients

$$\frac{\partial L}{\partial {θ}_{l}^{( j )}}$$

may be encoded in the position degrees of freedom of relay oscillators \tilde{ϕ}₃^{(l,j)} 418a-d, and the system can measure the position of these relay oscillators to perform the final θ parameter (e.g., synapses such as weights and biases) updates on an external classical post-processing device.

### Using Relay Oscillators to Obtain Gradients and Perform Natural Gradient Descent in a Fully Analogue Way

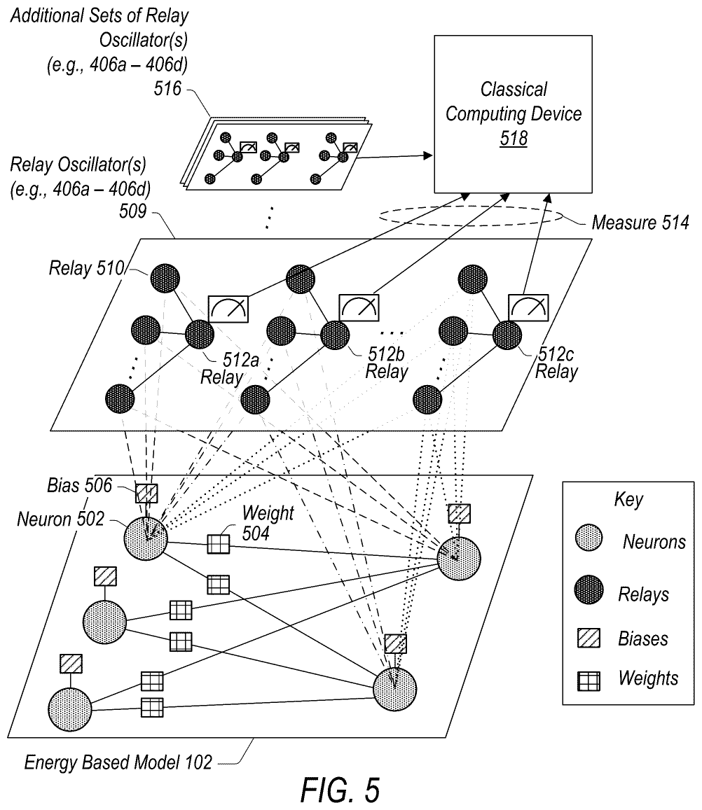

FIG. 5 is a high-level diagram illustrating gradient terms, that may be used to update synapse values, are obtained using relay oscillators in an analogue way, according to some embodiments.

In some embodiments, relay oscillators (ROs) 406a-d can be used in such a way that their position degree of freedom reaches equilibrium at the space-averaged value of the gradient of the energy function of a given EBM. Such a protocol may be used to train deep EBMs using a mean-field forwards and backwards propagation protocol. In some embodiments, Natural Gradient Descent (NGD) can be implemented in a fully analogue fashion using a mean-field relay oscillator protocol.

### Natural Gradient Descent

In some embodiments, parameters of an EBM (e.g., synapses such as weights 504 and biases 506) can be trained following an NGD protocol. The Bogoliubov-Kubo-Mori (BKM) metric meets desirable asymptotic optimality criteria. The BKM metric for energy based models may be defined as

$${𝒥}^{BKM} {( θ )}_{j , k} = \int ( {\partial }_{{θ}_{j}} {p}_{θ} ( x ) ) ( {\partial }_{{θ}_{k}} log {p}_{θ} ( x ) ) dx , \qquad ( equation 97 )$$

$$where {p}_{θ} ( x ) = exp ( - {ε}_{θ} ( x ) ) / Z ( θ ) .$$

Using this definition of p_{θ}(x), both terms in equation 97 may be calculated. The first term results in

$${\partial }_{{θ}_{j}} {p}_{θ} ( x ) = ( {𝔼}_{z ∼ {p}_{θ} ( z )} [ {\partial }_{{θ}_{j}} {ε}_{θ} ( z ) ] - {\partial }_{{θ}_{j}} {ε}_{θ} ( x ) ) {p}_{θ} ( x ) , \qquad ( equation 98 )$$

and the second term may be given by

$${\partial }_{{θ}_{k}} log {p}_{θ} ( x ) = ( - {\partial }_{{θ}_{k}} {ε}_{θ} ( x ) + {ε}_{y ∼ {p}_{θ} ( y )} [ {\partial }_{{θ}_{k}} {ε}_{θ} ( y ) ] ) , \qquad ( equation 99 ) .$$

Putting equations 98 and 99 into equation 97, results in

$$( equation 100 ) .$$

$${{𝒥}^{BKM} ( θ )}_{j , k} = {𝔼}_{x ∼ {p}_{θ} ( x )} [ {\partial }_{{θ}_{j}} {ε}_{θ} ( x ) {\partial }_{{θ}_{k}} {ε}_{θ} ( x ) ] - {𝔼}_{x ∼ {p}_{θ} ( x )} [ {\partial }_{{θ}_{j}} {ε}_{θ} ( x ) ] {𝔼}_{y ∼ {p}_{θ} ( y )} [ {\partial }_{{θ}_{k}} {ε}_{θ} ( y ) ] ,$$

Given the BKM metric in equation 100, the parameters (e.g., synapses such as weights 504 and biases 506) may be updated as

$$( equation 101 )$$

$${θ}_{t + 1} = {θ}_{t} + \frac{1}{{λ}_{t}} {𝒥}^{+} ( {θ}_{t} ) ( - {∇}_{{θ}_{t}} {ε}_{p} ( {θ}_{t} ) - N ( \frac{1}{n} {\sum }_{i = 1}^{n} {∇}_{{θ}_{t}} ε ( {θ}_{t} , {x}_{{t}_{i}} ) - {𝔼}_{x ∼ {{p}_{θ}}_{t} ( x )} [ {∇}_{{θ}_{t}} ε ( {θ}_{t} , x ) ] ) )$$

where λₜ may be the learning rate and [symbol] ⁺(θ) may be the Moore-Penrose pseudo-inverse of the information matrix [symbol] (θ). A special choice for the information matrix may be to set [symbol] (θ)= [symbol] ^{BKM}(θ).

### Mean-Field Relay Oscillators for Computing Gradients

In some embodiments, terms of the form

$${𝔼}_{( x , z ) ∼ {p}_{θ} ( x , z )} [ {\partial }_{{θ}_{j}} {ε}_{θ} ( x , z ) {\partial }_{{θ}_{k}} {ε}_{θ} ( x , z ) ] \qquad ( equation 102 )$$

$$and$$

$${𝔼}_{( x , z ) ∼ {p}_{θ} ( x , z )} [ {\partial }_{{θ}_{j}} {ε}_{θ} ( x , z ) ] {𝔼}_{( x , z ) ∼ {p}_{θ} ( x , z )} [ {\partial }_{{θ}_{k}} {ε}_{θ} ( x , z ) ] , \qquad ( equation 103 )$$

which may be required in equation 100, can be stored in the position degree of freedom of relay oscillators (Ros) 406a-d. Terms of the form [symbol] _{(x,z)˜p}_{_{θ}}_{(x,z)}[∂_{θ}_{ⱼ}ε_{θ}(x,z)] may also be needed when performing mean-field forwards and backwards propagation. The following are example steps of a process as described herein.

Step 1: An EBM block with energy function ε_{θ}(x,z) is considered. Relay oscillators such as 510 which may be coupled to the neurons 504 of a given EBM, may be used such that the final output relay oscillators 512a-c position degree of freedom corresponds to a trajectory given by the expectation value of the desired gradient. For example, a spatial relay oscillator scheme may be used. Other examples of relay oscillator schemes include a temporal (wherein a relay oscillator is repetitively used to obtain multiple gradients) or a sequence (wherein a chain of relay oscillators have increasingly large product of mass and frequency squared) based protocols. The following potential energy function may be considered for a spatial relay oscillator scheme

$$( equation 104 )$$

$${V}_{BKM}^{( 1 )} = \frac{1}{2} {m}_{r} ( t ) {{ω}_{r} ( t )}^{2} {\sum }_{j = 1}^{N} {ϕ}_{{r}_{j}}^{2} + \frac{1}{2} {\tilde{m}}_{r} ( t ) {{\tilde{ω}}_{r} ( t )}^{2} {ϕ}_{{r}_{N + 1}}^{2} + {ε}_{θ} ( x , z ) + {\sum }_{t = 1}^{N} {{λ}_{t}^{( 1 )} [ {ϕ}_{{r}_{t}} - {α}_{1} {\partial }_{{θ}_{j}} {ε}_{θ} ( x , z ) {\partial }_{{θ}_{k}} {ε}_{θ} ( x , z ) ]}^{2} + {λ}_{{r}_{N + 1}} ( t ) {\sum }_{j = 1}^{N} {( {ϕ}_{{r}_{N + 1}} - {ϕ}_{{r}_{j}} )}^{2} + \frac{1}{2} {m}_{b} {ω}_{b}^{2} {\sum }_{j = 1}^{N} {ϕ}_{{b}_{j}}^{2} + \frac{1}{2} {\tilde{m}}_{b} {\tilde{ω}}_{b}^{2} {ϕ}_{{b}_{N + 1}}^{2} + {\sum }_{j = 1}^{N} {λ}_{{b}_{j}} ( t ) {ϕ}_{{b}_{j}} {ϕ}_{{r}_{j}} + {λ}_{{b}_{N + 1}} ( t ) {ϕ}_{{b}_{N + 1}} {ϕ}_{{r}_{N + 1}}$$

Following a mean-field relay oscillator protocol, the coupling term Σₜ₌₁^{N}λₜ⁽¹⁾[ϕᵣ_{ₜ}−α₁∂_{θ}_{ⱼ}ε_{θ}(x,z)∂_{θ}_{ₖ}ε_{θ}(x,z)]² in equation 104 may result in the following expectation value for the position degree of freedom ϕᵣ_{_{N+1}} of the final output relay oscillator 512a-c

$$( equation 105 )$$

$$\begin{matrix}〈 {ϕ}_{{r}_{N + 1}} 〉 \approx \frac{{λ}_{{r}_{N + 1}} {α}_{1}}{N {λ}_{{r}_{N + 1}} + \frac{1}{2} {\tilde{m}}_{r} ( t ) {{\tilde{ω}}_{r} ( t )}^{2}} {\sum }_{j = 1}^{N} {\partial }_{{θ}_{j}} {ε}_{θ} ( {x}_{i} , {z}_{i} ) {\partial }_{{θ}_{k}} {ε}_{θ} ( {x}_{i} , {z}_{i} ) \\ \approx \frac{{α}_{1}}{N} {\sum }_{j = 1}^{N} {\partial }_{{θ}_{j}} {ε}_{θ} ( {x}_{i} , {z}_{i} ) {\partial }_{{θ}_{k}} {ε}_{θ} ( {x}_{i} , {z}_{i} ) \\ \approx {α}_{1} {𝔼}_{( x , z ) \sim {p}_{θ} ( x , z )} [ {\partial }_{{θ}_{j}} {ε}_{θ} ( x , z ) {\partial }_{{θ}_{k}} {ε}_{θ} ( x , z ) ] ,\end{matrix}$$

where in going to the second line the condition

$$N {λ}_{{r}_{N + 1}} ≫ \frac{1}{2} {\tilde{m}}_{r} ( t ) {{\tilde{ω}}_{r} ( t )}^{2}$$

is used. Note that α₁ is a constant that ensures the term α₁∂_{θ}_{ⱼ}ε_{θ}(xᵢ,zᵢ)∂_{θ}_{ₖ}ε_{θ}(xᵢ,zᵢ) has units of position. An example illustration of the architecture describing the couplings (illustrated by solid and dashed lines) between the relay oscillators such as 510 and the neurons such as 502 part of an EBM block 102 is shown in FIG. 5. A second chip may be used to house the relay oscillators 406a-d in order to ease connectivity constraints.

Step 2: In order to obtain terms of the form [symbol] _{x˜p}_{_{θ}}₍ₓ₎[∂_{θ}_{ⱼ}ε_{θ}(x)] which may be required in equation 100 as well as for the negative phase term in equation 101, another set of N+1 relay oscillators 516 with the following potential energy function may be used,

$$( equation 106 )$$

$${V}_{BKM}^{( 2 )} = \frac{1}{2} {m}_{r} ( t ) {{ω}_{r} ( t )}^{2} {\sum }_{j = 1}^{N} {ϕ}_{{r}_{j}}^{2} + \frac{1}{2} {\tilde{m}}_{r} ( t ) {{\tilde{ω}}_{r} ( t )}^{2} {ϕ}_{{r}_{N + 1}}^{2} + {ε}_{θ} ( x , z ) + {\sum }_{t = 1}^{N} {{λ}_{t}^{( 2 )} [ {ϕ}_{{r}_{t}} - {α}_{1} {\partial }_{{θ}_{j}} {ε}_{θ} ( x , z ) ]}^{2} + {λ}_{{r}_{N + 1}} ( t ) {\sum }_{j = 1}^{N} {( {ϕ}_{{r}_{N + 1}} - {ϕ}_{{r}_{j}} )}^{2} + \frac{1}{2} {m}_{b} {ω}_{b}^{2} {\sum }_{j = 1}^{N} {ϕ}_{{b}_{j}}^{2} + \frac{1}{2} {\tilde{m}}_{b} {\tilde{ω}}_{b}^{2} {ϕ}_{{b}_{N + 1}}^{2} + {\sum }_{j = 1}^{N} {λ}_{{b}_{j}} ( t ) {ϕ}_{{b}_{j}} {ϕ}_{{r}_{j}} + {λ}_{{b}_{N + 1}} ( t ) {ϕ}_{{b}_{N + 1}} {ϕ}_{{r}_{N + 1}} .$$

Following the same steps leading to equation 105 may result in the following

$$( {ϕ}_{{r}_{N + 1}} 〉 \approx {α}_{2} {𝔼}_{( x , z ) ∼ {p}_{θ} ( x , z )} [ {\partial }_{{θ}_{j}} {ε}_{θ} ( x , z ) ] . \qquad ( equation 107 )$$

Step 3: So far relay oscillators may have position degrees of freedom that reach equilibrium at expectation values (e.g., gradient terms) given in equation 102 as well as expectation values (e.g., gradient terms) of the form [symbol] _{(x,z)˜p}_{_{θ}}_{(x,z)}[∂_{θ}_{ⱼ}ε_{θ}(x,z)]. The protocol in step 2 may be sufficient for performing mean-field forwards and backwards propagation. In some embodiments, for a complete NGD protocol, gradient terms such as those given in equation 103 may be needed. Let ϕᵣ_{ⱼ} and ϕᵣ_{ₖ} be the relay oscillators in step 2 with equilibrium values given by [symbol] _{(x,z)˜p}_{_{θ}}_{(x,z)}[∂_{θ}_{ⱼ}ε_{θ}(x,z)] and [symbol] _{(x,z)˜p}_{_{θ}}_{(x,z)}[∂_{θ}_{ₖ}ε_{θ}(x,z)], and with masses mₜ and frequency ωₜ. Let ϕᵣ_{_{d}}^{(j,k)} be the final relay oscillator used in step 1 with equilibrium value given in equation 105, and with mass m_{d} and frequency ω_{d}. The system may comprise a third relay oscillator label as ϕᵣ_{_{f}}^{(j,k)} with mass m_{f} and frequency ω_{f}, and where m_{f}ω_{f}²<<mₜωₜ² and m_{f}ω_{f}²<<m_{d}ω_{d}². Thus, the oscillators ϕᵣ_{ⱼ}, ϕᵣ_{ₖ} and ϕᵣ_{_{d}}^{(j,k)} may be treated as static at their equilibrium values relative to the oscillator ϕᵣ_{_{f}}^{(j,k)}. The coupling between ϕᵣ_{_{f}}^{(j,k)} and the oscillators ϕᵣ_{ₜ}^{(j,k)} and ϕᵣ_{_{d}}^{(j,k)} may be described by the following potential

$$( equation 108 ) .$$

$${V}_{BKM}^{( 3 )} = \frac{1}{2} {m}_{f} {{ω}_{f}^{2} ( {ϕ}_{{r}_{f}}^{( j , k )} )}^{2} + {λ}_{3} ( t ) {( {ϕ}_{{r}_{f}}^{( j , k )} - {α}_{3} ( {ϕ}_{{r}_{d}}^{( j , k )} - {ϕ}_{{r}_{j}} {ϕ}_{{r}_{k}} ) )}^{2} ,$$

Again, it may be straightforward to show that

$$( equation 109 ) .$$

$$( {ϕ}_{{r}_{f}}^{( j , k )} \{ = \frac{2 {λ}_{3}}{2 {λ}_{3} + {m}_{f} {ω}_{f}^{2}} ( {α}_{1} {𝔼}_{( x , z ) ∼ {p}_{θ} ( xmz )} [ {\partial }_{{θ}_{j}} {ε}_{θ} ( x , z ) {\partial }_{{θ}_{k}} {ε}_{θ} ( x , z ) ] - {α}_{3} {α}_{1}^{2} {𝔼}_{( x , z ) ∼ {p}_{θ} ( x , z )} [ {\partial }_{{θ}_{j}} {ε}_{θ} ( x , z ) ] {𝔼}_{( x , z ) ∼ {p}_{θ} ( x , z )} [ {\partial }_{{θ}_{k}} {ε}_{θ} ( x , z ) ] ) ,$$

For the case where α₃α₁=1, the above simplifies to

$$〈 {ϕ}_{{r}_{f}}^{( j , k )} 〉 = \frac{2 {λ}_{3} {α}_{1}}{2 {λ}_{3} + {m}_{f} {ω}_{f}^{2}} ( {𝔼}_{( x , z ) ∼ {p}_{θ} ( x , z )} [ {\partial }_{{θ}_{j}} {ε}_{θ} ( x , z ) {\partial }_{{θ}_{k}} {ε}_{θ} ( x , z ) ] - {𝔼}_{( x , z ) ∼ {p}_{θ} ( x , z )} [ {\partial }_{{θ}_{j}} {ε}_{θ} ( x , z ) ] {𝔼}_{( x , z ) ∼ {p}_{θ} ( x , z )} [ {\partial }_{{θ}_{k}} {ε}_{θ} ( x , z ) ] ) ,$$

In some embodiments, the coupling strength may be large enough such that

$${λ}_{3} ≫ \frac{{m}_{f} {ω}_{f}^{2}}{2} ,$$

wherein the desired expectation value is obtained. The coupling λ₃ may be turned on at the end of step 3 when the oscillator ϕᵣ_{ₜ}^{(j,k)} has reached its equilibrium value and the product mₜωₜ² has been tuned such that the oscillator remains static relative to ϕᵣ_{_{f}}^{(j,k)}. After ϕᵣ_{_{f}}^{(j,k)} reaches its equilibrium value, the coupling λ₃(t) may be turned off. Bias oscillators may be used in equation 108 to assist the oscillator ϕᵣ_{_{f}}^{(j,k)} in maintaining its equilibrium value after λ₃(t) may be turned off. At the conclusion of step 3, the oscillator ϕᵣ_{_{f}}^{(j,k)} may encode the (j,k)'th component of the BKM matrix in equation 100.

In some embodiments, steps similar to the steps 2 and 3 above may be used to encode the difference between the positive and negative phase terms in the position degree of freedom of a relay oscillator. The position degrees of freedom of such relay oscillators may be represented as ϕᵣ^{(j,u)}, wherein the expectation value may be

$$〈 {ϕ}_{r}^{( j , u )} 〉 \approx - \frac{2 {λ}^{( 2 , u )}}{2 {λ}^{( 2 , u )} + {{m}_{r}^{( j , u )} ( {ω}_{r}^{( j , u )} )}^{2}} ( \frac{{α}_{4}}{n} {\sum }_{i = 1}^{n} {𝔼}_{z ∼ p o ( z \vert {x}_{i} )} [ {\partial }_{{θ}_{j}} {ε}_{θ} ( {x}_{i} , z ) ] - {α}_{2} {𝔼}_{( x , z ) ∼ p o ( x , z )} [ {\partial }_{{θ}_{j}} {ε}_{θ} ( x , z ) ] ) , \qquad ( equation 110 )$$

which gives the desired result when λ^{(2,u)}>>mᵣ^{(j,u)}(ωᵣ^{(j,u)})². For the case where α₄=α₂, the above simplifies to

$$〈 {ϕ}_{r}^{( j , u )} 〉 \approx - \frac{2 {λ}^{( 2 , u )} {α}_{4}}{2 {λ}^{( 2 , u )} + {{m}_{r}^{( j , u )} ( {ω}_{r}^{( j , u )} )}^{2}} ( \frac{1}{n} {\sum }_{i = 1}^{n} {𝔼}_{z ∼ p o ( z \vert {x}_{i} )} [ {\partial }_{{θ}_{j}} {ε}_{θ} ( {x}_{i} , z ) ] - {𝔼}_{( x , z ) ∼ p o ( x , z )} [ {\partial }_{{θ}_{j}} {ε}_{θ} ( x , z ) ] ) ,$$

In some embodiments, an appropriate choice may be to set λ^{(2,u)}=N to get the correct parameter update rules in equation 101, which may be valid as long as N>>mᵣ^{(j,u)}(ωᵣ^{(j,u)})².

In some embodiments, a step in completing the fully analogue NGD protocol using the mean-field relay oscillator protocol may be described as follows. Suppose there are a total of M parameters, e.g., θ=(θ₁, θ₂, . . . , θ_{M}) (e.g., synapses such as weights 504 and biases 506), and the set of M oscillators ϕᵣ^{(u)}=(ϕᵣ^{(1,u)}, ϕᵣ^{(2,u)}, . . . , ϕᵣ^{(M,u)}) 406a-d where [symbol] ϕᵣ^{(j,u)} [symbol] may be given in equation 110 is considered. The mass and frequency of the oscillator ϕᵣ^{(j,u)} may be labeled as mᵣ^{(j,u)} and ωᵣ^{(j,u)}. Furthermore, a set of M′×M′ oscillators ϕᵣ_{_{f}}=(ϕᵣ_{_{f}}^{(1,1)}, ϕᵣ_{_{f}}^{(1,2)}, . . . , ϕᵣ_{_{f}}^{(M,M)}) where M′≤M may be used, wherein the equilibrium value of ϕᵣ_{_{f}}^{(j,k)} may be given in equation 109. In some embodiments, the block-diagonal approximation to the Fisher information matrix, M′<M may be used. The mass and frequencies of the oscillators ϕᵣ_{_{f}}^{(j,k)} may be labeled as m_{f} and ω_{f}. For notational simplicity, the oscillators ϕᵣ_{_{f}} may be written in matrix form as

$${B}_{{r}_{f}} = [ \begin{matrix}{ϕ}_{{r}_{f}}^{( 1 , 1 )} & {ϕ}_{{r}_{f}}^{( 1 , 2 )} & & … & & {ϕ}_{{r}_{f}}^{( 1 , M )} \\ {ϕ}_{{r}_{f}}^{( 2 , 1 )} & {ϕ}_{{r}_{f}}^{( 2 , 2 )} & & … & & {ϕ}_{{r}_{f}}^{( 2 , M )} \\ … & … & & … & & … \\ {ϕ}_{{r}_{f}}^{( M , 1 )} & {ϕ}_{{r}_{f}}^{( M , 2 )} & & … & & {ϕ}_{{r}_{f}}^{( M , M )}\end{matrix} ] , \qquad ( equation 111 )$$

Note that if a block diagonal approximation to Bᵣ_{_{f}} is used, the following condition applies, namely M′<M, and entries in Bᵣ_{_{f}} where no oscillators are used may be set to zero.

In some embodiments, a series of oscillators with position degrees of freedom may be described by the vector ϕ_{δ}=(ϕ_{δ}_{₁}, ϕ_{δ}_{₂}, . . . , ϕ_{δ}_{_{M}}). The position degrees of freedom of such oscillators may be used to encode the final parameter update step for NGD given by the second term on the right-hand side in equation 101. The mass and frequencies of these oscillators may be denoted as m_{δ} and ω_{δ} which satisfy m_{δ}ω_{δ}²<<mᵣ^{(j,u)}(ωᵣ^{(j,u)})² and m_{δ}ω_{δ}²<<m_{f}ω_{f}². The last two conditions arise from the fact that ϕᵣ^{(u)} and ϕᵣ_{_{f}} may be relay oscillators whose product of mass times frequency squared may be tuned such that they remain static after reaching the thermal equilibrium values in equations 109 and 110. The following coupling potential between ϕ_{δ} and the oscillators ϕᵣ^{(u)} and ϕᵣ_{_{f}} which may be treated as static at their equilibrium values may be described by

$${V}_{δ} = {ϕ}_{r}^{( u )} {ϕ}_{δ}^{T} + {ϕ}_{δ} {B}_{{r}_{f}} {ϕ}_{δ}^{T} , \qquad ( equation 112 )$$

Note that in computing the equilibrium dynamics of ϕ_{δ}, given the above conditions, the following two replacements are used, ϕᵣ^{(u)}→ [symbol] ϕᵣ^{(u)} [symbol] and Bᵣ_{_{f}}→ [symbol] Bᵣ_{_{f}} [symbol] . To compute [symbol] ϕ_{δ} [symbol] , the expectation value may be represented by

$$〈 {ϕ}_{δ} 〉 = \frac{\int d {ϕ}_{δ} {ϕ}_{δ} {e}^{- β {V}_{δ}}}{\int d {ϕ}_{δ} {e}^{- β {V}_{δ}}} , \qquad ( equation 113 )$$

To evaluate the integral in equation 113, the potential V_{δ} may be such that e^{-βV}^{_{δ}}/Z (where Z=∫dϕ_{δ}e^{-βV}^{_{δ}}) may be a Gaussian distribution when using the expectation values for ϕᵣ^{(u)} and Bᵣ_{_{f}}. A Gaussian distribution for a random variable x of length N has probability distribution given by

$$p ( x ) = \frac{1}{{( 2 π )}^{N / 2} {\vert \sum \vert}^{1 / 2}} exp - \frac{1}{2} {( x - μ )}^{T} {\sum }^{- 1} ( x - μ ) \qquad ( equation 114 )$$

with mean μ and covariance matrix Σ. Expanding the exponent in equation 114 and matching it to −βV_{δ} (with the expectation values used for ϕᵣ^{(u)} and Bᵣ_{_{f}}), may result in (ignoring constant terms as they don't affect the statistics)

$$\begin{matrix}\sum = \frac{1}{2 β} 〈 {B}_{{r}_{f}}^{- 1} 〉 , \\ μ = - \frac{1}{2} 〈 {B}_{{r}_{f}}^{- 1} 〉 〈 {ϕ}_{r}^{( u )} 〉 ,\end{matrix} \qquad ( repectively equations 115 and 116 )$$

Consequently, from equation 116,

$$〈 {ϕ}_{δ} 〉 \approx - \frac{1}{2} 〈 {B}_{{r}_{f}}^{- 1} 〉 〈 {ϕ}_{r}^{( u )} 〉 , \qquad ( equation 117 )$$

where the approximation label arises since expectation values for ϕᵣ^{(u)} and Bᵣ_{_{f}} are used. From the equilibrium values of Bᵣ_{_{f}} and ϕᵣ^{(u)}, equation 117 corresponds to the second term on the right-hand side of equation 5. Furthermore the variance may be represented by

$$Var ( {ϕ}_{δ} ) = \frac{1}{2 β} 〈 {B}_{{r}_{f}}^{- 1} 〉 , \qquad ( equation 118 )$$

The non-zero variance given in equation 118 may correspond to a noisy NGD gradient update if the position degree of freedom of the ϕ_{δ} relay oscillators are used to update the parameters θ (e.g., synapses such as weights and biases). To complete the NGD protocol, the parameters θ (e.g., synapses such as weights and biases) may be updated.

In some embodiments, the parameters (e.g., synapses such as weights and biases) may be dynamical degrees with position degrees of freedom ϕ_{θ} and product m_{θ}ω_{θ}² that may be much larger than those of the neurons used in the energy function ε_{θ}(x,z). In this way, the parameters θ can be treated as static up until this point. In some embodiments, a coupling between ϕ_{θ} and ϕ_{δ} may be turned on quickly, and the correct parameter update rule of equation 101 (in expectation value) may be obtained, although the variance in ϕ_{δ} may add some noise to the parameter updates. More specifically, the following potential may be used

$${V}_{p a r a m} ( θ , δ ) = \frac{1}{2} {m}_{θ} ( t ) {{ω}_{θ} ( t )}^{2} {\sum }_{j = 1}^{M} {( {ϕ}_{{θ}_{j}} - {θ}_{0}^{( j )} )}^{2} + {λ}_{θ} ( t ) {\sum }_{j = 1}^{M} {ϕ}_{{θ}_{j}} {ϕ}_{{δ}_{j}} + \frac{1}{2} {m}_{( b , θ )} {ω}_{( b , θ )}^{2} {\sum }_{j = 1}^{M} {ϕ}_{{b}_{j}}^{( θ )} + {λ}_{( b , θ )} ( t ) {\sum }_{j = 1}^{M} {ϕ}_{{θ}_{j}} {ϕ}_{{b}_{j}}^{( θ )} + {V}_{δ} \qquad ( equation 119 )$$

where V_{δ} may be given in equation 112 and θ₀ may be the initial values chosen for the parameters θ (and θ₀^{(j)} may be the j'th component of the vector θ₀). Bias oscillators ϕ_{b}_{ⱼ}^{(θ)} may be used in some embodiments, but in other embodiments bias oscillators may be treated as optional. The coupling λ_{θ}(t) in equation 119 may be turned on after ϕ_{δ} reaches thermal equilibrium, and then turned off after ϕ_{θ} reach their new equilibrium values. Note that the coupling λ_{(b,θ)}(t) for the bias oscillators may be used in the same manner as if ϕ_{θ} were treated as relay oscillators.

In some embodiments, from equation 119, when the coupling λ_{θ}(t) is turned on and reaches its maximum value (say λ_{θ}), an expectation value of the synapse oscillators may be

$$\begin{matrix}〈 {ϕ}_{θ} 〉 = \frac{\int d {ϕ}_{θ} d {ϕ}_{δ} {ϕ}_{θ} {e}^{- β {V}_{p a r a m} ( θ , δ )}}{\int d {ϕ}_{θ} d {ϕ}_{δ} {e}^{- β {V}_{p a r a m} ( θ , δ )}} \\ \approx {θ}_{0} - η 〈 {B}_{{r}_{f}}^{- 1} 〉 〈 {ϕ}_{r}^{( u )} 〉 ,\end{matrix} \qquad ( equation 120 )$$

where the approximation from going from the first to the second line arises since expectation values [symbol] Bᵣ_{_{f}}⁻¹ [symbol] and [symbol] ϕᵣ^{(u)} [symbol] are used. In such an embodiment, the condition λ_{θ}=−2ηm_{θ}ω_{θ}² as well as the condition

$$2 {η}^{2} {m}_{θ} {ω}_{θ}^{2} ≪ max \vert {B}_{{r}_{f}} \vert , \qquad ( equation 121 )$$

are used which can be achieved for small η. The term α₄η/α₁ may correspond to the learning rate 1/λₜ in equation 101.

In some embodiments, the above process may be repeated each time ϕ_{δ} reaches a new equilibrium value when the parameters change due to the coupling in equation 119.

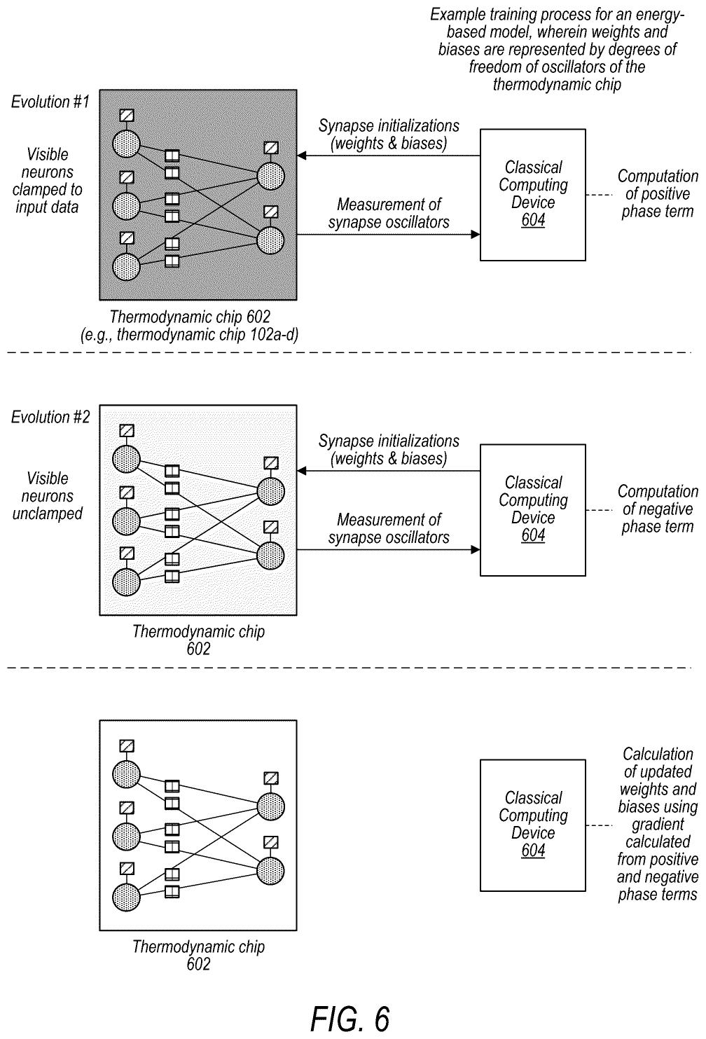

FIG. 6 is high-level diagram illustrating a process of determining weights and biases to be used in an energy-based model (EBM), wherein the weights and biases are determined using measurement values for synapse oscillators, according to some embodiments.

As shown in FIG. 6, in a first evolution, visible neurons of an energy-based model implemented on a thermodynamic chip 602 may be clamped to input data. For example, multiple mini-batches of input data may be clamped to visible neurons for multiple evolutions used to generate a first set of measurements used to compute a positive phase term. For example, the measurements may be used by classical computing device 604 to compute the positive phase term.

Also, in a second (or other subsequent) evolution, the visible neurons may remain unclamped, such that the visible neuron oscillators are free to evolve along with the synapse oscillators during the second (or other subsequent) evolution. Measurements may also be taken and used by the classical computing device 604 to compute a negative phase term.

Additionally, the positive and negative phase terms computed based on the first and second sets of measurements (e.g., clamped measurements and un-clamped measurements) may be used to calculate updated weights and biases.

This process may be repeated, with the determined updated weights and biases used as initial weights and biases for a subsequent iteration. In some embodiments, inferences generated using the updated weights and biases may be compared to training data to determine if the energy-based model has been sufficiently trained. If so, the model may transition into a mode of performing inferences using the learned weights and biases. If not sufficiently trained, the process may continue with additional iterations of determining updated weights and biases.

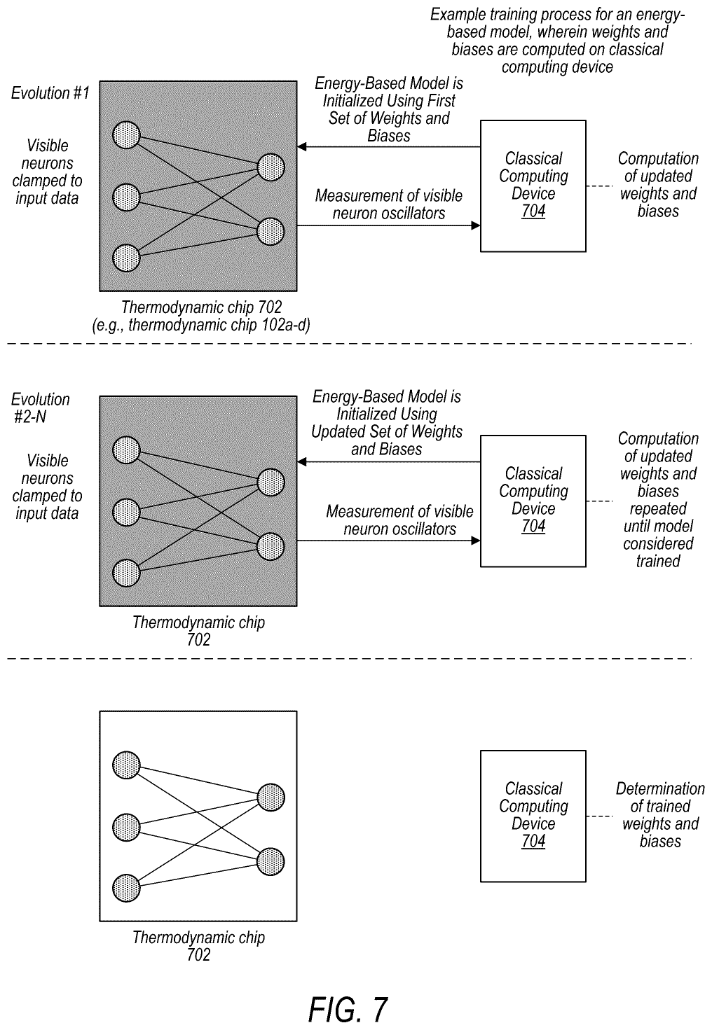

FIG. 7 is high-level diagram illustrating a process of determining weights and biases to be used in an energy-based model (EBM), wherein the weights and biases are computed using a classical computing device, according to some embodiments.

In some embodiments, updated weights and bias values may be computed iteratively by classical computing device 704 based on inference measurements from thermodynamic chip 702. For example, inference values may be compared to training data values, and new weights and biases may be iteratively computed until the inference values closely correspond to the training data. As can be seen in FIG. 7, in some embodiments the synapse oscillator may be omitted as degrees of freedom of the energy-based model. For example, when a classical computing device is used to iteratively determine the weight and bias values.

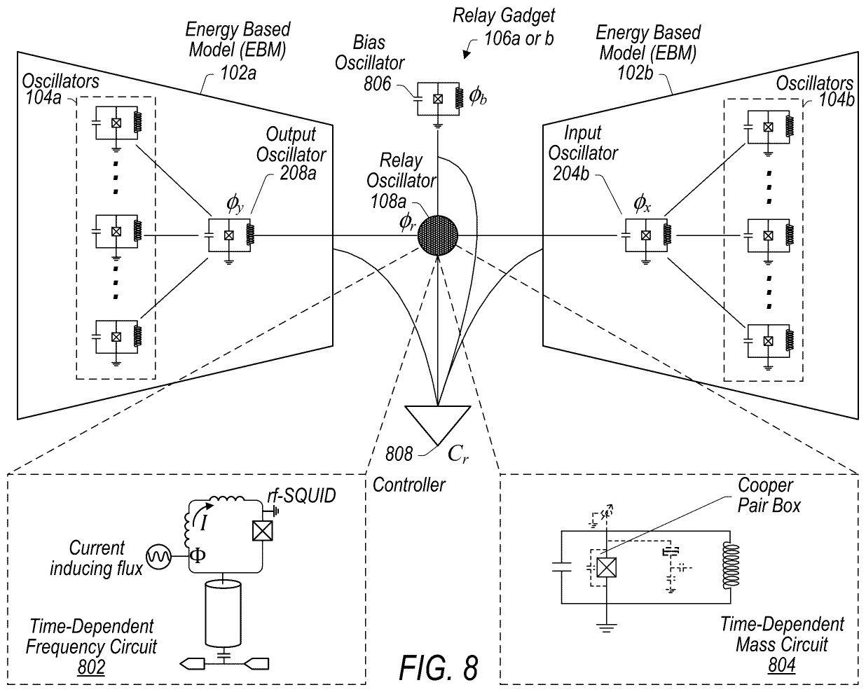

FIG. 8 is a diagram illustrating hardware components that may be used to implement oscillators of energy-based models (EBMs), as well as two different example hardware configurations of a relay oscillator that have a time-dependent mass or a time-dependent frequency, respectively, according to some embodiments.

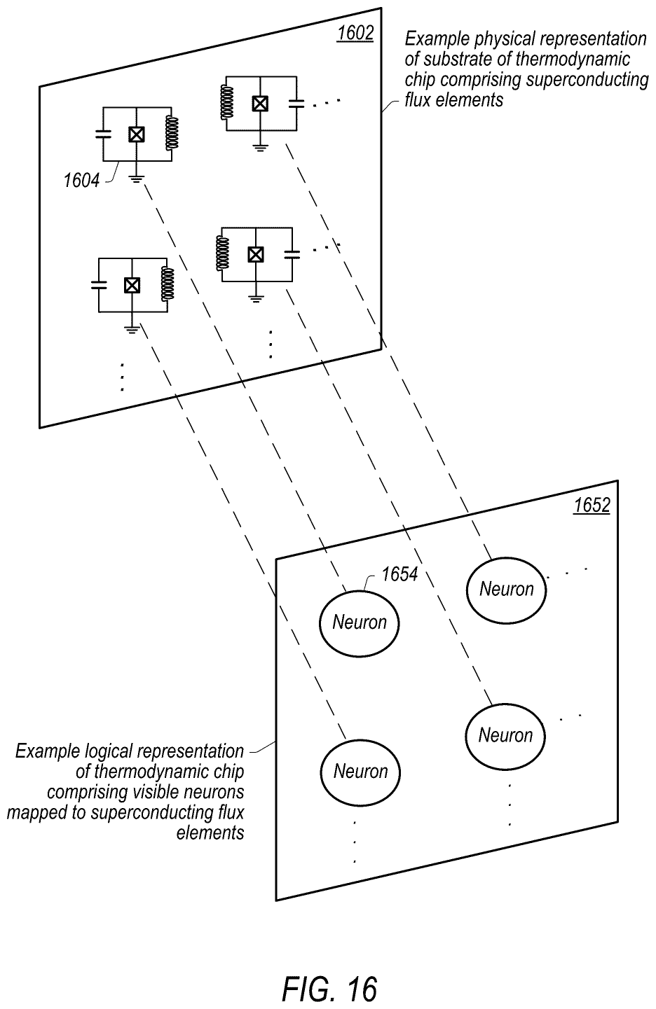

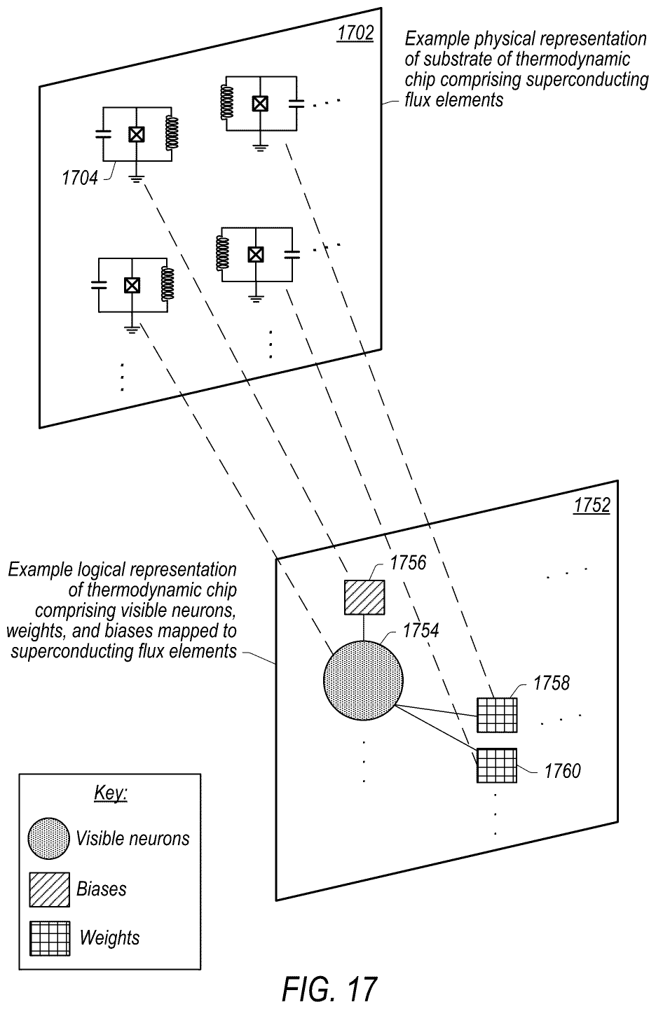

In some embodiments, each of the oscillators of the first energy-based model 102a and the second energy-based model 102b, may be implemented using superconducting circuit elements, such as shown in FIG. 8. These superconducting circuit elements may be used to implement oscillators that are mapped to visible or hidden neurons of the first or second energy-based model (e.g., 208a and 204b). Also, such oscillators may be mapped to synapses (e.g. weights or biases) of the first or second energy-based model. FIGS. 16-17 provide additional details regarding the mappings and hardware configurations used to implement example energy-based models. Also, as shown in FIG. 8 superconducting circuit elements may be used to implement the bias oscillator 806.

However, slightly different superconducting circuits may be used to implement the relay oscillator. In some embodiments a relay gadget 106a or 106b may comprise a plurality of relay oscillators such as 108a, wherein an expectation value of output oscillator 208a may be relayed to input oscillator 204b. For example, circuit 802 shows an example implementation circuit for the relay oscillator 108a, wherein the circuit 802 implements a time-dependent frequency that can be controlled by controller 808. As another alternative, circuit 804 shows an example implementation circuit for the relay oscillator 108a, wherein the circuit 804 implements a time-dependent mass that can be controlled by controller 808.

In some embodiments, the relay gadget does not include a bias oscillator 806.

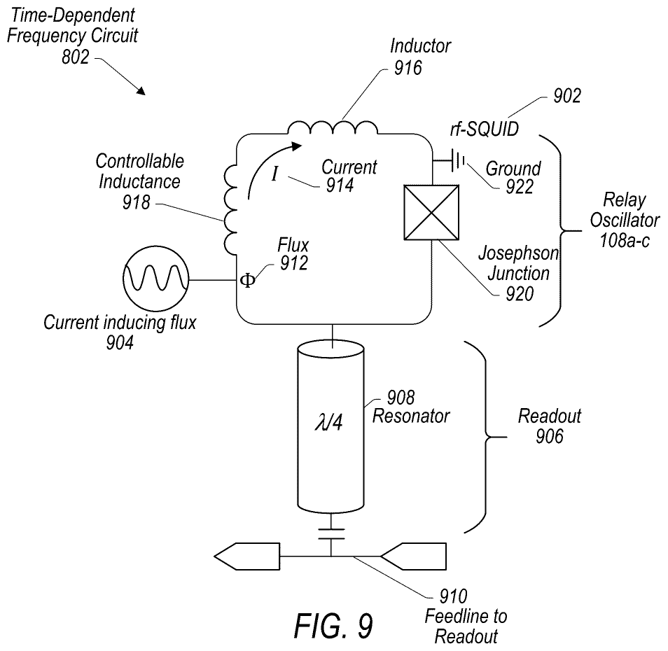

FIG. 9 is a diagram providing additional details regarding a hardware configuration used to implement a relay oscillator with a time-dependent frequency, according to some embodiments.

In some embodiments, a superconducting quantum interference device (SQUID) can be used in a circuit used to implement a relay oscillator with time-dependent frequency along with a controllable current line that induces a flux in the circuit. For example, time-dependent frequency circuit 802 includes rf-SQUID 902 and current line 904 that induces flux 912. Note the added flux 912 causes adjustments to the circuit flux 918 and current 914. The rf-SQUID 902 and current inducing flux 904 can be treated as a flux-tunable inductor, wherein changing the inductance of a LC-resonator changes the frequency of the time-dependent frequency circuit 802. In order to make the frequency time-dependent, a time dependent flux bias may be applied to a SQUID terminated resonator, such as shown in FIG. 9. In some embodiments, time-dependent frequency circuit 902 also includes Josephson junction 920 which is grounded 922. In some embodiments, the Josephson junction 920 and inductor 916 (along with controllable inductor 918) may form a part of relay oscillator 108a-c. Note that in some embodiments relay oscillator 108a-c further includes a capacitor in parallel with the inductance and Josephson junction. However, for simplification purposes, the capacitor is not shown in FIG. 9.

In some embodiments, a value of the relay oscillator 108a-c may be read via readout 906. For example, a position degree of freedom of the relay oscillator 108a-c may be readout via readout 906. In some embodiments, readout 906 includes a resonator 908 which may have a length corresponding to ¼ the wavelength of the signal being readout from the relay oscillator 108a-c. Also, readout 906 may include feedline 910.

Note that inducing the flux in the time-dependent frequency circuit 802 via the current line 904 and resulting induced flux 912 allows for the Josephson inductance 918 to be tuned. This inductance is in series with the resonator inductance 916 so it simply adds to the L term of the LC oscillator. In the time-dependent frequency circuit 802 shown in FIG. 9 there is a voltage antinode at the capacitor below the resonator 906 and a voltage node as the SQUID end, which is grounded.

In some embodiments, the following function may be used for the time-dependent frequency:

$${ω}_{r} ( t ) = {ω}_{f}^{( r )} σ ( {k}_{r} ( t - {t}_{r} ) ) + {ω}_{r}$$

When a time-dependent frequency is used, the equation of motion for the average position of the relay oscillator 108a-c becomes:

$${m}_{r} \frac{{d}^{2} {ϕ}_{r}}{{dt}^{2}} + γ {m}_{r} \frac{d {ϕ}_{r}}{dt} = - ( - 2 {λ}_{A} ( t ) ( {ϕ}_{y} - {ϕ}_{r} ) + {λ}_{B} ( t ) {ϕ}_{b} + {λ}_{X} ( t ) {ϕ}_{x} + {m}_{r} {ω}_{r}^{2} ( t ) {ϕ}_{r} ) + \sqrt{2 {m}_{r} ( t ) {k}_{B} T} \frac{{dW}_{t}^{( r )}}{dt}$$

$$Or$$

$${m}_{r} \frac{{d}^{2} {ϕ}_{r}}{{dt}^{2}} + γ {m}_{γ} \frac{d {ϕ}_{r}}{dt} = - ( - 2 {λ}_{A} ( t ) ( {ϕ}_{y} - {ϕ}_{r} ) - 2 {λ}_{B} ( t ) ( {ϕ}_{r} - {ϕ}_{b} ) + 2 {λ}_{X} ( t ) ( {ϕ}_{x} - {ϕ}_{r} ) + {m}_{r} {ω}_{r}^{2} ( t ) {ϕ}_{r} ) + \sqrt{2 {m}_{r} ( t ) {k}_{B} T} \frac{{dW}_{t}^{( r )}}{dt}$$

Note that since frequency is a function of capacitance and inductance, e.g.

$$( ω = \frac{1}{\sqrt{L C}} ) ,$$

by adjusting the inductance (L), the frequency of the circuit can be controlled. For example, as discussed above, a SQUID can be treated as a flux-tunable inductor, and by changing the inductance of the flux-tunable inductor, the inductance of an LC resonator can be changed, which also changes the LC resonator's frequency. For example, a time dependent flux bias can be applied to a SQUID terminated resonator.

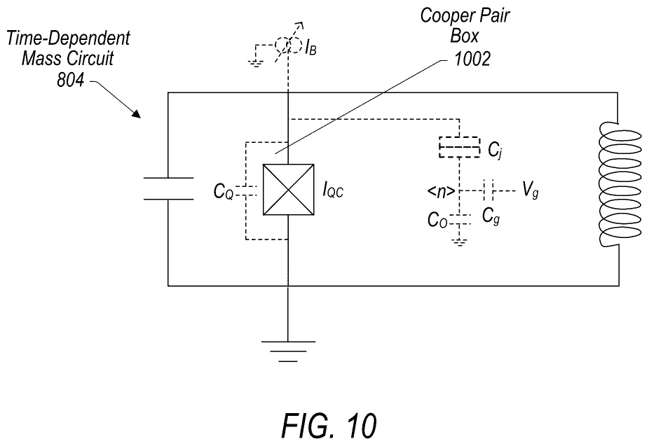

FIG. 10 is a diagram providing additional details regarding a hardware configuration used to implement a relay oscillator with a time-dependent mass, according to some embodiments.

A mass of an oscillator, is given by m=ϕ₀²C, where C is the capacitance of the circuit used to implement the oscillator and ϕ₀=h/2e is the reduced magnetic flux of the circuit used to implement the oscillator, e.g. a constant. Also, e is the elementary charge and h is Planck's constant. In some embodiments, a Cooper-pair box, such as Cooper-pair box 1002, may be used to change the capacitance of the circuit. This allows the oscillator mass to change as a function of time, in response to control signals from controller 1008. The gate voltage modulates the charge transfer through the small junction in the Cooper-pair box, thus leading to a gate-dependent capacitance.

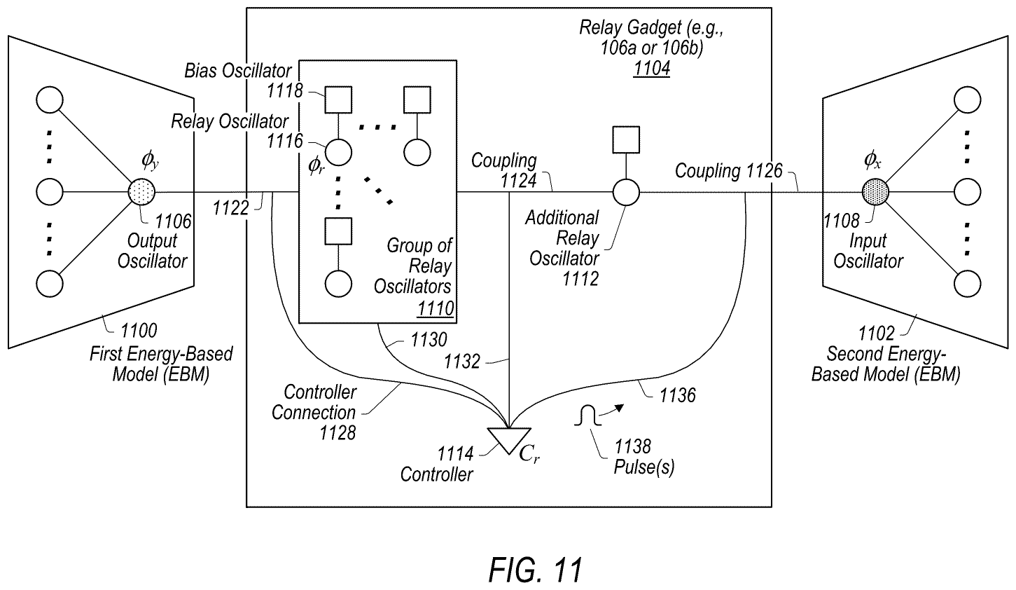

FIG. 11 is a high-level diagram illustrating an output oscillator, an input oscillator, and a relay gadget, wherein the relay gadget comprises a group of relay oscillators and is configured to relay thermodynamic information between the output oscillator and the input oscillator and includes bias oscillators, according to some embodiments.

In some embodiments, thermodynamic information is relayed from a first energy-based model (EBM) 1100 to a second energy-based model (EBM) 1102 via relay gadget 1104 (e.g., 106a or 106b). The thermodynamic information of EBM 1100 is outputted via output oscillator 1106 and inputted into input oscillator 1108 via relay gadget 1104. The thermodynamic information may include, for example, samples of thermodynamic equilibrium of output oscillator 1106, or the expectation value of the output oscillator 1106. The expectation value is at least derivable based on samples values of the output oscillator 1106. Output oscillator 1106 may be governed by a potential wherein the potential follows a single-well potential, double-well potential, multi-well potential, or any generic potential that may be engineered. The output oscillator 1106 may also be coupled to other oscillators belonging to EBM 1100.

In some embodiments, an expectation value of one or more degrees of freedom of output oscillator 1106 may be influenced by a potential of output oscillator 1106 as well as couplings between output oscillator 1106 and one or more oscillators belonging to first energy-based model 1100. Potentials governing the dynamics of the output oscillator 1106 may have multiple wells. With generic arbitrary potentials (e.g. multiple wells) and coupling between output oscillator 1106 and one or more oscillators belonging to first energy-based model 1100, the position degrees of freedom of the output oscillators can hop between wells. As described herein, a relay gadget provides a solution to approximate an expectation value of the output oscillator. Furthermore, utilizing the expectation value allows for forwards and backwards propagation. For example, using an approximated expectation value in forwards and backwards propagation may provide better results than using a sample value, as the expectation value better represents the state of the oscillator whose degree of freedom value is being relayed to a second oscillator.

Relay gadget 1104 comprises a group of relay oscillators 1110 and an additional relay oscillator 1112. The group of relay oscillators 1110 comprises one or more relay oscillators arranged with respective bias oscillators (e.g., relay oscillator 1116 arranged with bias oscillator 1118). As described later, relay oscillators in oscillator group 1110 may be configured and coupled in various ways (e.g. temporally and spatially) to transfer thermodynamic information. The additional relay oscillator 1112 is connected to bias oscillator 1120. As discussed later, the additional relay oscillator 1112 may be configured and coupled in various ways to transfer thermodynamic information. For example, the group of relay oscillators 1110 transfers thermodynamic information to additional relay oscillator 1112 via coupling 1124. Coupling 1124 may be controlled by on-chip classical controller 1114.

Output oscillator 1106 is coupled to the one or more relay oscillators of the group of relay oscillators 1110 via on-chip classical controller 1114. On-chip classical controller 1114 may send a pulse or a group of pulses to cause couplings between oscillators (e.g., coupling between output oscillator 1106 and relay oscillator 1116) or relay oscillators like 1116 and a bias oscillator like 1118 via 1130. Coupling is represented by coupling 1122, 1124, 1126 and oscillators may be coupled or not coupled. When coupling is on, parameters of respective coupled oscillators affect the other oscillator it is coupled to. Couplings between oscillators within the group of relay oscillators 1110 are not expressly shown in FIG. 11 to emphasize that the coupling may take different configurations (e.g. temporal or spatial configurations as detailed below). Nevertheless, on-chip classical controller 1114 may cause a first set of one or more pulses to be emitted through controller connection 1128, wherein the first set of pulses couples one or more relay oscillators of the group of relay oscillators 1110 to the output oscillator 1106 (e.g., turn on coupling 1122). The on-chip classical controller 1114 is further configured to cause a second set of one or more pulses to be emitted through 1132, wherein the second set of pulses couples one or more relay oscillators of the group of relay oscillators 1110 to the additional relay oscillator 1112 (e.g., turn on coupling 1124). The on-chip classical controller 1114 is further configured to cause a third set of one or more pulses (for example, set of pulses 1138) to be emitted, wherein the third set of pulses 1138 couples the additional relay oscillator 1112 to the input oscillator 1108 (e.g., turn on coupling 1126).

In some embodiments, an additional relay oscillator 1112 takes on an expectation value of an output oscillator 1106 based at least in part on a coupling or couplings between a group of relay oscillators 1110, wherein respective relay oscillators of group 1110 comprise respective sample values of the output oscillator 1106. The additional relay oscillator 1112 may take on the expectation value of output oscillator 1106 based at least on respective sample values taken on by respective relay oscillators. Furthermore, additional relay oscillator 1112 may transfer the taken on expectation value to input oscillator 1108 via controller 1114 causing coupling 1126 to turn on.

In some embodiments, bias oscillators such as bias oscillator 1118 may be used, for example, to stabilize relay oscillators of the relay gadget. In some embodiments, relay gadget 1104 may be implemented without bias oscillators such as 1118.

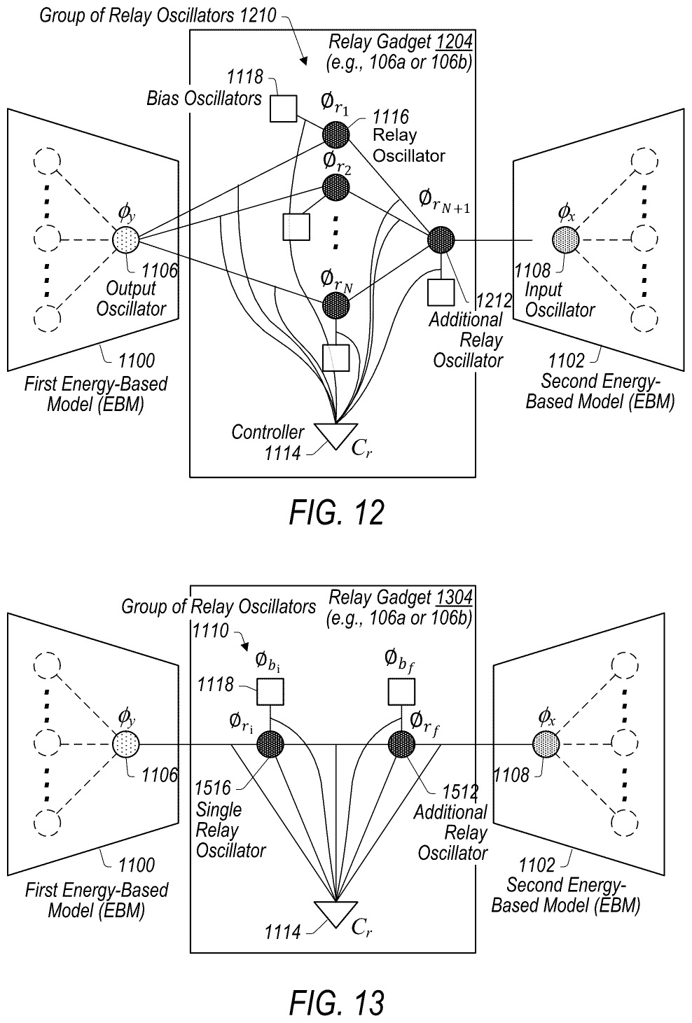

FIG. 12 is a high-level diagram illustrating a spatial analogue relay gadget, wherein respective ones of relay oscillators of a group of relay oscillators are configured to store respective sample values of an output oscillator, according to some embodiments.

In some embodiments, controller 1114 sends a first set of one or more pulses wherein the first set of pulses causes output oscillator 1106 of first energy-based model (EBM) 1100 to be coupled to at least one or more relay oscillators {ϕᵣ_{₁}, ϕᵣ_{₂}, . . . ϕᵣ_{_{N}}}, in the group of relay oscillators 1210. The group of relay oscillators 1210 comprises a plurality of relay oscillators, wherein respective relay oscillators {ϕᵣ_{₁}, ϕᵣ_{₂}, . . . ϕᵣ_{_{N}}}, are configured to store a sample of the output oscillator 1106 based at least in part on respective couplings between the respective ones of the relay oscillators (e.g., 1116) of the group of relay oscillators 1210 and the output oscillator 1106. The on-chip classical controller 1114 is further configured to cause another set of one or more pulses to be emitted, wherein the other set of pulses turns off the respective couplings between the output oscillator 1106 and the respective ones of the relay oscillator of the group of relay oscillators 1210 at different times. This may allow different samples of the output oscillator 1106 to be stored on the respective ones of the relay oscillators {ϕᵣ_{₁}, ϕᵣ_{₂}, . . . ϕᵣ_{_{N}}}.

On-chip classical controller 1114 may be further configured to cause a second set of one or more pulses to be emitted, wherein the second set of pulses turns on the coupling between respective ones of the relay oscillators with sample values of the output oscillator 106 to an additional relay oscillator 1212. The coupling is configured to transfer an approximation of the expectation value of output oscillator 1106 based at least in part on the sample values stored on respective relay oscillators in the first group of relay oscillators 1210. Once the additional relay oscillator 1212 is tuned to the expectation value of output oscillator 1106, controller 1114 may cause a set of one or more pulses that may cause the additional relay oscillator to be coupled to input oscillator 1108. In some embodiments, bias oscillators such as bias oscillator 1118 may be used, for example, to stabilize relay oscillators of the relay gadget. In some embodiments, relay gadget 1104 may be implemented without bias oscillators such as 1118.

FIG. 13 is a high-level diagram illustrating a temporal analogue relay gadget, wherein a group of relay oscillators comprises a single relay oscillator, according to some embodiments.

In some embodiments, the group of relay oscillators 1110 comprises a single relay oscillator 1316. The single relay oscillator 1316 is configured to store a sample of the output oscillator 1106 based at least in part on the coupling between the single relay oscillator 1316 and the output oscillator 1106. The coupling between output oscillator 1106 and single relay oscillator 1316 is caused by a first set of one or more pulses emitted from on-chip classical controller 1114. The on-chip classical controller 1114 is configured to cause a second set of one or more pulses to be emitted, wherein the second set of pulses causes the single relay oscillator 1316 to be coupled to additional relay oscillator 1312. The sequence of emitting the first set of pulses and then emitting the second set of pulses may be repeated numerous times. Each instance the sequence of the sequential sets of pulses is emitted, the position of additional relay oscillator 1312 is incrementally adjusted. Each adjustment may converge the additional relay oscillator 1312 to the expectation value of output oscillator 1106.

In some embodiments, bias oscillators such as bias oscillator 1118 may be used to stabilize relay oscillators of the relay gadget. In some embodiments, relay gadget 1104 may be implemented without bias oscillators such as 1118.

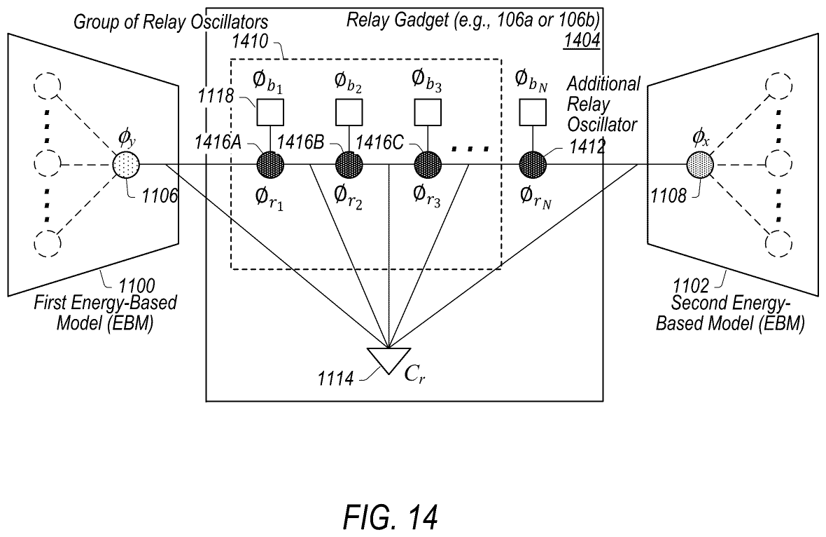

FIG. 14 is a high-level diagram illustrating a series analogue relay gadget, wherein a group of relay oscillators comprises a plurality of relay oscillators arranged in series, according to some embodiments.

FIG. 14 shows a drawing of a series analogue relay gadget 1404 such as shown in some embodiments. The group of relay oscillators 1110 comprises a plurality of relay oscillators {ϕᵣ_{₁}, ϕᵣ_{₂}, . . . } (e.g. relay oscillator 1416A, 1416B, 1416C) arranged one after another in series. Each relay oscillator has a product of mass and frequency squared. The first relay oscillator 1416A, ϕᵣ_{₁}, has the smallest product of mass and frequency squared. The next relay oscillator 1416B, ϕᵣ_{₂}, has a product of mass and frequency squared larger than the previous relay oscillator 1416A, ϕᵣ_{₁}. This trend of increasing the product of mass and frequency squared continues for each subsequent relay oscillator in the group of relay oscillators 1110. As last in the chain of relay oscillators, the additional relay oscillator 1412 has the largest product of mass and frequency squared. The couplings between relay oscillators and the coupling between the output oscillator 1106 and the first relay oscillator 1416A, ϕᵣ_{₁}, may be turned on at the same time and allowed to evolve thermodynamically according to Langevin dynamics. Once coupling is initiated, each successive relay oscillator takes continuous samples of the previous oscillator it is coupled to. Furthermore, each successive relay oscillator may be a closer approximation of the expectation value of the output oscillator 1106. In this manner, additional relay oscillator 1412 approximates an expectation value of input oscillator 1106. At this point, coupling between the additional relay oscillator 1412 and input oscillator 1108 may be turned on and the thermodynamic information may be transferred to input oscillator 1108. The number of relay oscillators and the timing of coupling may be chosen beforehand and optimized for a desired precision or accuracy of the expectation value of the output relay oscillator.

In some embodiments, bias oscillators such as bias oscillator 1118 may be used to stabilize relay oscillators of the relay gadget. In some embodiments, relay gadget 1104 may be implemented without bias oscillators such as 1118.

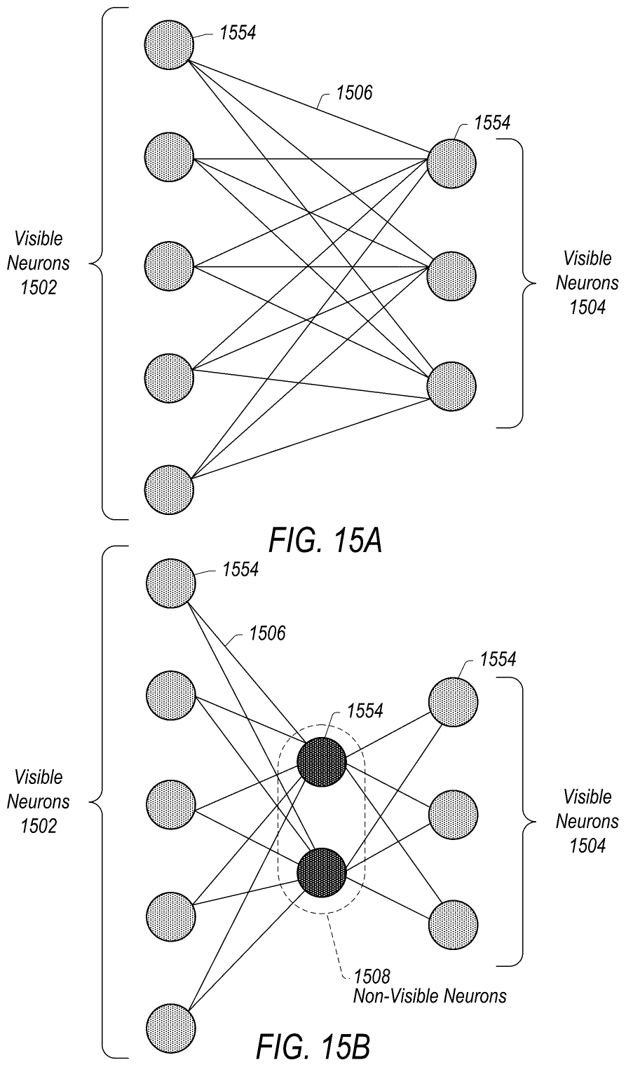

FIG. 15A illustrates example couplings between visible neurons of an energy-based model (EBM), according to some embodiments.

In some embodiments, input neurons and output neurons of an energy-based model, such as visible neurons 1502 and visible neurons 1504, may be directly linked via connected edges 1506. As shown in FIG. 15A, a given visible neuron 1502 of the five shown in the figure is connected, via edges 1506, to each of the respective three visible neurons 1504. A person having ordinary skill in the art should understand that FIG. 15A is meant to represent example embodiments of a graph architecture implemented using a thermodynamic chip that may be applied and that specific numbers of visible neurons 1502 and/or visible neurons 1504 shown in the figure are not meant to be restrictive. Additional configurations combining more/less visible neurons 1502 and/or visible neurons 1504 are also encompassed by the discussion herein. In addition, recall that neurons are logical representations of physical oscillators, such that, when describing neurons in FIGS. 15A and 15B, it should be understood that neurons and edges are implemented using oscillators and couplings.

FIG. 15B illustrates example couplings between visible neurons and non-visible neurons (e.g., hidden neurons) of an energy-based model (EBM), according to some embodiments.

In some embodiments, FIG. 15B may resemble additional example embodiments of an energy-based model architecture implemented using a thermodynamic chip. As shown in the figure, additional non-visible neurons 1508 may be used, which are respectively coupled, via edges 1506, to both visible neurons 1502 and to visible neurons 1504. Note that while the non-visible neurons are “not visible” from the perspective of inputs and outputs, the non-visible neurons may each correspond to a given oscillator. In addition, it may be noted that, in some embodiments that make use of non-visible neurons, no direct connections, via edges 1506, may be implemented between visible neurons 1502 and visible neurons 1504, but rather connections are routed firstly via non-visible neurons 1508, as shown in FIG. 15B. Couplings between visible and non-visible neurons may be additionally referred to herein as “layers” of a given energy-based model architecture that is implemented using a thermodynamic chip, according to some embodiments.

FIG. 16 is a high-level diagram illustrating oscillators included in a substrate of the thermodynamic chip and mapping of the oscillators to logical neurons of the thermodynamic chip, according to some embodiments.

In some embodiments, a substrate 1602 may be included in a thermodynamic chip, such as any one of the thermodynamic chips described above. Oscillators 1604 of substrate 1602 may be mapped in a logical representation 1652 to neurons 1654, as well as weights and biases (shown in FIG. 17). In some embodiments, oscillators 1604 may include oscillators with potentials ranging from a single well potential to a dual-well potential and may be mapped to visible neurons, weights, and biases.

In some embodiments, Josephson junctions and/or superconducting quantum interference devices (SQUIDS) may be used to implement and/or excite/control the oscillators 1604. In some embodiments, the oscillators 1604 may be implemented using superconducting flux elements (e.g., qubits). In some embodiments, the superconducting flux elements may physically be instantiated using a superconducting circuit built out of coupled nodes comprising capacitive, inductive, and Josephson junction elements, connected in series or parallel, such as shown in FIG. 16 for oscillator 1604. However, in some embodiments, generally speaking various non-linear flux loops may be used to implement the oscillators 1604, such as those having single-well potential, double-well potential, or various other potentials, such as a potential somewhere between a single-well potential and a double-well potential.

FIG. 17 is an additional high-level diagram illustrating oscillators included in a substrate of the thermodynamic chip mapped to logical neurons, weights, and biases of a given neuro-thermodynamic computing system, according to some embodiments.

While weights and biases are not shown in FIG. 16 for ease of illustration, respective ones of the visible neurons 1654 of FIG. 16 may each have an associated bias, and edges connecting the neurons 1654 may have associated weights. For example, FIG. 15 illustrates an arrangement of five visible neurons along with associated weights and biases. Each of the weights and biases may be mapped to oscillators in the thermodynamic chip, as well as the visible (and non-visible) neurons being mapped to oscillators in the thermodynamic chip. For example, FIG. 17 shows a portion of a thermodynamic chip, wherein weights and biases associated with a given neuron 1754 are shown. For example, bias 1756 may be a bias value for visible neuron 1754 and weights 1758 and 1760 may be weights for edges formed between visible neuron 1754 and other visible neurons of the thermodynamic chip. As shown in FIG. 17, each of the chip elements (visible neuron 1754, bias 1756, weight 1758, and weight 1760) may be mapped to separate ones of oscillators 1704. This may allow the visible neurons (and/or hidden neurons), weights, and biases to have independent degrees of freedom within a given thermodynamic chip that can separately evolve.

In some embodiments, oscillators associated with weights and biases, such as bias 1756 and weights 1758 and 1760, may be allowed to evolve during a training phase and may be held nearly constant during an inference phase. For example, in some embodiments, larger “masses” may be used for the weights and biases such that the weights and biases evolve more slowly than the visible neurons. This may have the effect of holding the weight values and the bias values nearly constant during an evolution phase used for generating inference values.

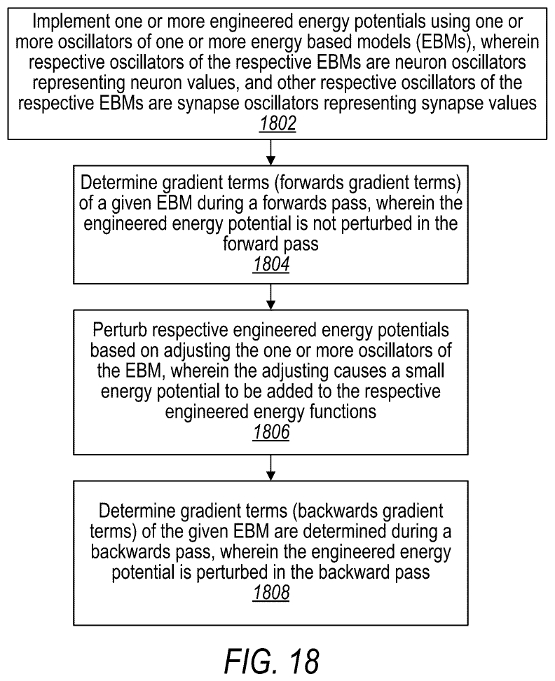

FIG. 18 is a high-level flowchart illustrating the process of implementing energy based models and determining gradients that may be used to update synapse oscillators representing synapse values, according to some embodiments.

At block 1802, one or more engineered energy potentials such as 206a-d are implemented on one or more oscillators of one or more energy based models (EBMs) 102a-d. Respective oscillators of the respective EBMs are neuron oscillators (e.g., 204a-d and 208a-d) representing neuron values. Other respective oscillators of the respective EBMs are synapse oscillators (e.g., bias oscillator 112, and weight oscillators 114, 116) representing synapse values.

At block 1804, the system determines gradient terms (forwards gradient terms) of a given EBM during a forwards pass 110, wherein the engineered energy potential is not perturbed in the forwards pass.

At block 1806, respective engineered energy potentials are perturbed by the system based on adjusting the one or more oscillators of the EBM, wherein the adjusting causes a small energy potential to be added to the respective engineered energy functions

At block 1808, the system determines gradient terms (backwards gradient terms) of a given EBM during a backwards pass 112, wherein the engineered energy potential is perturbed in the backwards pass.

In some embodiments, synapses may not be dynamical degrees of freedom. In such an embodiment, the method may further include the following. Measuring thermodynamic information of one or more synapse oscillators of a given EBM. Storing measured thermodynamic information on one or more classical computing devices. computing the forwards or backwards gradient terms of a given EBMs based on the measurements of the one or more oscillators. Determining update synapse values based on the forwards or backwards gradient terms.

In some embodiments, synapses may be dynamical degrees of freedom. Such an embodiment may include methods such as the following. Determining the forwards or backwards gradient terms based on evolving respective oscillators thermodynamically. Storing the determined forwards or backwards gradient terms on one or more relay oscillators. Updating the synapse values based on the forwards or backwards gradient terms.

### Illustrative Computer System

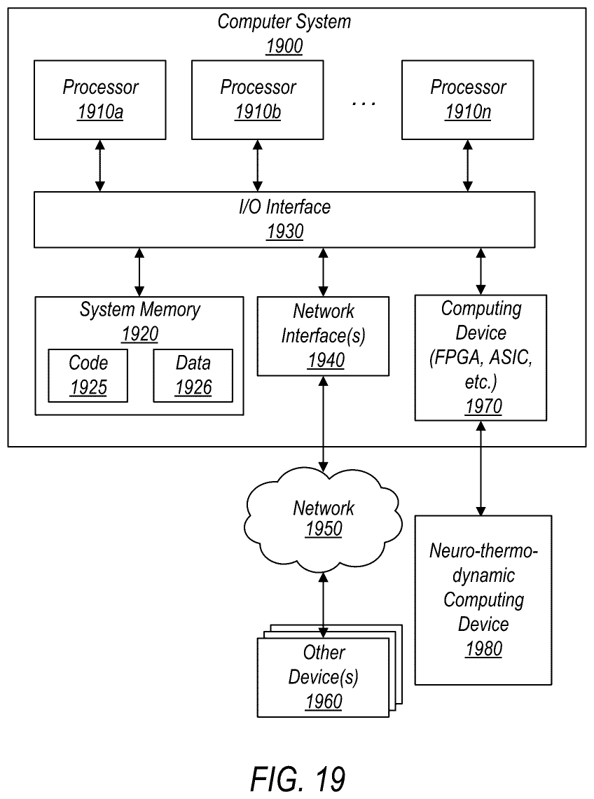

FIG. 19 is a block diagram illustrating an example computer system that may be used in at least some embodiments. In some embodiments, the computing system shown in FIG. 19 may be used, at least in part, to implement any of the techniques described above in FIGS. 1-18. Furthermore, computer system 1900 may be configured to interact and/or interface with neuro-thermodynamic computing device 1980, according to some embodiments.

In the illustrated embodiment, computer system 1900 includes one or more processors 1910 coupled to a system memory 1920 (which may comprise both non-volatile and volatile memory modules) via an input/output (I/O) interface 1930. Computer system 1900 further includes a network interface 1940 coupled to I/O interface 1930. Classical computing functions may be performed on a classical computer system, such as computing computer system 1900.

Additionally, computer system 1900 includes computing device 1970 coupled to thermodynamic chip 1980. In some embodiments, computing device 1970 may be a field programmable gate array (FPGA), application specific integrated circuit (ASIC) or other suitable processing unit. In some embodiments, computing device 1970 may be a similar computing device as described in FIGS. 1-18, such as classical computing devices used to control a thermodynamic chip. In some embodiments, neuro thermodynamic computing device 1980 may be a similar neuro thermodynamic computing device as described in FIGS. 1-18, such as neuro thermodynamic computing devices implemented using thermodynamic chips.

In various embodiments, computer system 1900 may be a uniprocessor system including one processor 1910, or a multiprocessor system including several processors 1910 (e.g., two, four, eight, or another suitable number). Processors 1910 may be any suitable processors capable of executing instructions. For example, in various embodiments, processors 1910 may be general-purpose or embedded processors implementing any of a variety of instruction set architectures (ISAs), such as the x86, PowerPC, SPARC, or MIPS ISAs, or any other suitable ISA. In multiprocessor systems, each of processors 1910 may commonly, but not necessarily, implement the same ISA. In some implementations, graphics processing units (GPUs) may be used instead of, or in addition to, conventional processors.

System memory 1920 may be configured to store instructions and data accessible by processor(s) 1910. In at least some embodiments, the system memory 1920 may comprise both volatile and non-volatile portions; in other embodiments, only volatile memory may be used. In various embodiments, the volatile portion of system memory 1920 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random-access memory (ReRAM), three-dimensional NAND technologies, Ferroelectric RAM, magneto resistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 1920 as code 1925 and data 1926.

In some embodiments, I/O interface 1930 may be configured to coordinate I/O traffic between processor 1910, system memory 1920, computing device 1970, and any peripheral devices in the computer system, including network interface 1940 or other peripheral interfaces such as various types of persistent and/or volatile storage devices. In some embodiments, I/O interface 1930 may perform any necessary protocol, timing or other data transformations to convert data signals from one component (e.g., system memory 1920) into a format suitable for use by another component (e.g., processor 1910). In some embodiments, I/O interface 1930 may include support for devices attached through various types of peripheral buses, such as a variant of the Peripheral Component Interconnect (PCI) bus standard or the Universal Serial Bus (USB) standard, for example. In some embodiments, the function of I/O interface 1930 may be split into two or more separate components, such as a north bridge and a south bridge, for example. Also, in some embodiments some or all of the functionality of I/O interface 1930, such as an interface to system memory 1920, may be incorporated directly into processor 1910.

Network interface 1940 may be configured to allow data to be exchanged between computing device 1900 and other devices 1960 attached to a network or networks 1950, such as other computer systems or devices. In various embodiments, network interface 1940 may support communication via any suitable wired or wireless general data networks, such as types of Ethernet network, for example. Additionally, network interface 1940 may support communication via telecommunications/telephony networks such as analog voice networks or digital fiber communications networks, via storage area networks such as Fibre Channel SANs, or via any other suitable type of network and/or protocol.

In some embodiments, system memory 1920 may represent one embodiment of a computer-accessible medium configured to store at least a subset of program instructions and data used for implementing the methods and apparatus discussed in the context of FIG. 1 through FIG. 18. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computer system 1900 via I/O interface 1930. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computer system 1900 as system memory 1920 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 1940. Portions or all of multiple computing devices such as that illustrated in FIG. 19 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computer system”, as used herein, refers to at least all these types of devices, and is not limited to these types of devices.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g., SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures above and the Appendix below and described herein represent exemplary embodiments of methods. The methods may be implemented in software, hardware, or a combination thereof. The order of method may be changed, and various elements may be added, reordered, combined, omitted, modified, etc.

It will also be understood that, although the terms first, second, etc., may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

Various modifications and changes may be made as would be obvious to a person skilled in the art having the benefit of this disclosure. It is intended to embrace all such modifications and changes and, accordingly, the above description and the Appendix below is to be regarded in an illustrative rather than a restrictive sense.

What is claimed is:

1. A system comprising:
one or more thermodynamic chips, wherein oscillators of the one or more thermodynamic chips are configured to implement:
a plurality of energy based models (EBMs) configured to thermodynamically evolve, wherein:
respective oscillators of the respective EBMs are mapped to be neuron oscillators representing neuron values; and
other respective oscillators of the respective EBMs are mapped to be synapse oscillators representing synapse values, wherein:
the synapse oscillators when coupled with the neuron oscillators establish an engineered potential that is configured to be perturbed; and
one or more relay gadgets, each comprising one or more of the oscillators (relay oscillators) configured to relay thermodynamic information between the EBMs as the EBMs thermodynamically evolve in a forward pass and a backward pass; and
wherein:
one or more forwards gradient terms of a given EBM are determined during the forwards pass, wherein the engineered energy potential is not perturbed in the forward pass;
one or more backwards gradient terms of the given EBM are determined during the backwards pass, wherein the engineered energy potential is perturbed in the backward pass.

2. The system of claim 1 further comprising one or more classical computing devices configured to:
measure thermodynamic information of one or more of the synapse oscillators of a given one of the EBMs;
compute the forwards or backwards gradient terms of the given EBM based on the measurements of the synapse oscillators; and
determine updated synapse values based on the forwards or backwards gradient terms.

3. The system of claim 1, wherein the one or more thermodynamic chips further comprise additional relay oscillators configured to:
couple and uncouple with one or more of the synapse oscillators of a given one of the EBMs;
be used to determine the forwards or backwards gradient terms based on respective relay oscillators evolving thermodynamically; and
store updated synapse values determined based on the forwards or backwards gradient terms, wherein the forwards or backwards gradient terms are determined based on respective relay oscillators of the EBMs evolving thermodynamically.

4. The system of claim 1, wherein:
a neural network is implemented via respective EBMs of the plurality of EBMs; and
the respective EBMs represent respective layers of the neural network.

5. The system of claim 4, wherein:
one or more neuron oscillators of a given EBM are configured to be clamped to thermodynamic information of one or more neuron oscillators of another one of the EBMs.

6. The system of claim 1, wherein:
the forwards gradient terms are determined based on changes in the engineered energy potential given a change in one or more oscillators of the EBM; and
the backwards gradient terms are determined based on how the perturbed engineered energy potential changes given a change in one or more oscillators of the EBM.

7. The system of claim 6, wherein:
updated synapse values are determined based on the forwards or backwards gradient terms.

8. The system of claim 1, wherein:
a difference between the forwards gradient terms and respective backwards gradient terms are determined; and
an updated synapse value is determined based on the difference between the forwards and backwards gradient terms.

9. A method, comprising:
implementing one or more engineered energy potentials using one or more oscillators of one or more energy based models (EBMs), wherein:
respective oscillators of the respective EBMs are neuron oscillators representing neuron values; and
other respective oscillators of the respective EBMs are synapse oscillators representing synapse values, wherein:
the synapse oscillators when coupled with the neuron oscillators establish an engineered potential that is configured to be perturbed; and
determining gradient terms (forwards gradient terms) of a given EBM during a forwards pass, wherein the engineered energy potential is not perturbed in the forward pass;
perturbing respective engineered energy potentials based on adjusting the one or more oscillators of the EBM, wherein the adjusting causes a small energy potential to be added to the respective engineered energy potentials; and
determining gradient terms (backwards gradient terms) of the given EBM are determined during a backwards pass, wherein the engineered energy potential is perturbed in the backward pass.

10. The method of claim 9 further comprising:
measuring thermodynamic information of one or more synapse oscillators of a given EBM;
storing measured thermodynamic information on one or more classical computing devices.

11. The method of claim 10 further comprising:
computing the forwards or backwards gradient terms of a given one of the EBMs based on the measurements of the one or more oscillators; and
determining updated synapse values based on the forwards or backwards gradient terms.

12. The method of claim 9 further comprising:
determining the forwards or backwards gradient terms based on evolving respective oscillators thermodynamically; and
storing the determined forwards or backwards gradient terms on one or more relay oscillators.

13. The method of claim 12 further comprising:
updating the synapse values based on the forwards or backwards gradient terms.

14. The method of claim 9, further comprising:
implementing a neural network via respective EBMs of a plurality of EBMs, wherein the respective EBMs represent respective layers of the neural network.

15. The method of claim 14, further comprising:
clamping one or more visible oscillators of a given EBM to thermodynamic information of one or more visible oscillators of another EBM.

16. The method of claim 9, wherein:
the forwards gradient terms are based on how the engineered energy potential changes given a change in one or more oscillators of the EBM; and
the backwards gradient terms are based on how the perturbed engineered energy potential changes given a change in one or more oscillators of the EBM.

17. The method of claim 16, wherein:
the forwards or backwards gradient terms are used to update synapse values of the EBM.

18. The method of claim 9, further comprising:
determining a difference between the forwards gradient terms and respective backwards gradient terms; and
determining updated synapse value based on the difference between the forwards and backwards gradient terms.

19. One or more non-transitory, computer-readable, storage media storing program instruction, that when executed on or across one or more processors, cause the one or more processors to:
cause one or more engineered energy potentials to be implemented using one or more oscillators of one or more energy based models (EBMs), wherein the one or more oscillators of each EBM comprises visible oscillators and synapse oscillators;
calculate a forwards gradient term of an engineered energy potential of the EBM that is not perturbed based on measurements of one or more oscillators;
calculate a backwards gradient term of an engineered energy potential of the EBM that is not perturbed based on measurements of one or more oscillators; and
cause the synapse oscillators of respective EBMs to be updated.

20. The one or more non-transitory, computer-readable, storage media of claim 19 that when executed on or across one or more processors, further cause the one or more processors to:
calculate a difference between the forwards gradient terms and the backwards gradient terms.
